(19) United States
(12) Patent Application Publication
(10) Pub. No.: US 2007/0229447 A1
(43) Pub. Date: Oct. 4, 2007

(54) LIQUID CRYSTAL DISPLAY DEVICE

(75) Inventors: Hiroshi Takahara, Osaka (JP); Kenji Nakao, Ishikawa (JP); Kazuhiro Nishiyama, Ishikawa (JP); Yukio Tanaka, Ishikawa (JP); Shigesumi Araki, Ishikawa (JP); Mitsutaka Okita, Ishikawa (JP); Tetsuo Fukami, Ishikawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd., Tokyo (JP)

(21) Appl. No.: 11/689,222

(22) Filed: Mar. 21, 2007

(30) Foreign Application Priority Data
Mar. 23, 2006 (JP) 2006-81541
Apr. 12, 2006 (JP) 2006-110327
Apr. 12, 2006 (JP) 2006-110318
Apr. 12, 2006 (JP) 2006-110334
Feb. 2, 2007 (JP) 2007-24075

(51) Int. Cl. G09G 3/36

(52) U.S. Cl. 345/102

(57) ABSTRACT

Common signals VCOM during a black voltage writing period are set to be larger than common signals VCOM during a video writing period. The common voltage signals VCOM is VmH or VmL during the black voltage writing periods. The common voltage signals VCOM is VcH or VcL during video writing periods and video holding periods. The polarity of the common voltage signals VCOM is inverted alternately from frame to frame. A backlight is extinguished in the black voltage writing period.

### CROSS-REFERENCE TO RELATED APPLICATIONS

This application is based upon and claims the benefit of priority from the prior Japanese Patent Application No. 2006-81541, filed on Mar. 23, 2006; the prior Japanese Patent Application No. 2006-110318, filed on Apr. 12, 2006; the prior Japanese Patent Application No. 2006-110327, filed on Apr. 12, 2006; the prior Japanese Patent Application No. 2006-110334, filed on Apr. 12, 2006; the prior Japanese Patent Application No. 2007-24075, filed on Feb. 2, 2007, the entire contents of which are incorporated herein by reference.

### TECHNICAL FIELD

The present invention relates to a liquid crystal display device having a high-contrast display performance and a desirable movie display performance.

### BACKGROUND OF THE INVENTION

In recent years, liquid crystal TVs are coming into practical use, and improvement of the movie display performance is required. There is a black voltage drive system as a method of improving the movie display performance. In the black voltage drive system, a lateral band-shaped black display portion synchronized with vertical synchronous signals is moved from the top to the bottom of a display screen. A backlight is constantly illuminated. By moving the lateral band-shaped black display portion from the top to the bottom of the display screen, image is intermittently displayed (for example, see Japanese Application Kokai No. 2002-202491).

The black voltage drive is effective for displaying movement of substance smoothly by removing retinal afterglow which is generated in sight of an observer since it creates a pseudo impulse luminance response close to CRT in the movie display.

There is also disclosed a liquid crystal display device in which a video signal writing scanning period and an auxiliary signal writing scanning period for applying auxiliary signals are provided, and different common voltages are applied for the video signal writing scanning period and for the auxiliary signal writing scanning period, so that the response speed of liquid crystal is increased by widening the range of a voltage V1c to be applied to the liquid crystal capacity during the auxiliary signal writing scanning period by the common voltage, not by widening the voltage range of source signals by increasing a blocking voltage of a source driver (for example, see Japanese Application Kokai 2000-259129).

As descried above, the desirable movie display performance is achieved by inserting the black display portion in the display screen. In particular, the larger the ratio of the black display portion in the display screen is, the more the movie display performance is improved.

However, in a driving method in the related art, the backlight is constantly illuminated. Therefore, light leakage occurs even in the black display portion inserted into the display screen. Therefore, there arises a problem of lowering of the display contrast.

Since light from the back light entering the black display portion is not used, the efficiency for light utilization is disadvantageously lowered.

Therefore, in the driving method employing insertion of the black display portion in the related art, although the movie display performance is improved, there remain problems such that the contrast is lowered, the efficiency for light utilization is lowered, and hence power consumption is increased.

### SUMMARY OF THE INVENTION

Accordingly, it is an object of the invention to provide a liquid crystal display device in which a superior display contrast is achieved, and the movie visibility is improved.

According to embodiments of the present invention, there is provided a liquid crystal display device including a liquid crystal display panel having an array substrate formed with a display area with a plurality of pixels arranged in a matrix pattern by a plurality of source signal lines and a plurality of gate signal lines arranged orthogonally to each other and pixel switching devices arranged in the vicinities of intersections of the source signal lines and the gate signal lines, and an opposed substrate having opposed electrodes and being arranged on the array substrate with a liquid crystal layer sandwiched therebetween, including:

a video display control unit configured to

(1) write black voltages into the respective pixels during a first period in one frame and

(2) write video signals into the respective pixels during a second period subsequent to the first period in the one frame; and

a common voltage application unit configured to

(1) apply a common voltage VmH to the opposed electrodes during the first period, apply a common voltage VcH (VmH>VcH) during the subsequent second period, and

(2) apply a common voltage VmL to the opposed electrodes in the first period in a subsequent frame of the one frame and apply a common voltage VcL (VmL<VcL<VcH) during a subsequent second period.

According to embodiments of the invention, there is provided a liquid crystal display device including a liquid crystal display panel having an array substrate formed with a display area with a plurality of pixels arranged in a matrix pattern by a plurality of source signal lines and a plurality of gate signal lines arranged orthogonally to each other and pixel switching devices arranged in the vicinities of intersections of the source signal lines and the gate signal lines, and an opposed substrate having opposed electrodes and being arranged on the array substrate with a liquid crystal layer sandwiched therebetween, including:

a video display control unit configured to

(1) write black voltages to the respective pixels during a first period in one frame,

(2) write video signals to the respective pixels during a second period subsequent to the first period during the one frame, and

(3) determine the magnitudes of the black voltage to be applied to the pixels during the first period by the magnitudes of the video signals to be applied to the pixels during the second period.

According to the embodiments of the invention, a superior display contrast is achieved and hence the movie visibility is improved.

### BRIEF DESCRIPTION OF THE DRAWINGS

FIG. 1 is a diagram showing a configuration of a liquid crystal display device according to an embodiment;

FIG. 2 is an explanatory drawing showing a liquid crystal display panel;

FIG. 3 is a diagram showing a configuration of the liquid crystal display device;

FIG. 4 is an explanatory drawing showing a method of driving the liquid crystal display device;

FIG. 5 is an explanatory drawing showing a method of driving the liquid crystal display device;

FIG. 6 is an explanatory drawing showing a method of driving the liquid crystal display device;

FIG. 7 is an explanatory drawing showing a method of driving the liquid crystal display device;

FIGS. 8A and 8B are drawings for explaining a method of driving the liquid crystal display device;

FIG. 9 is an explanatory drawing showing a method of driving the liquid crystal display device;

FIG. 10 is an explanatory drawing showing a method of driving the liquid crystal display device;

FIG. 11 is an explanatory drawing showing a method of driving the liquid crystal display device;

FIG. 12 is an explanatory drawing showing a method of driving the liquid crystal display device;

FIG. 13 is an explanatory drawing showing a method of driving the liquid crystal display device;

FIG. 14 is an explanatory drawing showing a method of driving the liquid crystal display device;

FIG. 15 is an explanatory drawing showing a method of driving the liquid crystal display device;

FIGS. 16A and 16B are drawings for explaining a method of driving the liquid crystal display device;

FIGS. 17A and 17B are drawings for explaining a method of driving the liquid crystal display device;

FIGS. 18A and 18B are drawings for explaining a method of driving the liquid crystal display device;

FIG. 19 is an explanatory drawing showing a method of driving the liquid crystal display device;

FIG. 20 is an explanatory drawing showing a method of driving the liquid crystal display device;

FIGS. 21A, 21B and 21C are explanatory drawings showing a method of driving the liquid crystal display device;

FIG. 22 is an explanatory drawing showing a method of driving the liquid crystal display device;

FIG. 23 is an explanatory drawing showing a method of driving the liquid crystal display device;

FIG. 24 is an explanatory drawing showing a method of driving the liquid crystal display device;

FIG. 25 is an explanatory drawing showing a method of driving the liquid crystal display device;

FIG. 26 is an explanatory drawing showing a method of driving the liquid crystal display device;

FIG. 27 is an explanatory drawing showing a method of driving the liquid crystal display device;

FIG. 28 is an explanatory drawing showing a method of driving the liquid crystal display device;

FIG. 29 is an explanatory drawing showing a drive circuit of the liquid crystal display device;

FIG. 30 is an explanatory drawing showing a method of driving the liquid crystal display device;

FIG. 31 is an explanatory drawing showing a method of driving the liquid crystal display device;

FIGS. 32A and 32B are explanatory drawings showing a method of driving the liquid crystal display device;

FIGS. 33A, 33B and 33C are explanatory drawings showing a method of driving the liquid crystal display device;

FIG. 34 is an explanatory drawing of the liquid crystal display device;

FIG. 35 is an explanatory drawing of the liquid crystal display device;

FIGS. 36A, 36B and 36C are explanatory drawings showing an operation of an OCB liquid crystal display device;

FIG. 37 is an explanatory drawing of the liquid crystal display device;

FIG. 38 is an explanatory drawing showing a method of driving the liquid crystal display device;

FIG. 39 is an explanatory drawing of the liquid crystal display device;

FIG. 40 is an explanatory drawing showing a method of driving the liquid crystal display device;

FIG. 41 is an explanatory drawing showing a method of driving the liquid crystal display device;

FIG. 42 is an explanatory drawing showing a method of driving the liquid crystal display device;

FIG. 43 is an explanatory drawing showing a method of driving the liquid crystal display device;

FIG. 44 is an explanatory drawing showing a method of driving the liquid crystal display device;

FIG. 45 is an explanatory drawing showing a method of driving the liquid crystal display device;

FIG. 46 is an explanatory drawing showing a method of driving the liquid crystal display device;

FIG. 47 is an explanatory drawing showing a method of driving the liquid crystal display device;

FIG. 48 is an explanatory drawing showing a method of driving the liquid crystal display device;

FIGS. 49A and 49B are explanatory drawings showing a method of driving the liquid crystal display device;

FIG. 50 is an explanatory drawing showing a method of driving the liquid crystal display device;

FIG. 51 is an explanatory drawing showing a method of driving the liquid crystal display device;

FIGS. 52A, 52B and 52C are explanatory drawings showing a method of driving the liquid crystal display device;

FIG. 53 is an explanatory drawing showing a method of driving the liquid crystal display device;

FIG. 54 is an explanatory drawing showing a method of driving the liquid crystal display device;

FIG. 55 is an explanatory drawing showing a method of driving the liquid crystal display device;

FIG. 56 is an explanatory drawing showing a method of driving the liquid crystal display device;

FIG. 57 is an explanatory drawing showing a method of driving the liquid crystal display device;

FIG. 58 is an explanatory drawing showing a method of driving the liquid crystal display device;

FIG. 59 is an explanatory drawing showing a method of driving the liquid crystal display device;

FIG. 60 is an explanatory drawing showing a method of driving the liquid crystal display device;

FIG. 61 is an explanatory drawing of a display equipment of the embodiment;

FIG. 62 is an explanatory drawing of the display equipment of the embodiment; and

FIG. 63 is an explanatory drawing of the display equipment of the embodiment.

### DETAILED DESCRIPTION OF THE INVENTION

Referring now to the drawings, a liquid crystal display device according to an embodiment of the invention will be described.

(1) Circuit Configuration of Liquid Crystal Display Device

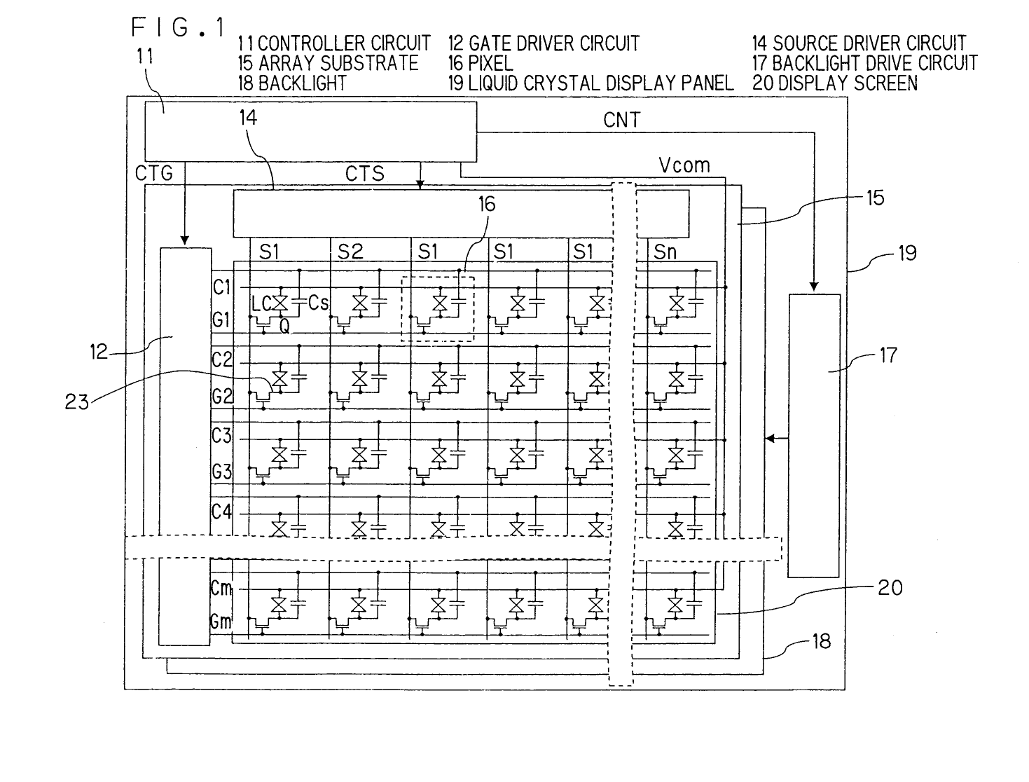

FIG. 1 schematically shows a circuit configuration of a liquid crystal display device according to this embodiment.

The liquid crystal display device includes a liquid crystal display panel 19, a backlight 18 that illuminates the liquid crystal display panel 19, a controller circuit 11 that controls the liquid crystal display panel 19 and the backlight 18, and a backlight driver circuit 17 that drives the backlight 18.

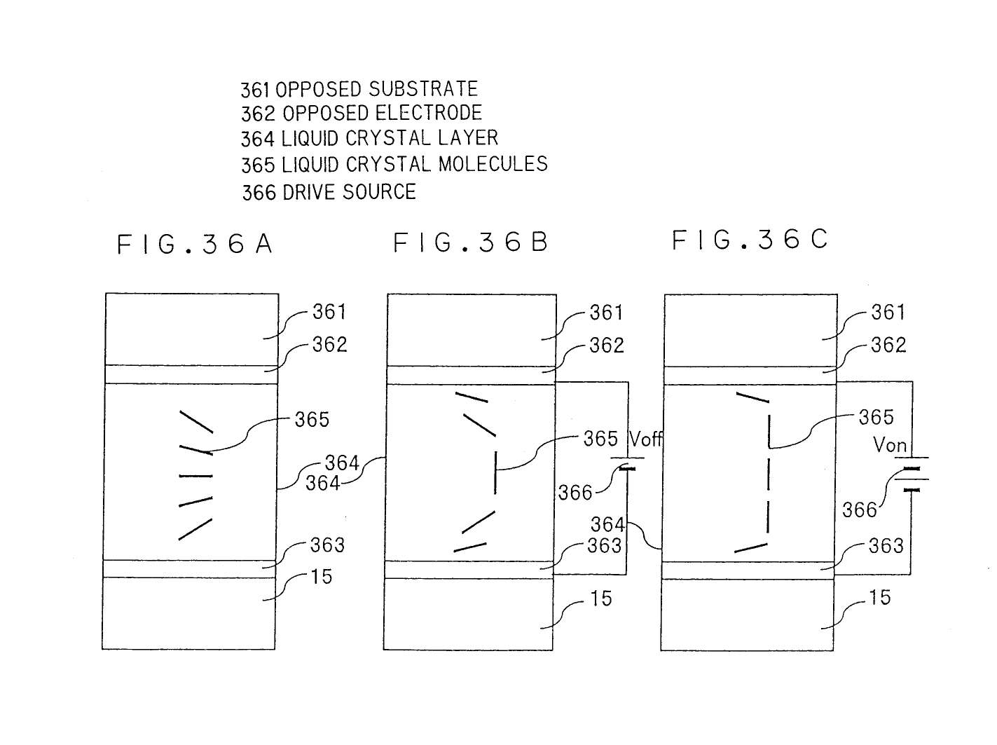

The liquid crystal display panel 19 has a configuration in which a liquid crystal layer 364 is sandwiched between a pair of electrode substrates, that is, an array substrate 15 and an opposed substrate 361. Examples of the liquid crystal layer 364 include TN liquid crystal, OCB mode (Optically Compensated Bend) liquid crystal, IPS (In Plane Switching) liquid crystal, and VA (Vertically Aligned) liquid crystal (see FIG. 36).

The array substrate 15 includes a plurality of pixel electrodes 23 arranged, for example, on a transparent insulating substrate such as glass in a substantially matrix pattern, a plurality of gate signal lines G (G1 to Gm) arranged along the rows of the plurality of pixel electrodes 23, and a plurality of source signal lines S (S1 to Sn) arranged along the rows of the plurality of pixel electrodes 23. The array substrate 15 includes a plurality of pixel switching devices Q arranged in the vicinities of intersections of the gate signal lines G and the source signal lines S. The pixel switching devices Q each are formed, for example, of a thin film transistor, and gates of the thin film transistors are connected to the gate signal lines G, sources of the thin film transistors are connected to the source signal lines S, and drains of the thin film transistors are connected between the pixel electrodes 23.

The opposed substrate 361 includes a color filter having colored layers of red (R), green (G) and blue (B) arranged on the transparent insulating substrate formed, for example, of glass, and opposed electrodes 362 arranged on the color filter so as to oppose the plurality of pixel electrodes 23. The color filter may be formed on the side of the pixel electrodes 23 of the array substrate 15. The color filter is formed over or under the pixel electrodes 23.

The pixel electrodes 23 and the opposed electrodes 362 each are formed, for example, of a transparent electrode material such as ITO, are covered with alignment layers which are applied with a rubbing processing in the direction parallel to each other, and constitute pixels 16 together with pixel areas as part of the liquid crystal layer 364 controlled to have a liquid crystal molecule alignment corresponding to an electric field from the pixel electrodes 23 and the opposed electrodes 362 (see FIG. 36). In the case of the IPS liquid crystal display panel, the opposed electrodes 362 are formed on the side of the array substrate, and the opposed electrodes 362 are not plane, but are linear signal lines. Such signal lines are also opposed electrodes since they also serve as electrodes and liquid crystal molecules are arranged between such signal lines and the pixel electrodes.

The plurality of liquid crystal pixels 16 each include a liquid crystal capacity LC between the pixel electrode 23 and the opposed electrode. For example, a configuration in which the capacity portions are connected in the row direction as auxiliary capacity lines, and a plurality of auxiliary capacity lines C1 to Cm are respectively connected to the pixel electrodes 23 of the liquid crystal pixels 16 of the respective corresponding rows in terms of capacity to secure an auxiliary capacity Cs may also be applicable.

The liquid crystal display device includes a gate driver circuit 12 that drives the plurality of gate signal lines G1 to Gm in sequence to conduct the pixel switching devices Q row by row and a source driver circuit 14 that outputs a pixel voltage to each of the plurality of source signal lines S1 to Sn respectively in the periods that the pixel switching devices Q in the respective rows are conducted by driving the corresponding gate signal lines G. The liquid crystal display device includes the backlight drive circuit 17 that drives the backlight 18.

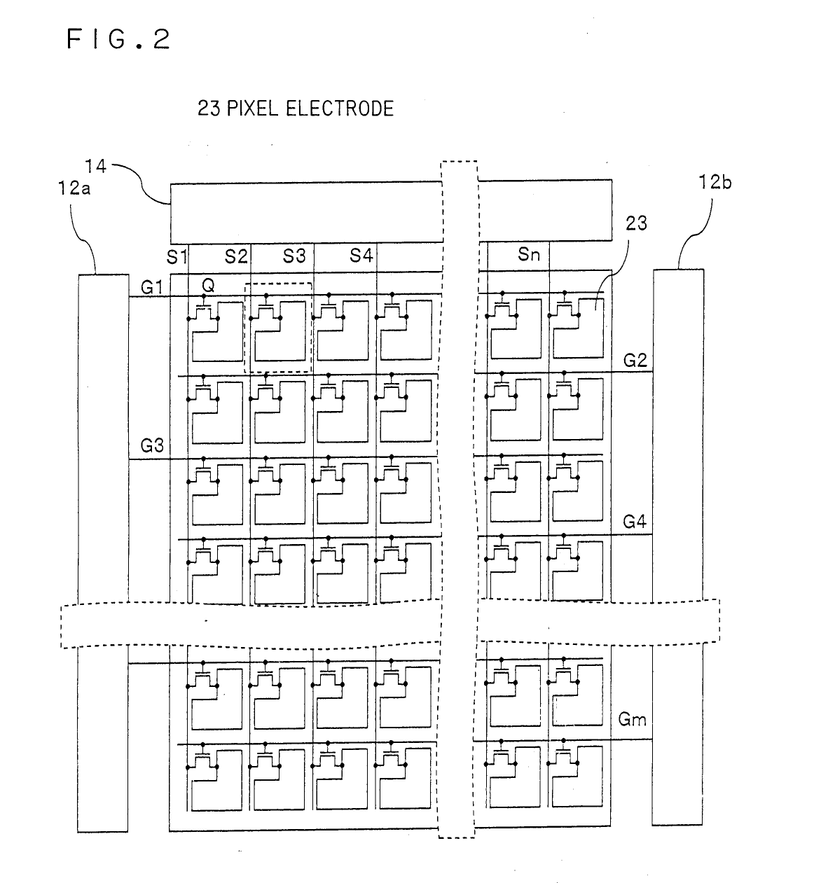

In the configuration shown in FIG. 1, the gate driver circuit 12 is arranged on one side of a display screen 20. The gate driver circuit 12 selects the gate signal lines G in sequence. In FIG. 2, the gate driver circuits 12 are arranged on both sides of the display screen 20. One of the gate driver circuits 12 selects ODD number^{th} gate signal lines G and the other gate driver circuit 12 selects EVEN number^{th} gate signal lines G.

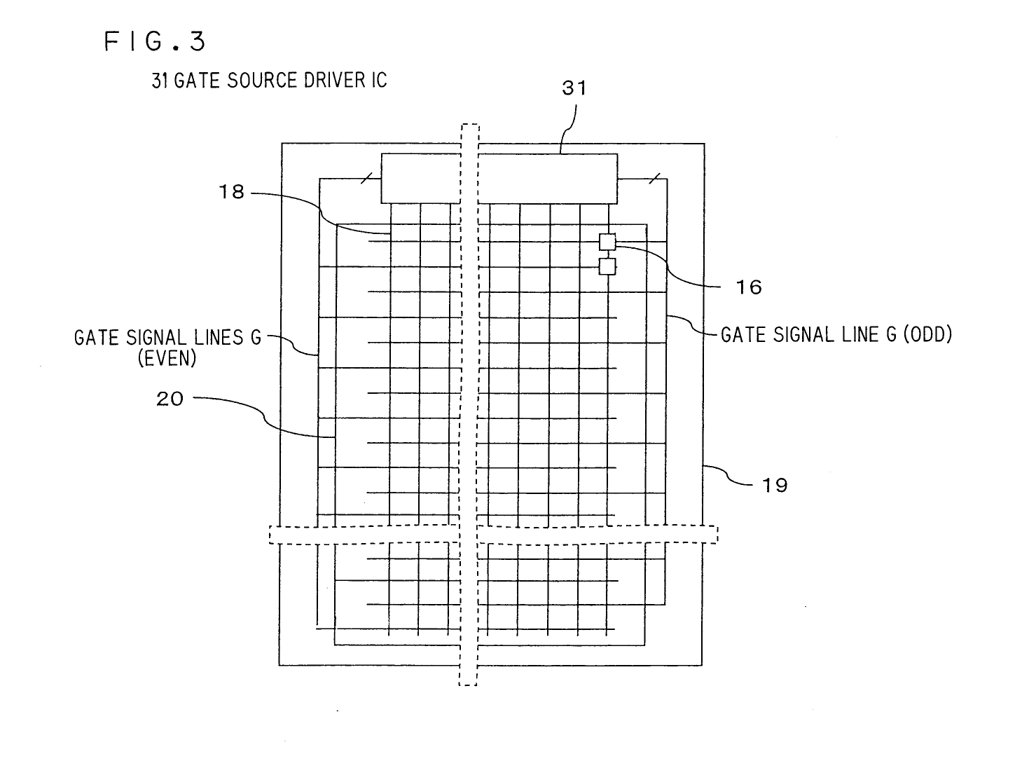

In the configurations shown in FIG. 1 and FIG. 2, the source driver circuit 14 and the gate driver circuit 12 are provided. However, the source driver circuit 14 and the gate driver circuit 12 may be combined into a single chip as shown in FIG. 3. By combining the circuits into a single chip as shown in FIG. 3, the functions of the source driver circuit 14 and the gate driver circuit 12 can easily be synchronized and common components such as a power source circuit and a logic circuit may be integrated, so that cost reduction is achieved.

In the configuration shown in FIG. 3, gate driver circuits are formed on the left and right sides of a gate source driver IC31. Formed on the right side of the gate source driver IC is an output circuit for 200 outputs of the gate signal lines G (ODD). Formed on the left side of the gate source driver IC is an output circuit for 200 outputs of the gate signal lines G (EVEN). The respective output circuits are connected to the gate signal lines G. The respective gate signal lines G are arranged into a staggered pattern.

The gate source driver IC31 is not limited to the IC, but may be of any form as long as it has a function to select the gate signal lines G and to generate video signals (source signals) to be applied to the source signal lines S. For example, a circuit formed by combining discrete components may also be applicable. Alternatively, it may be fabricated simultaneously with the pixel switching devices Q of the pixels 16 using low-temperature or high-temperature polysilicon process technology. The alternatives described above may also be applied to the source driver circuit 14, the gate driver circuit 12, and the controller circuits 11.

In the liquid crystal display device according to embodiments of the invention is not limited to the configurations shown in FIG. 1, FIG. 2 and FIG. 3. For the sake of simplification, description will be given assuming that the liquid crystal display device is configured as shown in FIG. 3 in this specification. The number of dots in the display area is assumed to be 240 RGB×400 dots. The gate signal lines G are assumed to be drawn out to the left and right directions alternately.

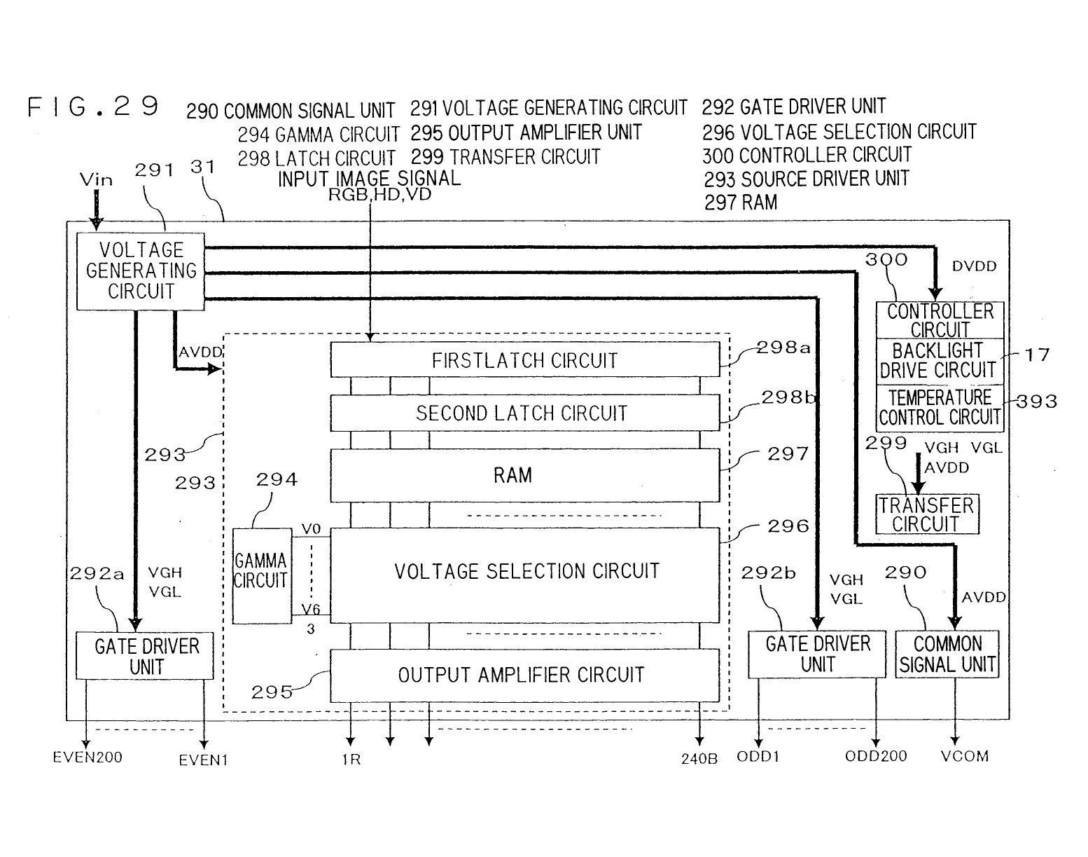

FIG. 29 is a block diagram showing the gate source driver IC31 shown in FIG. 3. Input video signals supplied to the IC31 include RGB video signals of a predetermined frame rate, horizontal synchronous signals HD, and vertical synchronous signals VD. The input video signals are latched in sequence and is held in a first latch circuit 298a. The first latch circuit 298a latches RGB data for one row of pixels. The data in the first latch circuit 298a is copied in a second latch circuit 298b by the next horizontal synchronous signals HD. Data in the second latch circuit 298b is written in a RAM 297. The RAM 297 holds the RGB data for one screen of the display screen 20.

The capacity of the RAM 297 corresponds to one screen when the frame rate of the input video signals and the frame rate of the output video signals outputted from 1R to 240B terminals, which are connected to the source signal lines S are the same. When the frame rate of the output video signals is 1.25 times the frame rate of the input video signals, at least a capacity of 1.25 times the image data for one screen is required. When the frame rate of the output video signals is 1.5 times the frame rate of the input video signals, at least a capacity of 1.5 times the image data for one screen is required. When the frame rate of the output video signals is twice the frame rate of the input video signals, at least a capacity of twice the image data for one screen is required. In the gate source driver IC31 in the embodiments of the invention, a required RAM capacity is integrated corresponding to the frame rate to be converted.

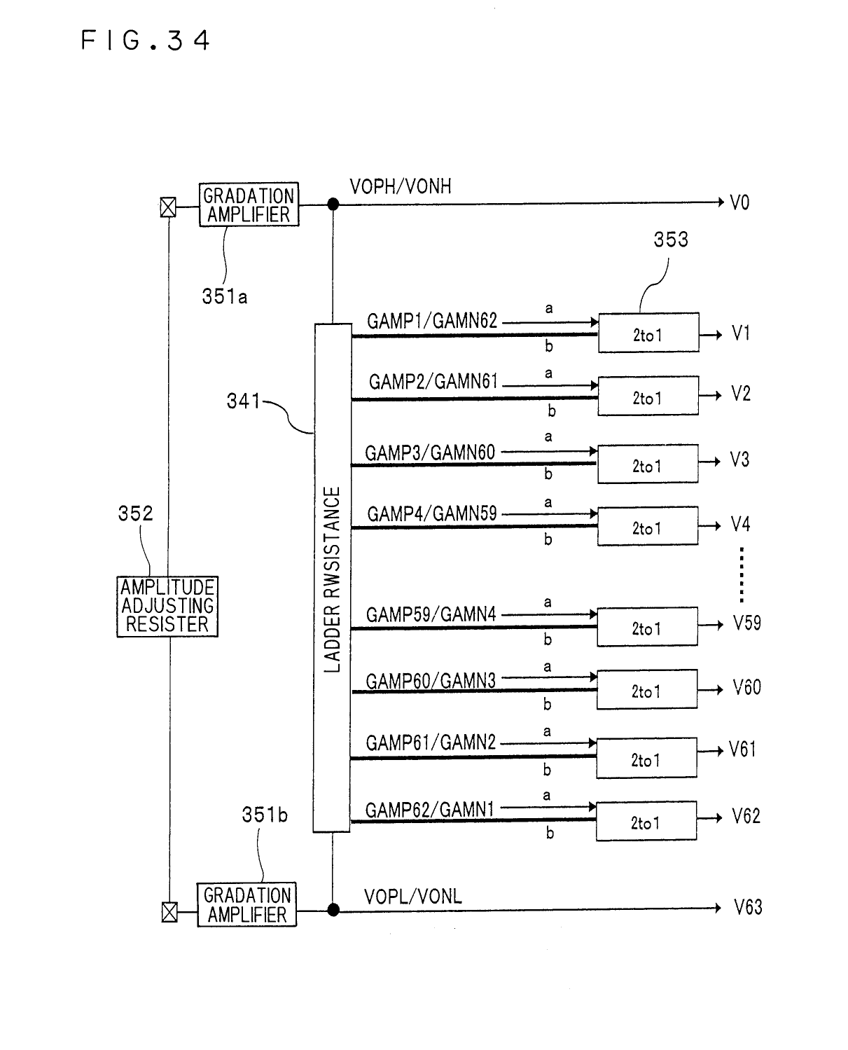

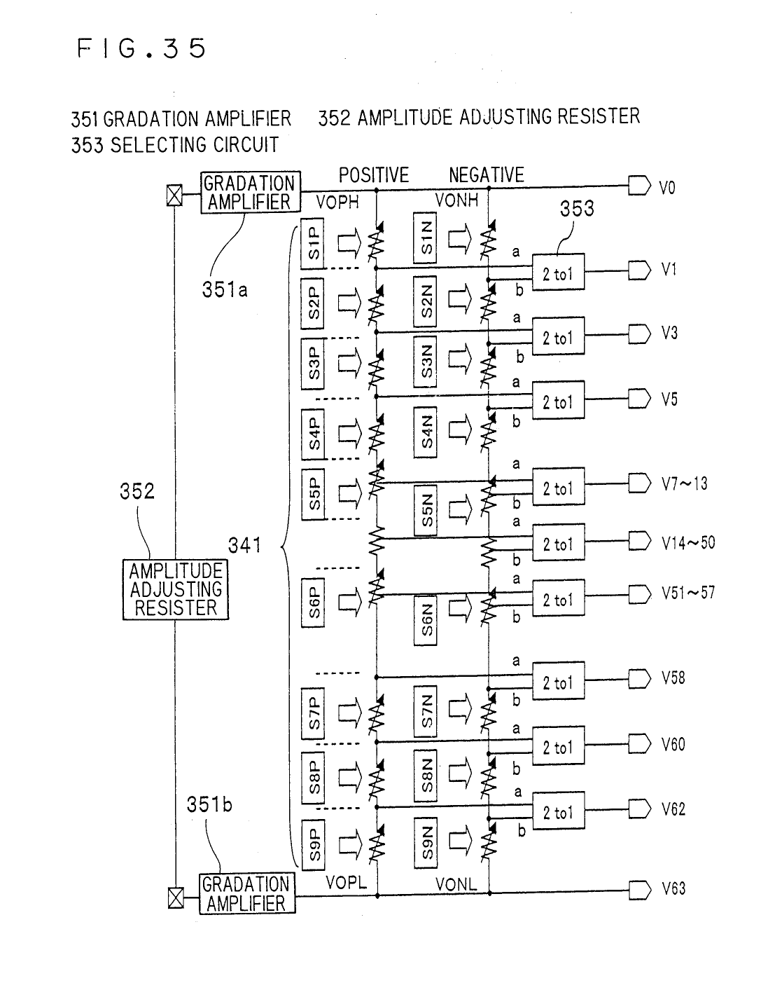

The voltages outputted from a gamma circuit 294, which will be described in conjunction with FIG. 34 and FIG. 35, are voltages of 6-bits (V0 to V63).

Data for one pixel row is read synchronously with the HD signals from the RAM 297. A voltage selection circuit 296 selects one of the voltages of the gamma circuit 294 corresponding to the data read from the RAM 296. The selected voltage is amplified by an output amplifier circuit 295 and is outputted to the source signal lines S (1R to 240B). Reference numeral 293 designates a video signal processing (control) circuit.

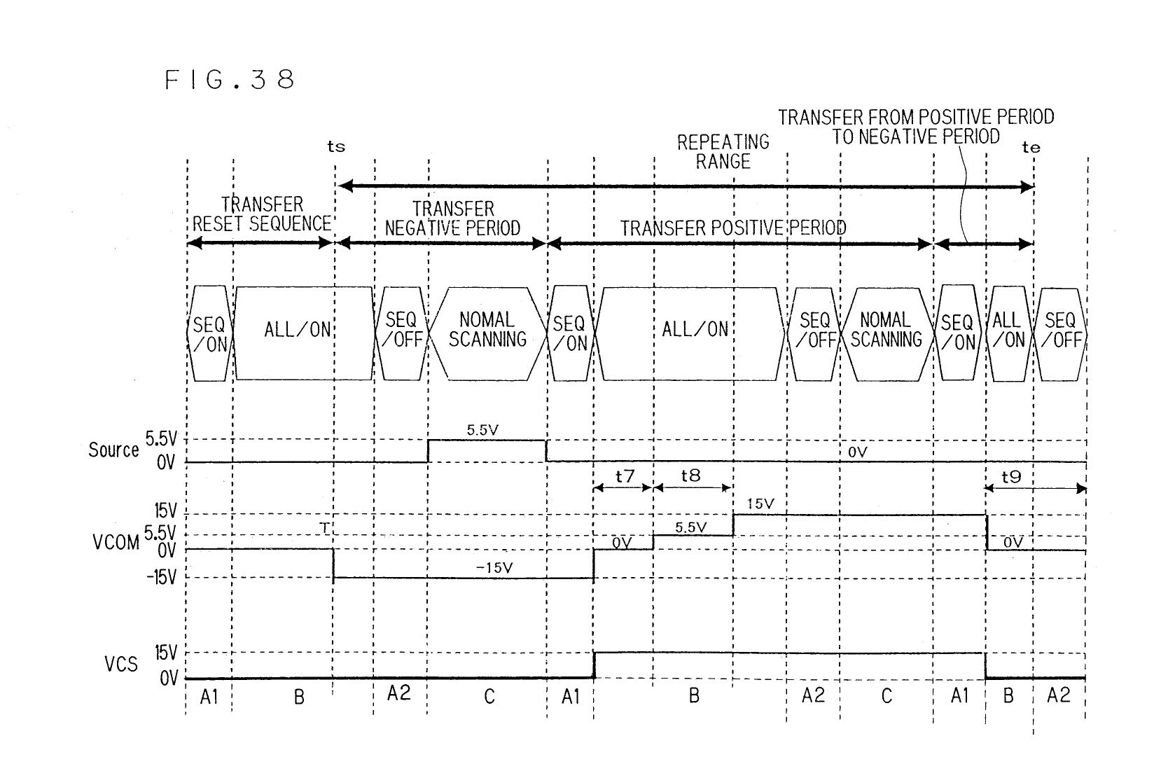

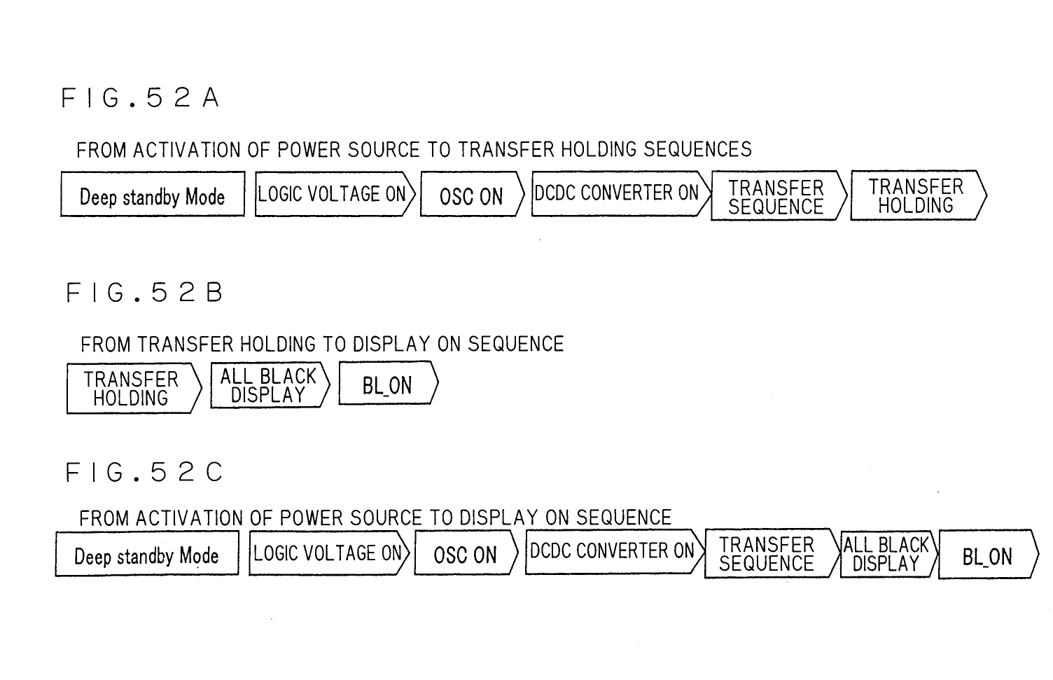

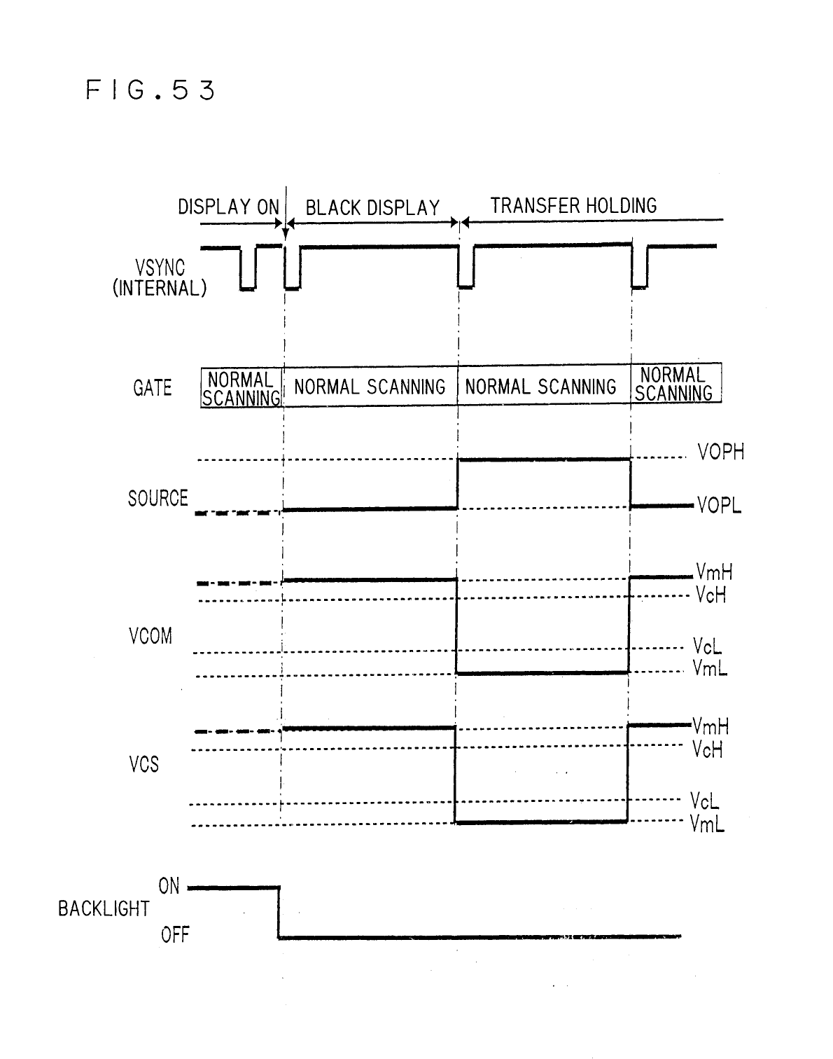

A gate driver unit 292 includes a timing processing circuit for the gate signal lines G and a selection circuit for the gate signal lines G. A common signal unit 290 generates VCOM signals. Transfer voltages are outputted to the opposed electrodes 362 under the control of a transfer circuit 299. A transfer sequence will be described in conjunction with FIG. 38, FIG. 52 and FIG. 53.

A voltage generating circuit 291 generates required voltages (AVDD, DVDD, VGH, VGL) from battery voltages Vin from a main body. The voltage generating circuit 291 also generates a transfer voltage used in the transfer circuit 299. The DVDD is a logic voltage of a controller circuit 300, and the AVDD is an analogue voltage for a source driver unit 293 and the common signal unit 290.

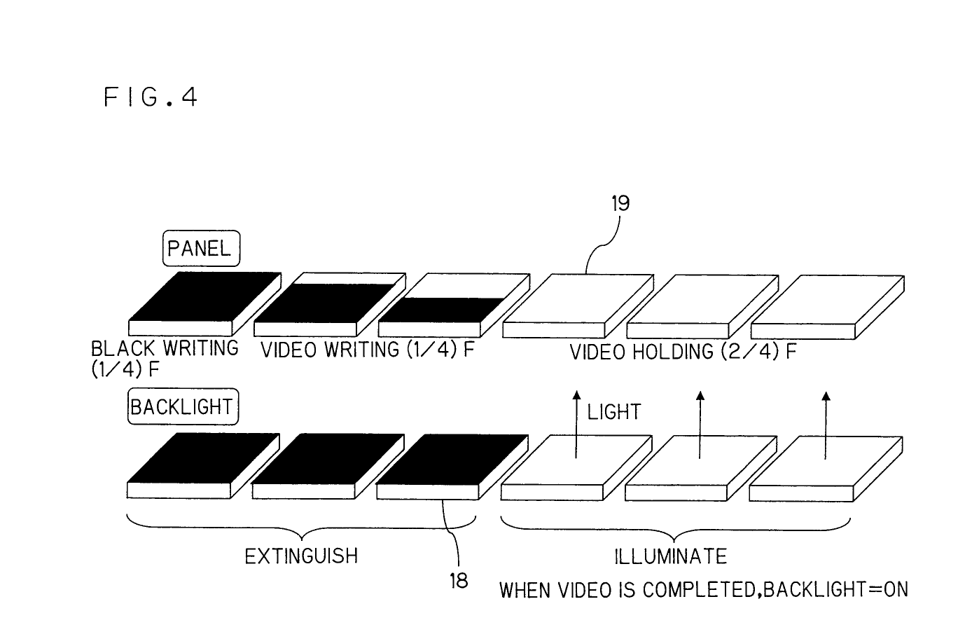

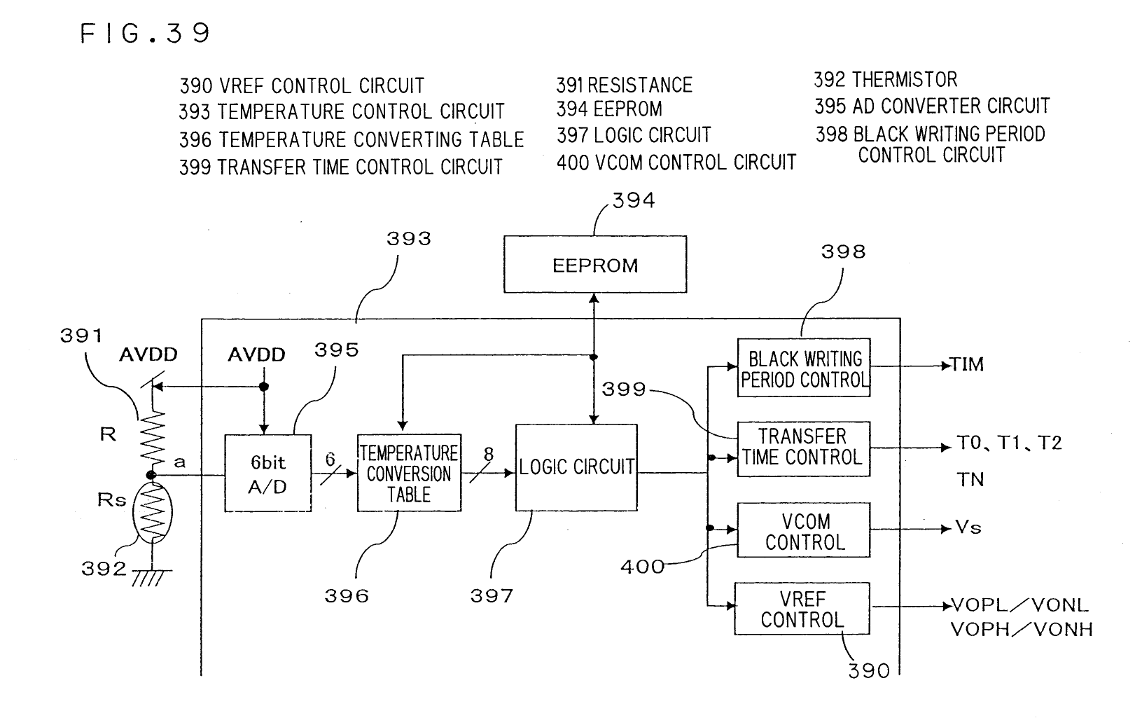

The controller circuit 300 is a control circuit for controlling timing and operation of the voltage generating circuit 291, the gate driver unit 292, the source driver unit 293, the common signal unit 290 and the transfer circuit 299. Reference numeral 17 designates the backlight drive circuit. The backlight drive circuit 17 controls to turn ON and OFF the backlight 18 as described in conjunction with FIG. 1 and FIG. 4. The backlight drive circuit 17 includes a temperature control circuit, described in conjunction with FIG. 39.

(2) Description of Drive System

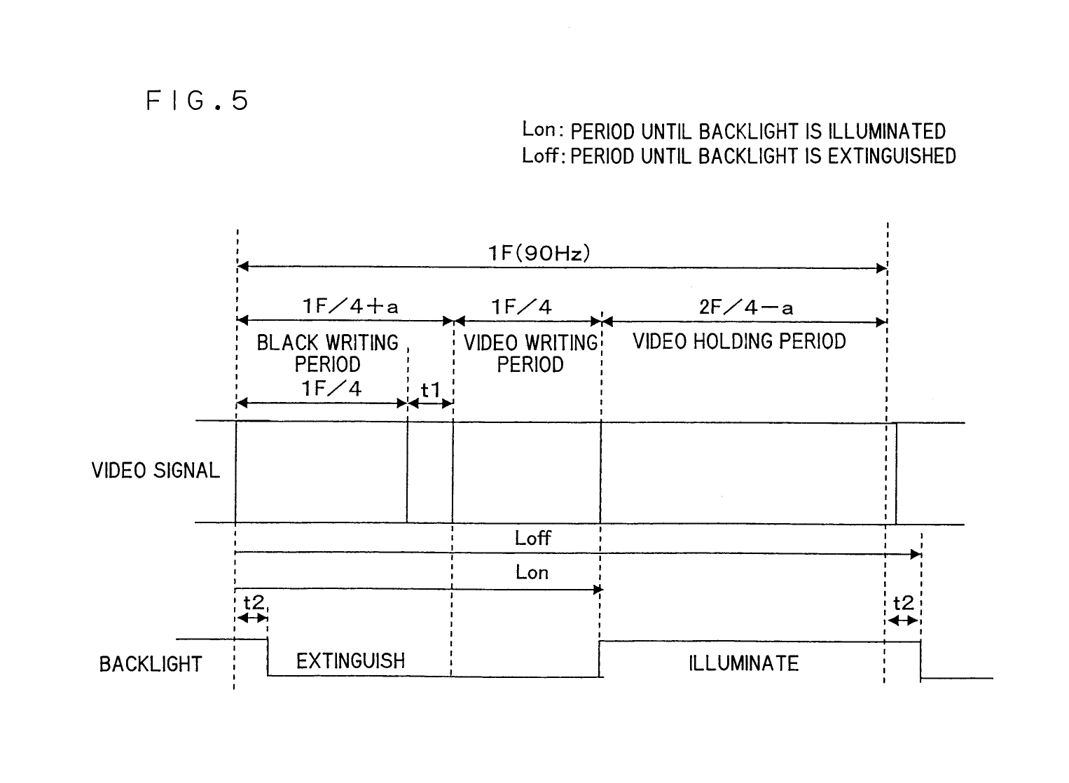

FIG. 5 shows a concept of the basic method of driving the liquid crystal display device according to this embodiment. In this embodiment, the operation of the liquid crystal display panel 19 and the operation of the backlight 18 are synchronously controlled. One frame (cycle or section in which one image is rewritten and an image is displayed) is divided into three operating sections. The term “one frame” in this specification does not mean a cycle to rewrite one screen. One frame is a cycle of a series of operations including the black writing period, the video writing period, and the video holding period. In order to facilitate understanding, it is assumed that one frame (1F) is divided or processed by the unit of ¼ or ½ frame (see also FIG. 4).

(2-1) Black Writing Period

The first 1F/4 period of one frame (1F) (black writing period) is a period during which a black voltage is written. The black voltage is applied to the display screen 20 in sequence from the top of the screen. In order to facilitate description, it is assumed that the black voltage (video signals or video data which is displayed in black) is applied during the first 1F/4 period. Although the expression “black voltage” is used, it means video signals to be written into the pixels 16 via the source signal lines S.

To apply the black voltage means to apply a voltage which lowers the coefficient of transmission of the liquid crystal layer to the liquid crystal layer 364. The voltage applied to the liquid crystal layer 364 is mainly determined by the common voltage applied to the opposed electrodes 362 and the voltage applied to the pixel electrodes 23. Since the liquid crystal is an AC drive, the coefficient of transmission of the liquid crystal layer is determined by an absolute value of the voltage applied to the liquid crystal layer. Therefore, to change the magnitude of the black voltage means to change the black voltage as the video signals to be applied to the pixel electrodes 23 when the common voltage is constant. When the video signals applied to the pixel electrodes 23 is constant, it means to change the common voltage. The magnitude of the black voltage is determined by the common voltage and the black voltage as the video signals. Therefore, the black voltage can be changed by changing either one of the common voltage and the black voltage as the video signals. It is also possible to consider that the black voltage to be applied during the black writing period is first video signals, and the video signals to be applied during the video writing period is second video signals.

The coefficient of transmission of the liquid crystal means a ratio of light entering the pixels by the operation of the polarizing property of a polarizing plate with respect to light outgoing from the polarizing plate. However, it is expressed technically such that the alignment state of the liquid crystal layer is changed, and the coefficient of transmission of the liquid crystal is changed.

A black writing period “a” corresponds to duration until a video writing period “b” starts. The black writing period “a” includes the period of outputting the black voltage to the source signal lines S and writing the black voltage into the pixels 16 (the black voltage writing period) and the black voltage holding period for holding the black voltage after having written into the pixels (blank period). The black voltage holding period starts from a time point when the black writing is finished.

During the black voltage holding period, a predetermined voltage is outputted from the source driver unit of the gate source driver IC31 to the source signal lines S. The predetermined voltage is preferably an intermediate potential between VOPH and VOPL. Actually, the predetermined voltage is voltages in a range from (VOPH-VOPL)/2−1(V) to (VOPH-VOPL)/2+1(V). Alternatively, the predetermined voltage is voltages in a range from 20% to 80% of the power voltage AVDD of the source driver unit. The voltage to be applied during the black voltage holding period is referred to as “holding voltage”. When the holding voltage does not fall within the range described above, the pixel leak is likely to occur, which is not preferable.

The predetermined holding voltage is applied also during the video holding period. The holding voltage is applied during the black voltage holding period and the video holding period, and the source signal lines S may have high impedance during the black voltage holding period and the video holding period. That is, the source drive unit and the source signal lines S are separated. It is also possible to apply the predetermined holding voltage to the source signal lines S at the beginning of the black voltage holding period or the video holding period, and then changed to the high impedance in the mid course.

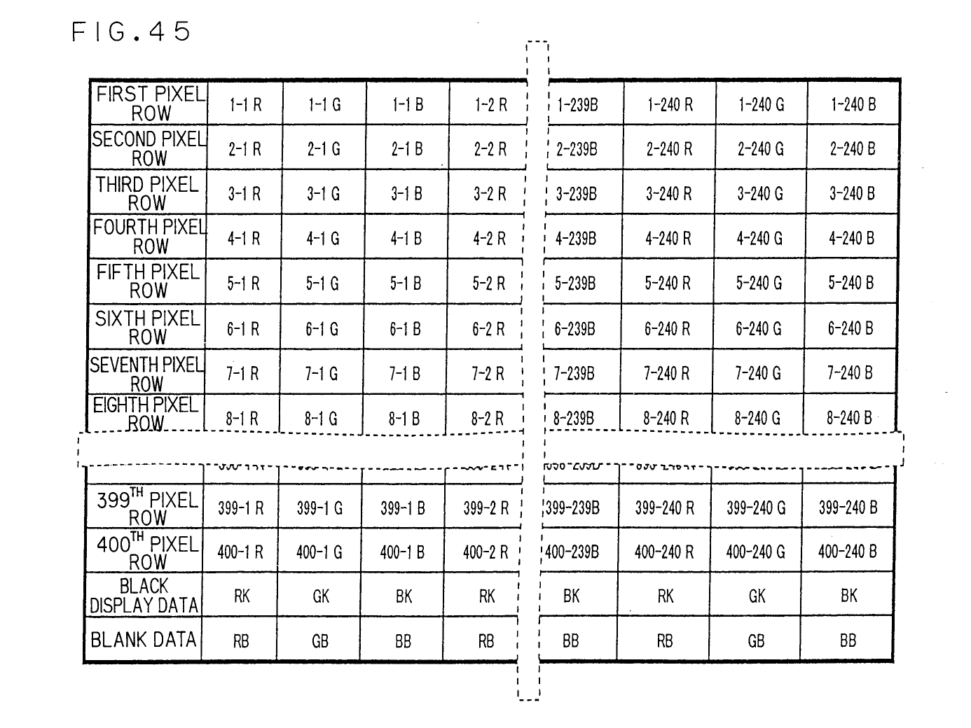

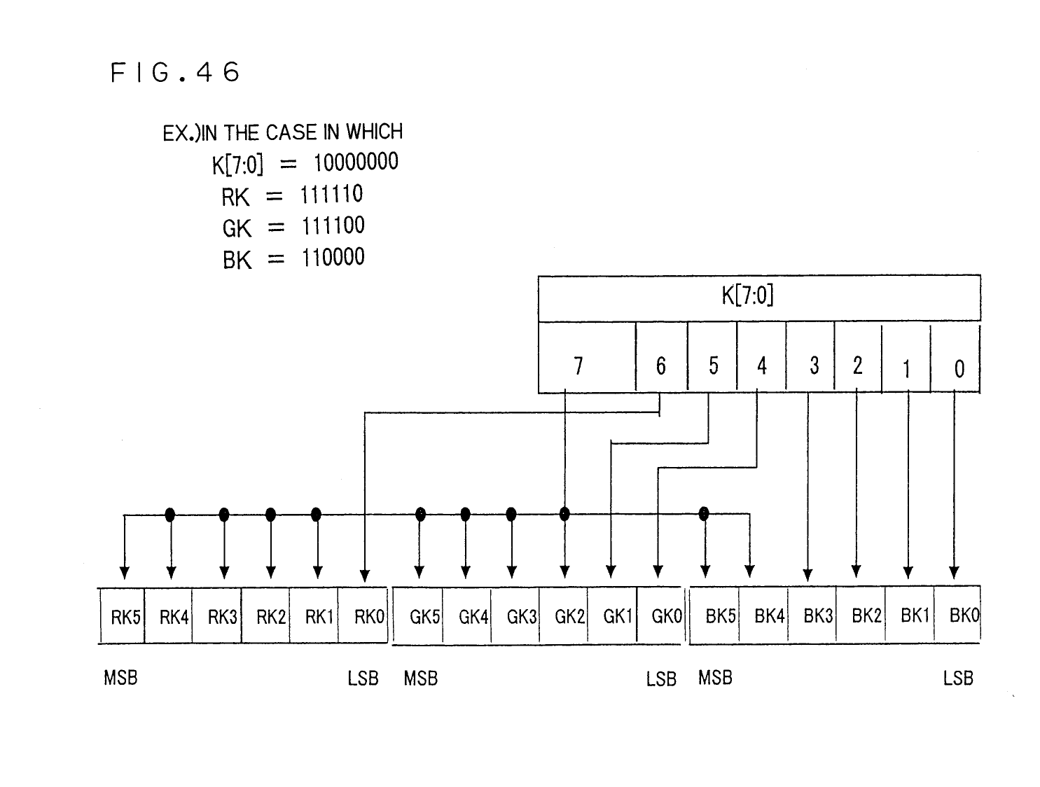

The holding voltage is written in the RAM area as blank data as shown in FIG. 45. The blank data is DA converted, and is applied with, for example, a polarity inverting process to obtain the holding voltage. The blank data may be acquired as a part of the video signals supplied to the liquid crystal display device. The blank data may also be stored in a format shown in FIG. 46.

In the embodiment, the voltage to be applied in these periods is not limited to the black voltage. It should be considered to be a predetermined voltage to be applied to the display screen 20. The predetermined voltage is preferably voltages which make the pixels to be displayed in black or near black. However, the predetermined voltage may be voltages which display low-gradation. In other words, the black voltage is low-gradation voltages, voltages which can hardly be visually recognized, or voltages which correspond to gradations which can hardly be visually recognized. In other words, the black voltage includes not only a voltage which corresponds to 0^{th} gradation, but also voltages which correspond to a wide range of brightness or luminance. The black voltage may be voltages which display white (high-gradation) as long as it can hardly be visually recognized. It is because the backlight 18 is in an extinguished state when the black voltage is written in this embodiment, and hence the image is not visible even in a white display (high gradation) in the black writing period. The predetermined voltage to be applied during the black writing period is not limited to the black voltage as described above. However, in order to facilitate understanding, or in order to facilitate description, the predetermined voltage to be applied during the black writing period is assumed to be the black voltage with low luminance in this specification, and the black writing period will be described referring to FIG. 36.

The black writing period is provided for causing the liquid crystal layer 364 to achieve the black display in a highest gradation or in a normally white mode and the white display in a normally black mode by applying black gradation signals as the video signals (source signals) and applying the common voltage VCOM signal to the opposed electrodes 362. The OCB liquid crystal has technical significance in that reverse transfer is prevented and the bend alignment is maintained by applying a high video signal (source signal) voltage to the liquid crystal layer 364 during the black writing period. Accordingly, the drive system in this embodiment can be applied to the liquid crystal display panels of both the normally white mode and the normally black mode. The above-described matter is applied to other embodiments of the invention.

The predetermined voltage to be applied during the black writing period may be a constant voltage over the entire display screen 20, and may be different voltages for red (R) pixels, green (G) pixels, and blue (B) pixels, because there is a liquid crystal mode in which an optimum black voltage is different among the RGB pixels. It is also possible to differentiate the predetermined voltage corresponding to the video signals (video data) to be written into the pixels during the subsequent video writing period for causing the respective pixels 16 to display the image. In other words, the predetermined voltage to be written during the black writing period differs from pixel to pixel.

(2-2) Video Writing Period

In a period of 1F/4 in the black writing period, the display image is written in sequence from the top of the screen of the display screen 20. The display image is written during the period of ¼ of one frame. Therefore, the writing speed of the display image (video) is a fourfold speed. One screen is rewritten during a period in which the ¼ screen is rewritten in the normal liquid crystal display panel. The image on the display screen 20 is rewritten from the upper side in sequence. In the video writing period, the video voltages corresponding to the video signals are applied to the pixels 16. In this video writing period as well, the backlight 18 is in the extinguished state. Therefore the state in which the image is rewritten is not visible. During this period, the gate driver circuit 12 is operated, and the voltage outputted from the gate source driver IC31 is written in the pixels in sequence.

The operation to apply the video signals during the video writing period is to apply a voltage to the liquid crystal layer 364. The voltage to be applied to the liquid crystal layer 364 is determined mainly by a common voltage to be applied to the opposed electrodes 362 to a voltage to be applied to the pixel electrodes 23. Therefore, to change the magnitude of the voltage to be applied to the liquid crystal layer means to change the video signals to be applied to the pixel electrodes 23 when the common voltage is constant. When the video signals to be applied to the pixel electrodes 23 are constant, it is to change the common voltage. The magnitude of the voltage to be applied to the liquid crystal layer 364 is determined by the common voltage and the video signals. Therefore, the voltage to be applied to the liquid crystal layer 364 during the video writing period can be changed by changing one of the common voltage and the video signals.

(2-3) Video Holding Period

A period after the video writing period is a video holding period. The video holding period is a period of ½ ( 2/4) of one frame. More accurately, it is a period obtained by subtracting the black writing period and the video writing period from one frame period.

The latter half period of the frame 2F/4 (=1F/2) is a period for holding the image which has rewritten during the video writing period. During this period, the operation of the gate driver circuit 12 stops. Therefore, little power is consumed. Although the operation of the gate driver circuit 12 stops, the source driver circuit outputs the voltages preset for the respective source signal lines. The voltages to be outputted are voltages of intermediate gradations. It is for preventing the potential of the pixels 16 from becoming unstable due to the potential of the source signal lines 14 becoming a floating state.

Although the backlight 18 is constantly illuminated during video holding periods “c” (c1, c2) in the embodiment presented in this specification, the embodiment is not limited thereto. It is also possible to control the backlight 18 to flush at a high-speed in the video holding periods “c” to adjust the light amount emitted from the backlight 18 and control the brightness. In other words, the technical idea in this embodiment is to make the image visible in the video holding periods “c”, and also to make the image of the liquid crystal display panel invisible in black writing periods “a”.

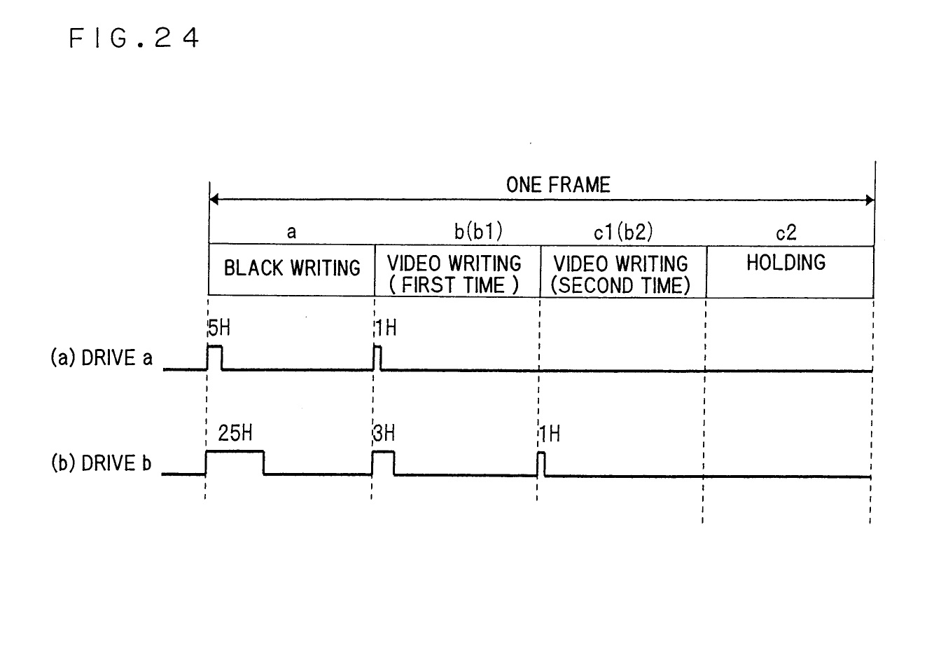

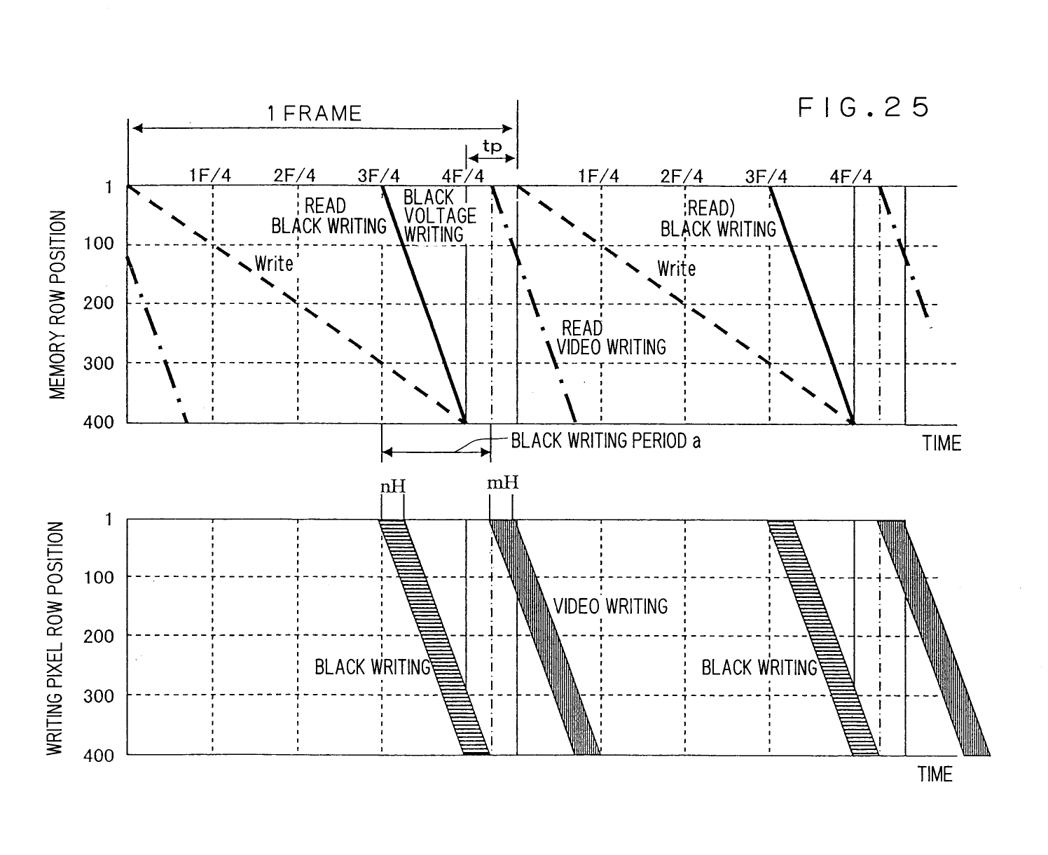

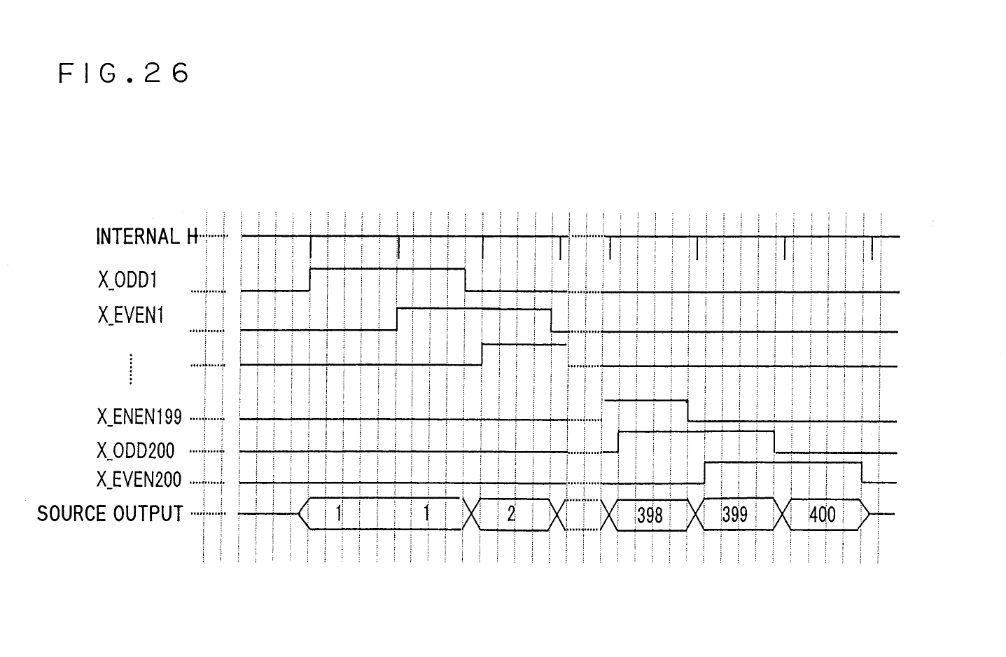

In the video signals may be written in the pixels 16 in the same manner as video writing periods “b” both or one of the video holding periods c1, c2 (see (b) in FIG. 24). The common signal holds the voltage constant. In the video holding periods c1 or c2, a plurality of the pixel rows may be selected (see FIG. 25, FIG. 26).

The backlight may be flushed at a frequency of a range from 1 KHz to 15 KHz in the video holding periods “c”. In the black writing periods “a” and the video writing periods “b”, the backlight is extinguished. Alternatively, the backlight is controlled to a substantially extinguished state. However, the embodiment is not limited to the mode in which the backlight 18 is not illuminated during this period. The embodiment is not limited to the mode in which the backlight 18 is illuminated during the video holding periods “c”. For example, in a reflective display panel, the backlight is not necessary even during the video holding period since the image is displayed by outside light. In the embodiment of the invention, the backlight 18 is flushed synchronously with the frame rate of the image display of the liquid crystal display panel. Basically, the backlight 18 is extinguished during the black writing periods and the video writing periods, and the backlight 18 is illuminated during the video holding periods. The duration of illumination of the backlight 18 is increased when the panel temperature is lower than a predetermined temperature, and when the peripheral luminance is higher than a predetermined luminance. When the duration of illumination is increased more than a certain extent, the duration of illumination also continues at least in one of the black writing period and the video writing period. Alternatively the illumination starts in an early stage. The duration of illumination of the backlight 18 is shortened when the panel temperature is higher than the predetermined temperature or when the peripheral luminance is lower than the predetermined luminance. When the duration of illumination is shortened beyond a certain extent, the backlight 18 is only illuminated during part of the video holding periods. The extinguished state continues even when the video holding period starts.

The backlight 18 is an illumination device for the liquid crystal display panel. Examples of the backlight include a backlight having white LEDs and a backlight having a fluorescent lamp. The backlight 18 employed in a projecting-type display device includes discharge (HID lamps, high-pressure mercury lamps, xenon lamps) which illuminates the liquid crystal display panel (light valve). The backlight 18 also includes a front light which emits light from the entire panel and illuminates the liquid crystal display panel.

(2-4) Intermittent Display of Image

In the drive system in which the lateral band-shaped black display portion is moved in the vertical direction of the screen in the related art, the image is also displayed intermittently. Therefore, the movie display performance is improved. However, since the backlight 18 is constantly illuminated, lowering of the contrast and increase in power consumption are resulted. In this embodiment, the backlight 18 is in an OFF (extinguished) state during the black writing period. Therefore, it is a complete black display in view, and hence lowering of the contrast does not occur. Since no light is generated from the backlight 18, the efficiency for light utilization is not lowered.

Since the image of the previous frame is rewritten in sequence in the subsequent image writing period, if it is visible, “movie blurring” occurs. However, since the backlight 18 is in the extinguished state during this period as well, the state in which the image is in the course of being rewritten is not visually recognized. It is the complete black display state visually.

As described above, during the black writing periods and the video writing periods, it is a state in which the movie visibility is normally lowered by rewriting of the image. However, it cannot be visually recognized by extinguishing the backlight 18.

In the period of 1F/2 on the latter half of one frame, the image rewritten during the video writing period is held. In this period, since the image is not rewritten, the image display state is completely stable in the period of 1F/2. Since the backlight 18 is illuminated during this period, the image is visually recognized.

The backlight 18 illuminated in the video holding period may be illuminated continuously to the first period of the black writing period “a” (near the first period). By illuminating the backlight 18 continuously, there is a possibility of lowering of the display contrast and occurrence of the luminance inclination. However, the brightness of the screen is improved. In the same manner, the backlight 18 may be illuminated during the last period (in the vicinity of the end) of the video writing period “b”. By illuminating the backlight 18 in the early stage, the luminance inclination may occur. However, the brightness of the screen is improved. Therefore, the driving method in this embodiment is not limited to a mode in which the backlight 18 is completely distinguished in the black writing periods “a” and the video writing periods “b”. At least, it should be considered that the backlight 18 is extinguished during a certain period in the black writing periods “a” and the video writing periods “b”. Alternatively, it should be considered that the backlight 18 is illuminated during a predetermined period in the black writing periods “a” and the video writing periods “b”. The predetermined period in which the backlight 18 is to be continuously illuminated is set to a range from 0 times to 0.2 times the black writing period “a” (the period to extinguish is in the range from 0.8 times to 1.0 times the black writing period), so that the image display which is satisfactory in practical use can be maintained. The predetermined period to start illumination of the backlight 18 early is set to a range from 0 times to 0.2 times the video writing period “b” (the period to extinguish the backlight is in the range from 0.8 times to 1.0 times the video writing period “b”) so that a desirable image display sufficient for practical use is achieved.

In a video holding period “c” as well, when the duration of illumination of the backlight 18 is shortened, the luminance of the screen is lowered. However, the display contrast is increased. Therefore, it should be considered that the backlight is illuminated for a predetermined period of the video holding period “c” in the driving method of this embodiment. The predetermined period to illuminate the backlight 18 is set to a range from 0.7 times to 1.0 times the video holding period “c” (the period to extinguish the backlight 18 is set to a range from 0 times to 0.3 times the black writing period), so that a desirable image display is achieved.

As described thus far, “to extinguish the backlight 18” during the black writing period “a” and the video writing period “b” means to extinguish the backlight 18 during a predetermined period or a certain period of the above-described periods, and does not mean to extinguish for the entire length of these periods. Also, “to illuminate the backlight 18” during the video holding period “c” means to illuminate the backlight 18 during a predetermined period or a certain period of the above-described periods, and does not mean to illuminate for the entire length of this period.

As described above, according to the driving method in this embodiment, the deterioration of the image quality is prevented by bringing the backlight 18 in the extinguished state during the black writing period in which the lowering of the contrast is likely to occur and the image writing period which may cause the movie blurring (the video signal rewriting period). In the latter half period of one frame, 2F/4 (=1F/2), the rewritten image is maintained without change, so that the movie blurring is prevented. By extinguishing the backlight 18 in a period of 1F/2 and illuminating the backlight 18 in a remaining 1F/2, the image is displayed intermittently. Therefore, very desirable movie display is achieved. Since the gate driver circuit 12 and the source driver circuit 14 are practically stopped operations during the latter half period of 2F/4 (=1F/2), reduction of power consumption is also achieved.

(2-5) Gate Signal Lines G and Source Signal Lines S

The gate signal lines G are provided by an odd number (ODD) 1 to 200 and an even number (EVEN) 1 to 200. That is, the total number of the gate signal lines G is four hundreds. The source signal lines S are formed by a number corresponding to 240 RGB pixels. Therefore the total number of the source signal lines S is 240×3.

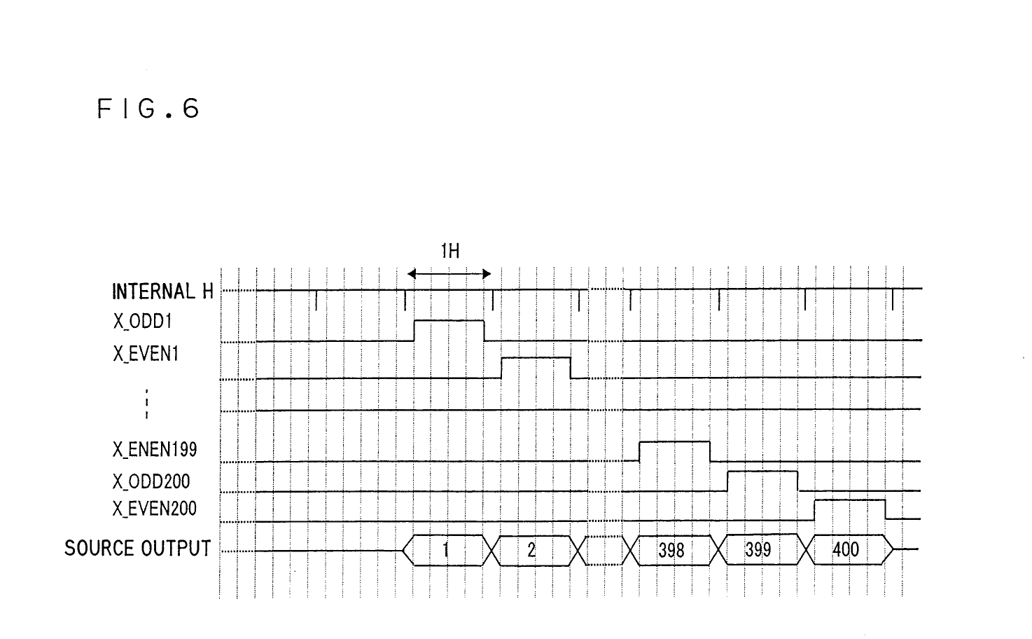

FIG. 6 is a timing chart of the gate signal lines G and the source signal lines S. The position of the selected gate signal line G is shifted in sequence for each internal horizontal synchronous signal (internal H).

The reason why it is expressed as the internal H is for discriminating from horizontal synchronous signals of the video signals applied to the liquid crystal display device (external H). The internal H is synchronous signals generated from internal clock signals (CLK) of the liquid crystal display device in this embodiment.

Internal vertical synchronous signals (internal V) are also the same. It is for discriminating from vertical synchronous signals (external V) of the video signals applied to the liquid crystal display device. The internal H is synchronous signals generated from the internal clock signal (CLK) of the liquid crystal display device in this embodiment. The internal H and the internal V are synchronized.

Synchronously with the internal H, the gate signal lines G are selected in sequence from X_ODD 1, X_EVEN 1, X_ODD2, X_EVEN2, X_ODD3, X_EVEN3, . . . , X_ODD 200 to X_EVEN 200. Synchronously with the selection of the gate signal lines G, the video data or the black voltage is applied to the source signal lines S.

(2-6) Variability of Black Writing Period and Illumination of the Backlight

FIG. 5 is an explanatory drawing showing a state of application of the video signals (source signals) such as the black writing period, and states of illumination and extinction of the backlight 18. In FIG. 5, one frame period (frame rate) is assumed to be 90 Hz (image is rewritten 90 times every second). The one frame period is set at least to 70 Hz. When the frame rate to be inputted to the liquid crystal display device is lower than 70 Hz (60 Hz, 50 Hz, for example), the frame rate is converted to at least 70 Hz in the liquid crystal display device in this embodiment.

The one frame is synchronized with the internal V (vertical synchronous signal used in the internal operation of the liquid crystal display device). The selection of the gate signal lines G is synchronous with the internal H (horizontal synchronous signals used in the internal operation of the liquid crystal display device).

The black writing period in the embodiment shown above is 1F/4. This period may be effectively elongated. In FIG. 5, it is shown as awaiting time t1. In the black writing period, the black voltage is written from the top side of the display screen 20 in sequence. The period required to write until the bottom side is 1F/4. The gate driver circuit 12 selects the gate signal lines G from ODD 1 to EVEN 200. The gate source driver IC31 outputs the black voltage to the source signal lines S, and writes the black voltage to the pixels 16 corresponding to the selection of the gate signal lines G. The polarity of the signals that the gate source driver IC31 outputs to the source signal lines S is inverted frame to frame.

The period required until the application of the black voltage to the display screen 20 is 1F/4. At a time point when the application of the black voltage is finished, the gate source driver IC31 selects no gate signal lines G and stops operation. The source signal lines S are kept in the state of being applied with the black voltage. It is for stabilizing the potentials of the source signal lines S.

The liquid crystal layers 364 of the pixels 16 start changing right after the application of the black voltage. However, it takes a certain time to achieve the change. At a time point when 1F/4 of the black writing period is finished, the pixels 16 at the upper portion of the screen have completely changed by the application of the black voltage. However, the pixels 16 at the bottom of the screen are not completely changed because only a short time has passed since the black voltage is applied. A waiting time until the pixels 16 at the bottom of the screen are completely changed is the waiting time t1. When the waiting time t1 is not provided for a predetermined duration, luminance inclination may occur between the upper portion and the bottom of the display screen 20. The waiting time t1 is duration of 1F/4 at the maximum.

The period “a” differs depending on the mode of the liquid crystal. In the TN liquid crystal mode, it needs to be set to relatively a long period. In the case of the OCB liquid crystal mode, since the response of the liquid crystal molecules is quick, it may be a short period. The liquid crystal has a dependency on the temperature. Therefore it is preferable to configure to detect (measure) the external temperature with a temperature sensor such as a thermistor so that the waiting time t1 can be changed. After having elapsed the waiting time t1, the video writing period starts.

The video writing period is 1F/4. The gate driver circuit 12 selects the gate signal lines G from ODD 1 to EVEN 200. The gate source driver IC31 outputs the video signals (video data) corresponding to the pixels to the source signal lines S, and writes the video signals (source signals) to the pixels 16 corresponding to the selection of the gate signal lines G. The video holding period is; a period 1F−(black writing period+waiting time t1+video writing period). The black writing period “a” may be considered to include the waiting time t1. The black writing period includes a period in which the black voltage is written to the pixels (black voltage period) and a period in which the black voltage is held (the black voltage holding period), and the waiting time t1 changed by the temperature.

The backlight 18 is illuminated at a time point when the video writing period is ended. However, there is also the response time of the liquid crystal of the pixels 16 in the video writing period. At the timing when the video writing period is ended, the pixels 16 at the upper portion of the screen are completely changed by the application of the video signals. However, the pixels 16 at the bottom of the screen are not completely changed because only a short time is passed since the video signals (source signals) are applied. Therefore, it is preferable to provide a waiting time t2 as in the case of the black writing period. The waiting time t2 is equal to or shorter than the waiting time t1 of the black writing period at the longest. It is because that change of the screen by the response of the video signal does not cause the luminance inclination in the screen, and has little adverse effect.

The backlight 18 is illuminated at the time point when the video holding period is ended. It is preferable to provide the waiting time t2 for illumination as well. The longer the waiting time t2 is, the brighter the screen luminance becomes. The waiting time t2 corresponds to the black writing period. The black voltage is written from the top of the screen. The video display is still going on at the bottom of the display screen 20.

During the waiting time t2, the luminance at the upper portion of the screen is lowered. However, a certain period is needed for the response of the liquid crystal. Even when the black voltage is applied, the previous video display is continued for a certain period. Therefore, since a state in which the video display is continued on the upper portion and the lower portion of the display screen 20 exists in the waiting time t2, the brightness of the display screen 20 can be improved by the provision of the waiting time t2.

The waiting time t2 differs depending on the liquid crystal mode. In the TN liquid crystal mode, it can be set to relatively a long period. In the case of the OCB liquid crystal mode, since the response of the liquid crystal molecule is quick, the power efficiency of the backlight 18 is lowered when it is not a short time. The liquid crystal has a dependency on the temperature. Therefore, it is preferable to configure to detect (measure) the external temperature with the temperature sensor such as the thermistor, so that the waiting time t2 can be changed.

The starting positions of the timings of illumination and extinction of the backlight 18 are set as follows. The starting positions correspond to the starting positions of the respective frames for illumination and extinction. The internal vertical synchronous signals of the liquid crystal display device are applied at the starting positions of the frames. An extinction counter for counting the timing of extinction of the starting positions of the frames is reset at the starting positions of the frames. An illumination counter for counting the timing of illumination of the backlight 18 is also reset.

When the value of the extinction counter matches a set value, the backlight 18 is extinguished. When the value of the illumination counter matches the set value, the backlight 18 is illuminated. The set values are stored in an EEPROM as an external storage. The values stored in the EEPROM may be rewritten by a micro computer or the like. The waiting time t1, the waiting time t2 are set with the internal H (the horizontal synchronous signal used in the internal operation of the liquid crystal display device) as one unit.

In the embodiment shown above, the waiting time t1 and the waiting time t2 are changed by the temperature. Alternatively, it is also possible to change with the external intensity. The magnitude of the external intensity is measured by arranging a PIN photo diode (photo sensor) outside the liquid crystal display device, and detecting and measuring an output current of the photosensor.

When the external intensity is high, the contrast of the display screen may be low. It is desired to increase the luminance of the screen. In this case, it is effective to increase the duration of illumination of the backlight 18. Therefore, the waiting time t2 is set to be longer. When the external intensity is low, the luminance of the display screen 20 is not necessary. However, it is desired to increase the contrast of the display screen. In this case, the waiting time t2 is set to a short time or zero. The waiting time t2 is set by rewriting by the micro computer.

In the OCB liquid crystal display panel, the reverse transfer is likely to occur at a low temperature. Therefore, it is effective to make the black writing period “a” variable corresponding to the panel temperature. Also, by shortening the black writing period “a” and increasing the video holding period “c” (c1, c2), the duration of illumination of the backlight 18 can be increased, so that a high-luminance display is achieved.

The panel temperature is preferable a temperature of the display area of the liquid crystal display panel. Actually, the temperature in the periphery of the panel and the temperature of the interior of a casing are used as the panel temperature. The panel temperature is also estimated from the outside air temperature. Any of these temperatures corresponds to the panel temperature in this specification.

Variation or adjustment of the waiting time t1 is effectively achieved by switching the images to be displayed on the liquid crystal display panel between still images and movie. In the case of the movie, the longer the black writing period “a” becomes, the more the movie display performance improves. In the case of the still images, it is not necessary to improve the movie display performance. It is effective for reducing the black writing period “a” and restraining generation of flicker. It is also possible to differentiate the input frame rate to be transmitted between the movie and the still image. In the case of the movie, the frame rate may be low. In the case of the still image, the input frame rate is increased to restrain the flicker. The description given above may be applied to other embodiments of the invention, or it may be combined with other embodiments of the invention to implement this embodiment.

(2-7) Common Signals

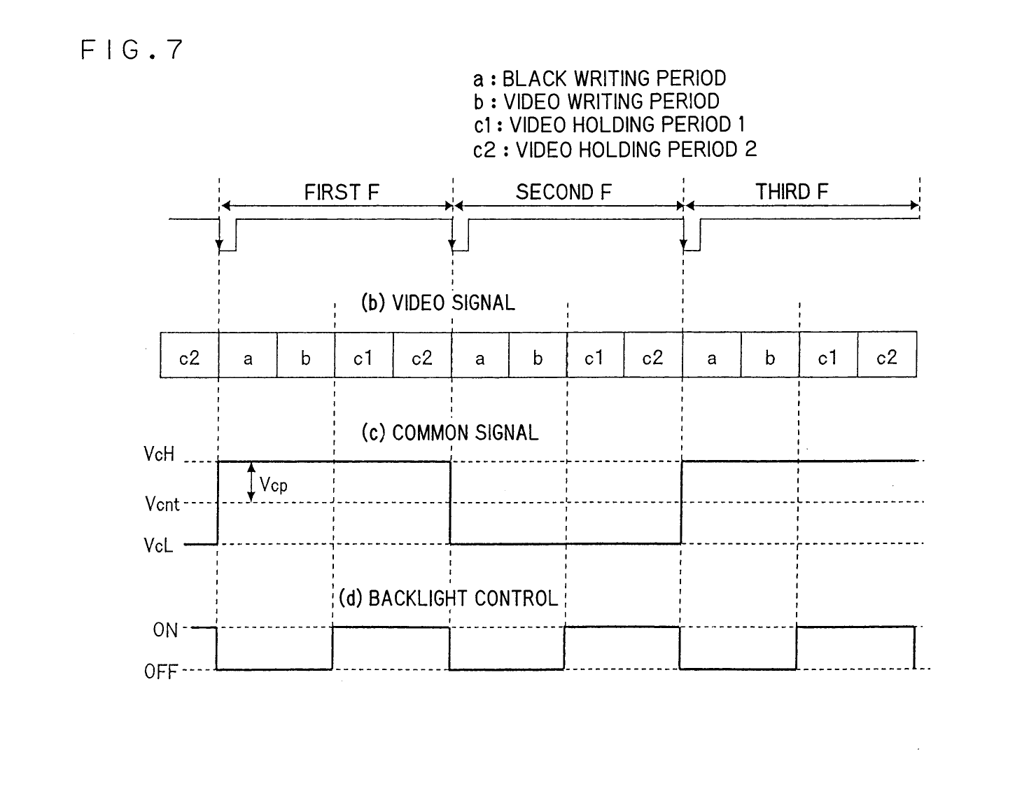

FIG. 7 shows a change of the common signal. In FIG. 7, the black writing period is represented by “period a”, the video writing period is represented by “period b”, and the video holding periods are “c1, and c2”. In order to facilitate description, the waiting times t1 and t2 are not considered as in FIG. 5, and the black writing period “a”, the video writing period “b”, and the video holding periods c1, c2 are respectively 1F/4.

The polarity of the common signal is inverted frame to frame. The common signal deflects between VcH, VcL with Vcnt as a center. The values of VcH, VcL differs depending on the liquid crystal mode, and also on the coefficient of transmission, the luminance, and the temperature of the liquid crystal.

The backlight 18 is turned ON (illuminated) in the video holding periods “c” (c1, c2) and is turned OFF (extinguished) during the black writing periods “a” and the video writing period “b”.

(2-8) Frame Inversion Drive

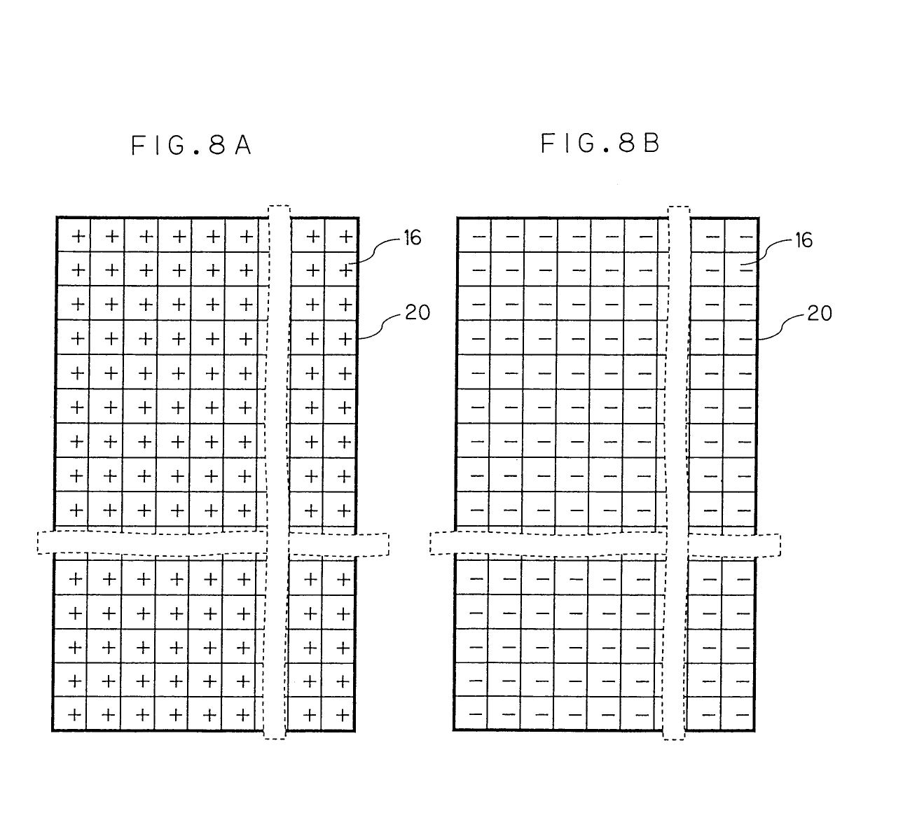

As shown in FIGS. 8A and 8B, a frame inversion method is basically employed in this embodiment. The common voltage signals VCOM is applied to the opposed electrodes 362, and voltages having opposite polarities are applied to the frames alternately. In FIG. 8A, the signs “+” marked in the pixels 16 represent a state in which the positive video signals or the common voltage are applied. In FIG. 8B, the signs “−” marked in the pixels 16 represent a state in which the negative video signals or the common voltage is applied.

FIG. 8A shows a state in which rewriting of the positive video signals or the common voltage in the ODD frame is terminated. FIG. 8B shows a state in which rewriting of the negative video signals or the common voltage in the EVEN frame is finished.

The image held in the previous frame is rewritten from the top of the display screen 20 in sequence into the black display and the image display state of the liquid crystal display panel 19 becomes the black display in the period of 1F/4.

In the subsequent 1F/4 period, the display image is written from the top of the display screen 20 in sequence. In other words, the image writing speed is a fourfold speed. Four rows of pixels are rewritten in a period in which one pixel row is rewritten in the normal liquid crystal display panel.

The latter half period of one frame, 2F/4 (=1F/2) is a period for holding the image which is rewritten previously. In this period, the operations of the source driver circuit 14 and the gate driver circuit 12 are stopped. Therefore, little power is consumed.

The backlight 18 is controlled to be the extinguished state during the former half period of 1F/2 of the frame. That is, since the backlight 18 is not illuminated (extinguished) during the black writing period and the screen rewriting period (video signal rewriting period), and hence the image display state of the liquid crystal display panel 19 is invisible.

(2-9) Writing to RAM

In this embodiment, the video signals are written in the display screen 20 in the period of 1F/4. Therefore, it is necessary to write the image at a fourfold speed. Therefore, a RAM (memory circuit) for holding the video signals supplied from the outside of the liquid crystal display device for the period of one frame is needed.

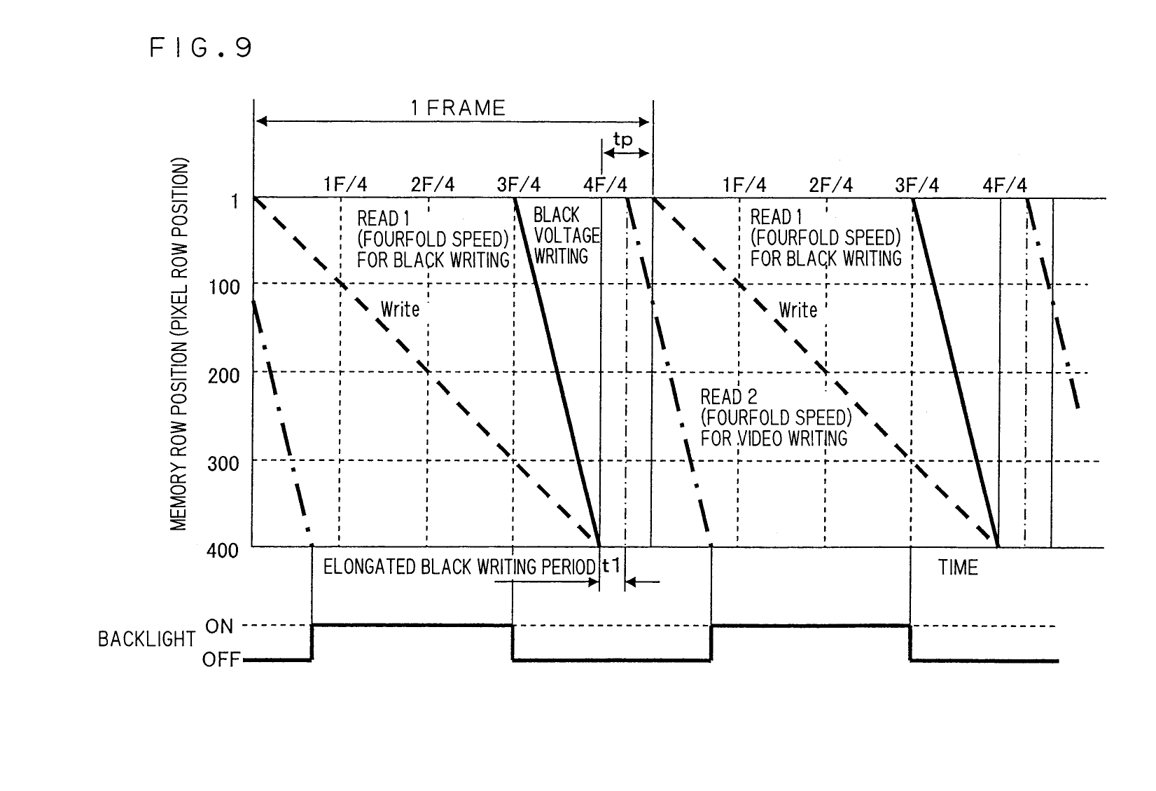

FIG. 9 is an explanatory drawing for explaining writing to and reading from the memory. The video writing period and the black writing period are assumed to be 1F/4. However, this expression is not accurate because there exists a blank period tp in one frame (1F). The video writing period and the black writing period are (1F period−tp)/4 to be exact. However, in order to facilitate understanding, writing and operation are assumed to be performed in the video writing period, the black writing period and the video holding period by the unit of 1F/4. In order to facilitate description, the blank period tp in one frame period is zero. Writing of the black voltage to the display screen and writing of the video signals to the display screen are performed in 1F/4. The period of 1F/4 is a period required for selecting the gate signal lines G from the first gate signal line G to the last gate signal line G. It is also the period required for rewriting one screen. It is adequate to consider the period of 1F/4 as a period for selecting all the pixels on the display screen, or a period for applying the voltage thereto, or a period for selecting all the gate signal lines G rather than to consider as ¼ of one frame.

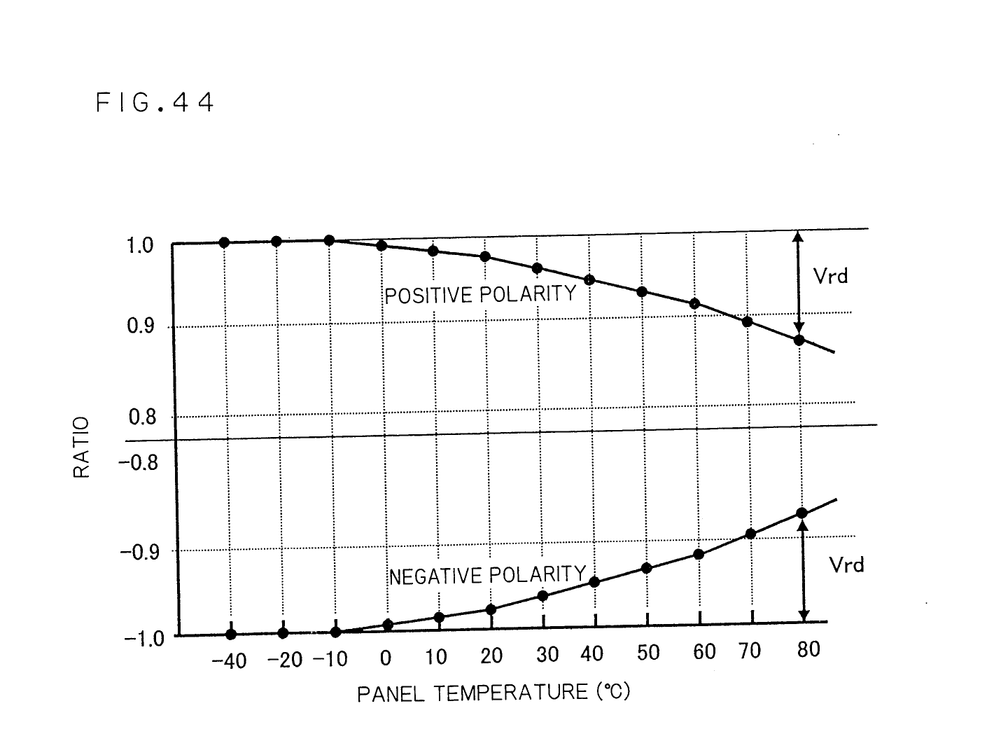

The RAM (rewritable memory SRAM) has a capacity to hold the image data for one screen. The RAM has a configuration in which input and output can be achieved by the unit of one pixel row (240 RGB×6 bit). The RAM has a capacity for the number of rows of pixels to be displayed in the display screen 20+α a rows of pixels. The capacity for the α rows of pixels will be described later in conjunction with FIG. 44.

Examples of the RAM include a flash memory in addition to a DRAM and the SRAM. The fixed data may be stored in a ROM.

The RAM possessed by the gate source driver IC31 is not limited to one block. It is also possible to provide a plurality of blocks of RAMs. By writing or storing different video signal data in the plurality of blocks of the RAMs, and reading the pixels by row from each of the RAM blocks provided therein, a plurality of pixel rows can be read simultaneously, and written into the pixel rows of the liquid crystal display device. Therefore, high speed writing is achieved.

Since the liquid crystal display device in this embodiment has 400 pixel rows, the required memory is 240 RGB×6 bit×400 pixel rows. In FIG. 9, the configuration of the RAM is the same as the concept of the pixel rows, and the memory positions in the RAM is memory row positions 1 to 400. That is, the memory row positions are equal to the pixel row positions. For example, the data of 240 RGB×6 bit in the 10^{th} pixel row is held at the position of the 10^{th} row of the memory row positions, and the video data to be written in the 10^{th} pixel row is read from the 10^{th} row position from among the memory row positions. The data of 240 RGB×6 bit in the 20^{th} pixel row is held at the position of the 20^{th} row of the memory row positions, and the video data to be written in the 20^{th} pixel row is read from the position of the 10^{th} row from among the memory row positions.

The video signals supplied from the outside into the liquid crystal display device are stored in the RAM taking the period of 1F as shown in FIG. 9 by dot lines (write) (the period from 0 to 4F/4). The period of 1F becomes (one frame−tp) when there is the blank period tp. The black voltage may also be applied as the black signals supplied to the liquid crystal display device from the outside. However, in this case, a RAM for holding the black voltages is needed. Since the optimum black voltages can be set for the respective pixels, however, desirable black writing is achieved.

In this embodiment, the black voltage (video data to be applied to the pixels during the black writing periods) is written in an EEPROM 394 on the outside. The black voltages are different among the RGB pixels from each other, but are fixed in each of the R, G, and B pixels. Therefore, 1 byte data area is set for each of R, G and B. For example, the black voltage for the R pixels is 00 H (hexadecimal numeral, 6 bits), the black voltage for the G pixels is 02 H, and the black voltage for the R pixels is 01 H.

When the black writing data is written in the RAM, the data in the RAM is read from the first row to the 400^{th} row of the memory in sequence in the period from 3F/4 to 4F/4, and written into the display screen 20 at a fourfold speed. The black writing periods are shown by solid lines. When the voltages different from each other are written for the R, G, and B pixels in the outside EEPROM, the data in the EEPROM are copied in the latch circuit of the gate source driver IC31 and the copied data is written into the display screen 20 at a fourfold speed in the period from 3F/4 to 4F/4.

When the voltages different from each other are written for the R, G, and B pixels in the outside EEPROM, the preset EEPROM data is used. Therefore, it does not compete with the reading of the RAM data. Therefore, the period for writing the black voltage is not limited to the period from 3F/4 to 4F/4. For example, it may be performed in the period of 5F/8 to 7F/8.

The black writing periods may be elongated as described in conjunction with FIG. 5. In FIG. 5 and FIG. 9, it corresponds to t1. After having elapsed the elongated black writing period t1, the video writing period is started. When there is the blank period tp, the video writing period starts from the blank period. In FIG. 9, the video writing period is shown by a long and short dash line. When the video writing period is ended, the backlight 18 is turned ON (illuminated). The video holding period lasts from the end of the video writing period until the beginning of the black writing period.

(2-10) Modification

(2-10-1) Common Voltages to be Applied to Corresponding Electrode

As described in conjunction with FIG. 7, the common voltage signal VCOM applied to the opposed electrodes 362 is changed frame by frame. In other words, it is controlled in such a manner that when a first frame is VCOM=VcH, it is controlled to be VCOM=VcL in a second frame, and to be VCOM=VcH in a third frame.

However, the embodiment is not limited thereto, what is essential is to apply the AC drive to the liquid crystal layer 364 so that the polarity of the voltage applied in a certain cycle is changed. Also, what is essential is that the positive effective value and the negative effective value of an arbitrary frame and the subsequent frame substantially match with each other. The common voltage signals VCOM applied to the opposed electrodes 362 must simply be applied without generation of flicker by applying the positive and negative effective values applied to the voltage to be applied to the pixels 16. Therefore, the voltage signals may be applied to the opposed electrodes 362 in many ways. The common voltage signal VCOM may be asymmetry with respect to the common center voltage Vcnt. For example, VcH-Vcnt may be different from Vcnt-VcL.

(2-10-2) Modification 1

As described in conjunction with FIG. 6, the gate signal lines G are selected in sequence from the first (ODD 1) to 400^{th} (EVEN 200) signal line. However, the embodiment is not limited thereto. For example, it is also possible to select the odd number^{th} gate signal lines G (ODD 1 to ODD 200), in the period of 1F/8, and select the even number^{th} gate signal lines G (EVEN 1 to EVEN 200) in the subsequent period of 1F/8. The video data or the black voltages corresponding to the selected pixel rows are applied to the source signal lines S in sequence. The polarity to be applied to the source signal lines S is the same during the period of 1F/8. Therefore, the power consumption of the gate source driver IC31 can be reduced. Generation of the flicker can easily be restrained.

In the embodiment shown above, although there is an effect to achieve both the reduction of the power consumption and the restraint of the flicker, there is a case in which lateral lines appear when the response of the liquid crystal is lowered due to the extremely low temperature. For example, when focusing on the pixels 16 on the first line (ODD line) and the second line (EVEN line), the timing to start writing to these pixels 16 is shifted by the time difference between the video signal writing scan for the odd line and the video signal writing scan for the even line. When there is a delay in response, transition of the coefficient of transmission of the pixels cannot be completed before illumination of the backlight 18, and hence there arises a difference of the coefficient of transmission between the pixels 16 in the odd line and the pixels 16 in the even line, which causes a difference in luminance, and is observed as a lateral line.

In order to reduce visibility of this difference in luminance, it is effective to delay the timing to illuminate the backlight 18. In this manner, in this embodiment, ON and OFF of the backlight 18 is synchronized with the video signals. The timings of illumination and extinction of the backlight 18 can be varied.

(2-10-3) Modification 2

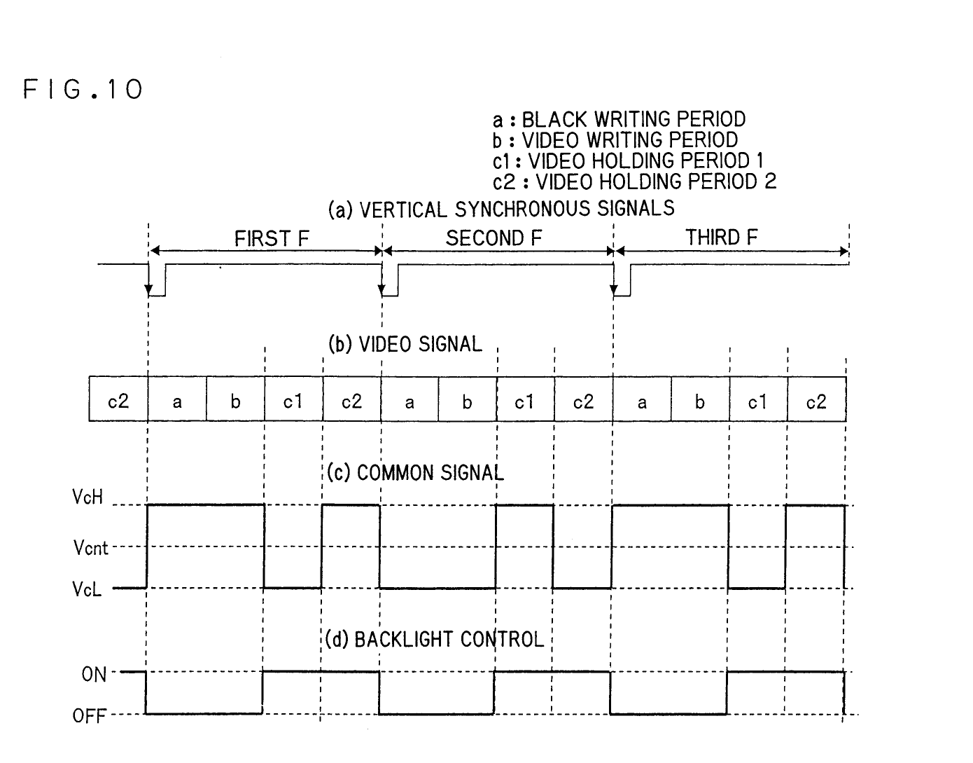

As shown in FIG. 10, it is also possible to invert the polarity of the common voltage signal VCOM in the video signal holding periods c1, c2. As shown in FIG. 10, by inverting the polarity of the common voltage signal VCOM applied to the opposed electrodes 362, the inversion cycles match and hence the luminance inclination and the flicker may be reduced. The polarity of the video signals or the black voltage to be applied to the source signal lines S is inverted so as to match the polarity of the common voltage.

In FIG. 10, the backlight 18 is illuminated corresponding to the periods c1, c2 of the respective frames. The backlight 18 is extinguished during the periods “a” as the black writing periods and the periods “b” as the video signal writing period.

As shown in FIG. 10, the common voltage signal is VCOM=VcH in the periods “a” and “b” in the first frame (first F). The common voltage signal is VCOM=VcL in the period c1 as the video holding period, and is VCOM=VcH in the period c2. That is, the polarity of the common signals is inverted in the video holding period. The lengths of the period c1 and the period c2 of the video holding period are matched (substantially the same).

In the second frame (second F) which is a subsequent frame of the first frame, the common signals are applied with the polarity inverted from the first frame (the first F). Therefore, the AC drive is achieved in the second frame period in the liquid crystal layer 364.

In the periods “a” and “b” in the second frame, the common signal is VCOM=VcL. The common signal in the period c1 as the video holding period is VCOM=VcH, and the common signal in the period c2 is VCOM=VcL. That is, the polarity of the common signals is inverted in the video holding period.

The common signal VCOM in the third frame (third F) is the same as the first frame. It is effective to change the common voltage signals with the panel temperature.

(2-10-4) Modification 3

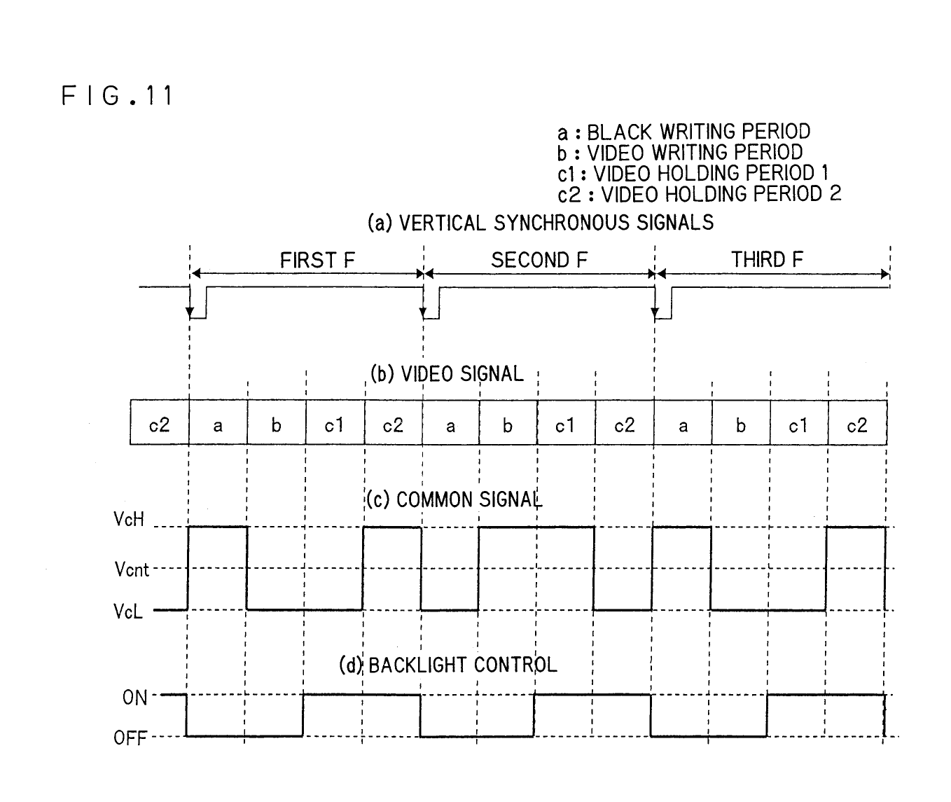

FIG. 11 shows a modification of FIG. 10. In FIG. 11 as well, the backlight 18 is illuminated corresponding to the periods c1 and c2 of the respective frames. The backlight 18 is extinguished in the periods “a” as the black writing period and the period “b” as the video signal writing period.

As shown in FIG. 11, the common signal is VCOM=VcH in the period “a” as the black writing period of the first frame (the first F). The common signal is VCOM=VcL in the period “b” as the subsequent video writing period and the period “c1” which is the video holding period. The period “c2” is the common signal VCOM=VcH in the period c2. That is, the polarity of the common signal is inverted in the black writing period and the video writing period, and the polarity of the common signal is also inverted in the video holding period. The lengths of the period “a” of the black writing period and the period “b” of the video writing period match (substantially the same). The lengths of the period c1 and the period c2 of the video holding period are the same (substantially the same).

In the second frame (the second F), which is a subsequent frame of the first frame, the common signal is applied with the polarity inverted from the first frame (the first F). Therefore, the AC drive is achieved in the two frame periods in the liquid crystal layer 364.

The common signal is VCOM=VcL in the period “a” in the second frame. The common signal is VCOM=VcH in the period “b” as the video writing period. The common signal VCOM=VcH in the period c1 as the video holding period, and are VCOM=VcL in the period c2. That is, in the same manner as the first frame, the polarity of the common signal is inverted in the black writing period and the video writing period, and the polarity of the common voltage signals is also inverted in the video holding period. The lengths of the period “a” of the black writing period and the period “b” of the video writing period are matched (substantially the same). The lengths of the period c1 and the period c2 of the video holding period are the same (substantially the same).

The common voltage signals VCOM in the third frame (the third F) are the same as the first frame. It is effective to change the common voltage signals with the panel temperature.

(2-10-5) Modification 4

The embodiments shown above employ the driving method in which the gate signal lines G are selected from G1, G2, G3, G4, G5 . . . in sequence. However, the embodiment is not limited thereto. Assuming that the number of pixel rows in the display screen 20 is represented by m, as shown in FIG. 10, odd number^{th} gate signal lines Gi (ODDi, provided that i designates 1 or integers larger than 1, and the maximum value is number of pixel rows/2) and even number^{th} gate signal lines Gi (EVENi, provided that i designates 1 or integers larger than 1, and the maximum value is the number of pixel raws/2) are connected by a cross-wind lead.

With the configuration as shown in FIG. 3, the video signals outputted from the gate source driver IC31 can be applied to the odd number^{th} gate signal lines G (the odd number^{th} pixel row) in sequence without changing the polarity. Subsequently, the video signals outputted from the gate source driver IC31 can be applied to the even number^{th} gate signal lines G (the even number^{th} pixel row) in sequence without changing the polarity. The polarity of the common signal VCOM is changed according the polarity of the video signals.

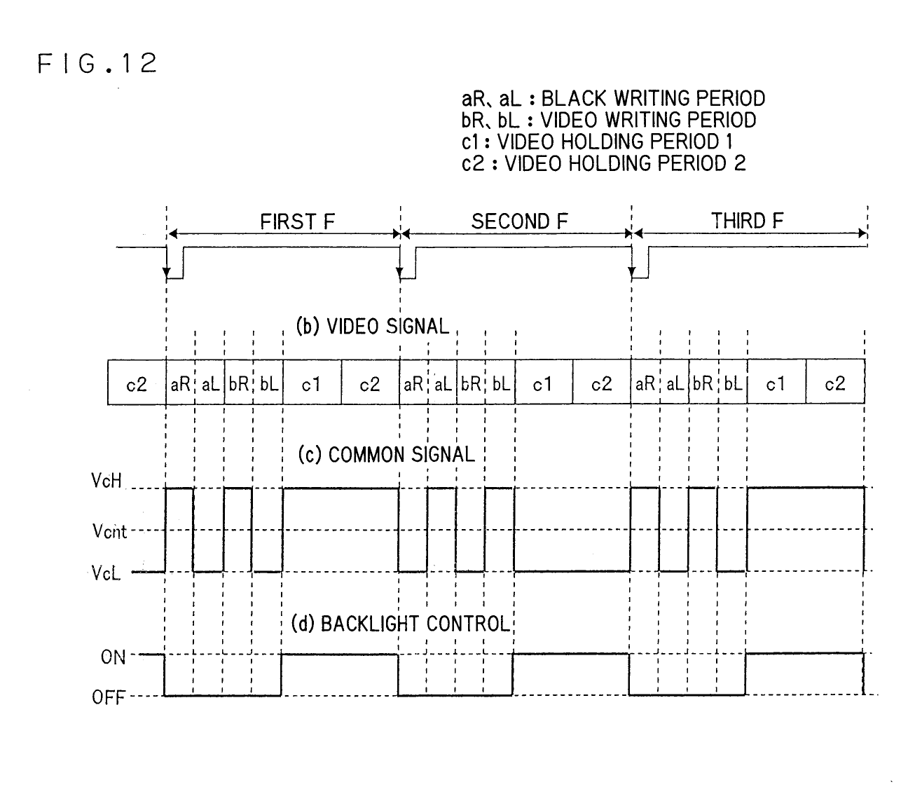

FIG. 12 shows a variation of the common signal to be applied in the configuration of the liquid crystal display device shown in FIG. 3. In FIG. 12, a state of operation of the EVEN gate signal lines G is represented by reference sign R, and a state of operation of the ODD gate signal lines G is represented by reference sign L.

For example, reference sign aR means the period “a” in which the black writing is being performed with the even number^{th} gate signal lines G selected. Reference sign bL means the period “b” in which the video signal writing is being performed with the odd number^{th} gate signal lines G selected.

The length of aR+aL is the same as the period “a” in FIG. 11. The lengths of the period of aR and the period of aL are the same. The length of the bR+bL is the same as the period “b” in FIG. 11. Therefore, the operation frequency is the same between the gate driver circuit 12a and the gate driver circuit 12b. The lengths of the period of bR and the period of bL are the same.

In FIG. 12, lengths of the signals to be applied to the pixels are aR, aL, bR, bL, c1 and c2. Therefore, the black voltage is applied to the even number^{th} pixel rows in the period aR, and then the black voltage is applied to the odd number^{th} pixel rows in the period aL. Then, the video signals are applied to the even number^{th} pixel rows in the period bR, and then the video signals are applied to the odd number^{th} pixel rows in the period bL.

The common signals VCOM to be applied to the opposed electrodes 362 are applied as follows. The common voltage signals VCOM=VcH are applied during the period aR in the first frame (the first F). Therefore, the voltage VcH is applied at the opposed electrodes 362 during a period in which the black voltage is applied to the even number^{th} pixel rows. In the subsequent period aL, the common voltage signals VCOM=VcL are applied. Therefore, the voltage VcL is applied to the opposed electrodes 362 during a period in which the black voltage is applied to the odd number^{th} pixel rows.

The common voltage signals VCOM=VcH are applied in the period bR in the first frame (the first F). Therefore, the voltage VcH is applied to the opposed electrodes 362 during a period in which the video signals are applied to the even number^{th} pixel rows. The common voltage signals VCOM=VcL are applied in the subsequent period bL. Therefore, the voltage VcL is applied to the opposed electrodes 362 during the period in which the video signals are applied to the odd number^{th} pixel rows. The common voltage signals VCOM=VcH are applied in the video signal holding periods (c1, c2) in the first frame.

In the second frame (the second F) which is a subsequent frame of the first frame, the common voltage signals VCOM is applied to the opposed electrodes 362 so as to achieve the opposite polarity from the first frame. That is, the common voltage signals VCOM=VcL are applied in the period aR in the second frame (the second F). Therefore, the voltage VcL is applied to the opposed electrodes 362 during a period when the black voltage is applied to the even number^{th} pixel rows. In the subsequent period aL, the common voltage signals VCOM=VcH are applied. Therefore, the voltage VcH is applied to the opposed electrodes 362 during a period in which the black voltage is applied to the odd number^{th} pixel rows.

The common voltage signals VCOM=VcL are applied in the period bR of the second frame (the second F). Therefore, the voltage VcL is applied to the opposed electrodes 362 during the period in which the video signals are applied to the even number^{th} pixel rows. In the subsequent period bL, the common voltage signals VCOM=VcH are applied. Therefore, the voltage VcH is applied to the opposed electrodes 362 during a period in which the video signals are applied to the odd number^{th} pixel rows. The common voltage signals VCOM=VcL are applied in the video signal holding periods (c1, c2) in the first frame.

The common signal VCOM in the third frame (the third F) are the same as the first frame. It is effective to change the common voltage signals with the panel temperature.

As described above, the AC voltage is applied to the liquid crystal layer 364 in the first frame and the second frame, that is, the odd frames and the even frames by generating and applying the common voltage signals VCOM as described above.

(2-10-6) Modification 5

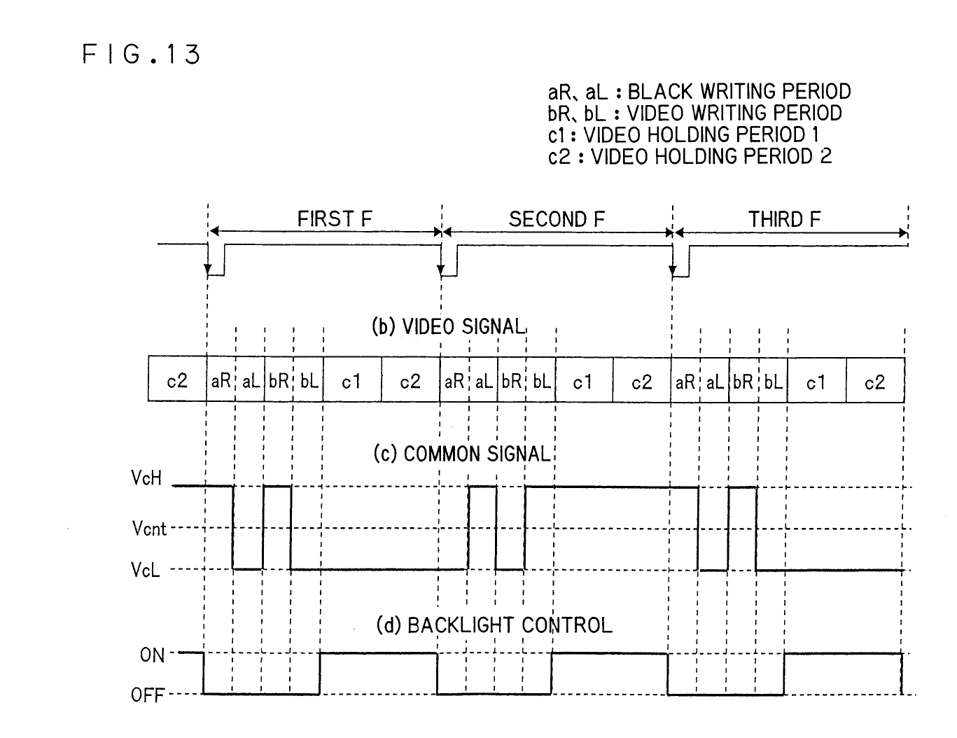

FIG. 13 is a modification of FIG. 12. The lower power consumption is achieved by reducing the points of change of the common voltage signals VCOM in comparison with FIG. 12.

In FIG. 13, the common voltage signals VCOM applied to the opposed electrodes 362 (common electrodes) are applied as follows. The common voltage signals VCOM=VcH are applied during the period aR in the first frame (the first F). Therefore, the voltage VcH is applied at the opposed electrodes 362 during a period in which the black voltage is applied to the even number^{th} pixel rows. In the subsequent period aL, the common voltage signals VCOM=VcL are applied. Therefore, the voltage VcL is applied to the opposed electrodes 362 during a period in which the black voltage is applied to the odd number^{th} pixel rows.

The common signal VCOM=VcH is applied in the period bR of the first frame (the first F). Therefore, the voltage VcH is applied to the opposed electrodes 362 during a period in which the video signals are applied to the even number^{th} pixel rows. In the subsequent period bL, the common signal VCOM=VcL is applied. Therefore, the voltage VcL is applied to the opposed electrodes 362 during a period in which the video signals are applied to the odd number^{th} pixel rows. In the video signal holding periods (c1, c2) of the first frame, the polarity of the common voltage signals VCOM applied to the period bL is maintained. Therefore, the common voltage signals VCOM=VcL are applied.

In the second frame (the second F) which is a subsequent frame of the first frame, the common voltage signals VCOM is applied to the opposed electrodes 362 so as to achieve the opposite polarity from the first frame. That is, the common voltage signals VCOM=VcL are applied in the period aR in the second frame (the second F). Therefore, the voltage VcL is applied to the opposed electrodes 362 during a period when the black voltage is applied to the even number^{th} pixel rows. In the subsequent period aL, the common voltage signals VCOM=VcH are applied. Therefore, the voltage VcH is applied to the opposed electrodes 362 during a period in which the black voltage is applied to the odd number^{th} pixel rows.

The common voltage signals VCOM=VcL are applied in the period bR of the second frame (the second 2F). Therefore, the voltage VcL is applied to the opposed electrodes 362 during a period in which the video signals are applied to the even number^{th} pixel rows. In the subsequent period bL, the common voltage signals VCOM=VcH are applied. Therefore, the voltage VcH is applied to the opposed electrodes 362 during a period in which the video signals are applied to the odd number^{th} pixel rows. The polarity of the common voltage applied in the period bL is maintained in the video signal holding periods (c1, c2) of the first frame. Therefore, the common signal VCOM=VcH voltage is applied.

The common signal VCOM in the third frame (the third F) is the same as the first frame. It is effective to change the common voltage signals with the panel temperature.

As described above, the AC voltage is applied to the liquid crystal layer 364 in the first frame and the second frame, that is, the odd frames and the even frames by generating and applying the common voltage signals VCOM as described above.

In the embodiment shown above, although there is an effect to achieve both the reduction of the power consumption and the restraint of the flicker, there is a case in which lateral lines appear when the response of the liquid crystal is lowered due to the extremely low temperature. For example, when focusing on the pixels 16 on the first line (ODD line) and the second line (EVEN line), the timing to start writing to these pixels 16 is shifted by the time difference between the video signal writing scan for the odd line and the video signal writing scan for the even line. When there is a delay in response of the liquid crystal, transition of the coefficient of transmission of the pixels cannot be completed before illumination of the backlight 18, and hence there arises a difference of the coefficient of transmission between the pixels 16 in the odd line and the pixels 16 in the even line, which causes difference in luminance, and is observed as a lateral line. In order to reduce visibility of this difference in luminance, it is effective to delay the timing to illuminate the backlight 18. In this manner, in this embodiment, ON and OFF of the backlight 18 is synchronized with the video signals. The timings of illumination and extinction of the backlight 18 can be varied.

(2-10-7) Modification 6

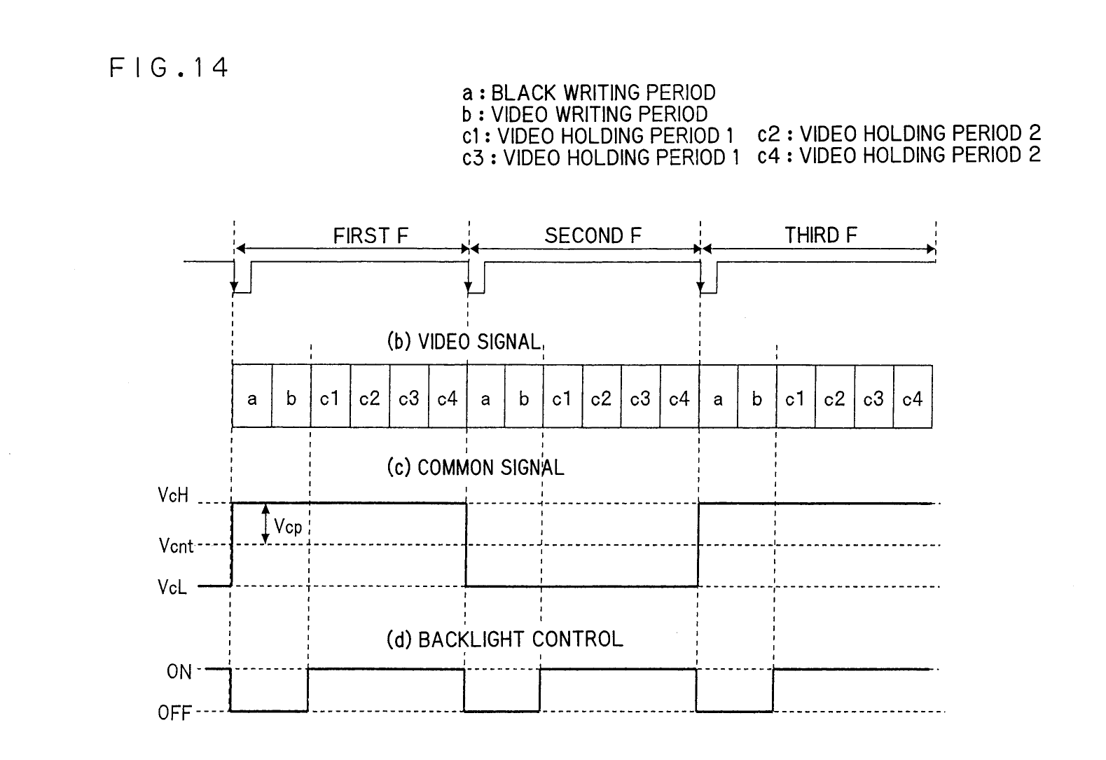

In the embodiments shown above, the image is written by writing the video signals at a fourfold speed. However, the embodiment is not limited thereto. For example, it is also possible to configure to write the video signals in the display area at a sixfold speed as shown in FIG. 14.

In FIG. 14, the lengths of the period a, the period b, the period c1, the period c2, the period c3, and the period c4 are the same. Therefore, the black insertion drive is performed in the period of 1F/6, and the video signals are written in the subsequent period of 1F/6. The period of 4F/6 (=2F/3) is the video signal holding period.

The backlight 18 is illuminated in the video signal holding period. It is extinguished during the black writing period “a” and the video writing period “b” to make the image display invisible.

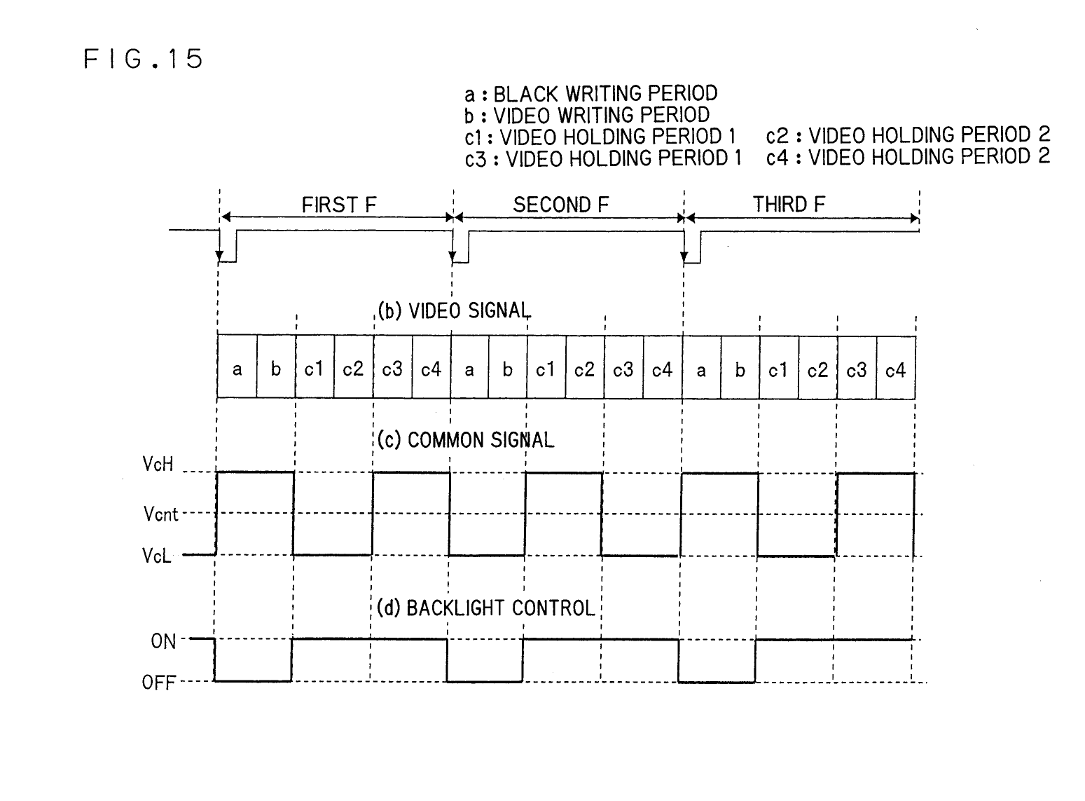

Although the polarity of the common voltage signals VCOM is inverted frame to frame in the drawing, the embodiment is not limited thereto. Needless to say, the systems shown in FIG. 10 to FIG. 13 may be employed. As shown in FIG. 15, by inverting the polarity of the common voltage signals VCOM applied to the opposed electrodes 362, the inversion cycles match and hence the luminance inclination and the flicker may be reduced.

(2-10-8) Modification 7

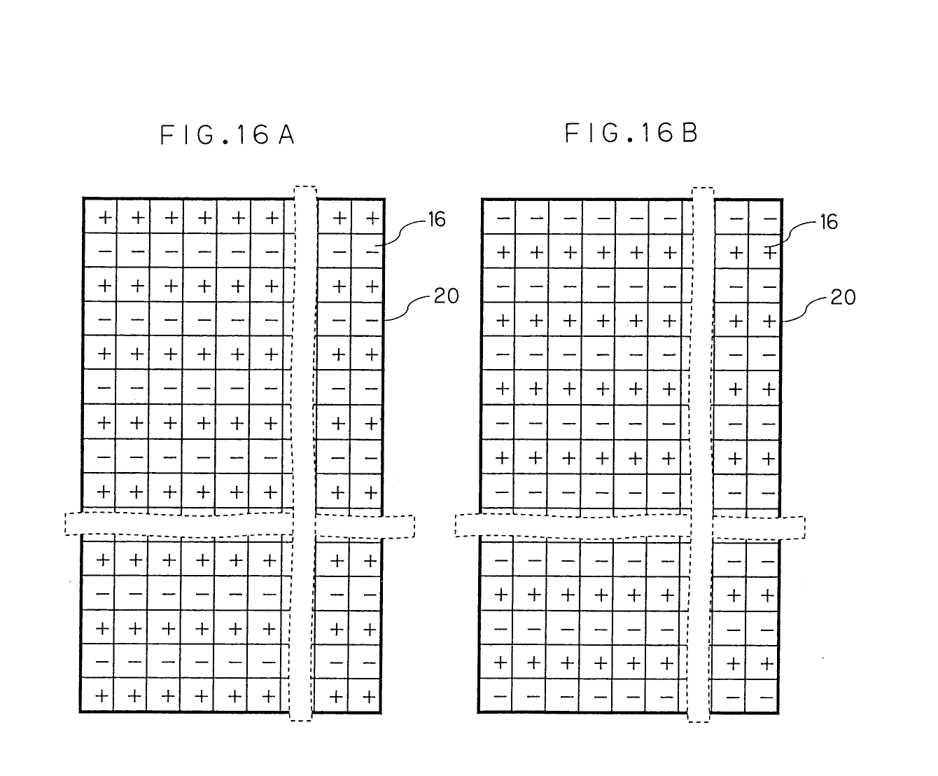

In the embodiment shown above, the signal polarity inverting system to be outputted from the source driver circuit 14 to the source signal lines S is a frame inversion or a column inversion system. However, the embodiment is not limited thereto. The drive system as shown in FIGS. 16, 17 and 18 may also be employed. The polarities (VcH, VcL) of the common signal VCOM may be changed corresponding to the signal polarity (the polarity of the signals to be applied to the pixels 16) outputted from the source driver circuit 14.

FIGS. 8A and 8B show embodiments of the frame inversion drive. FIG. 8A shows a state of polarity of the video signals in the pixels 16 in the odd number^{th} frames. FIG. 8B shows a state of polarity of the video signals in the pixels 16 in the even number^{th} frame. In FIGS. 8A and 8B, the signs “+” represent a state in which the positive video signals are held in the pixels 16, and the signs “−” represent a state in which the negative video signals are held in the pixels 16.

FIGS. 16A and 16B show embodiments of the one-line inversion drive. FIG. 16A shows a state of polarity of the video signals in the pixels 16 in the odd number^{th} frames. FIG. 16B shows a state of polarity of the video signals in the pixels 16 in the even number^{th} frames. The one-line inversion drive is also referred to as 1 H inversion drive. The polarity of the video signals to be applied to the pixels 16 is inverted by each pixel row.

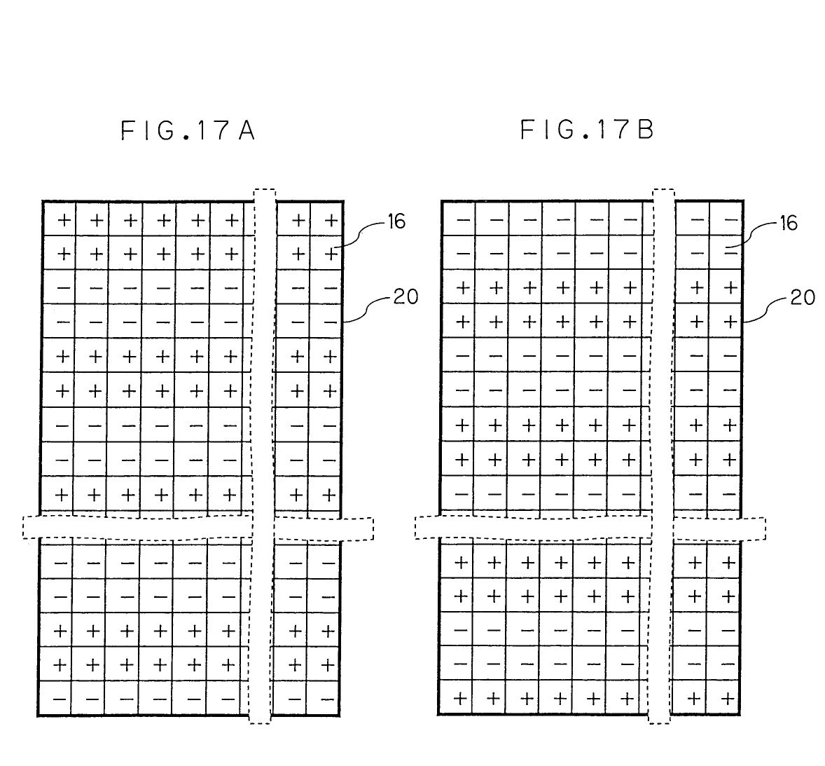

FIGS. 17A and 17B show embodiments of the two-line (2 H) inversion drive. FIG. 17A shows a state of polarity of the video signals in the pixels 16 in the odd number^{th} frames. FIG. 17B shows a state of polarity of the video signals in the pixels 16 in the even number^{th} frame. The two-line inversion drive is also referred to as 2 H inversion drive. The polarity of the video signals to be applied to the pixels 16 is inverted by every two pixel rows.

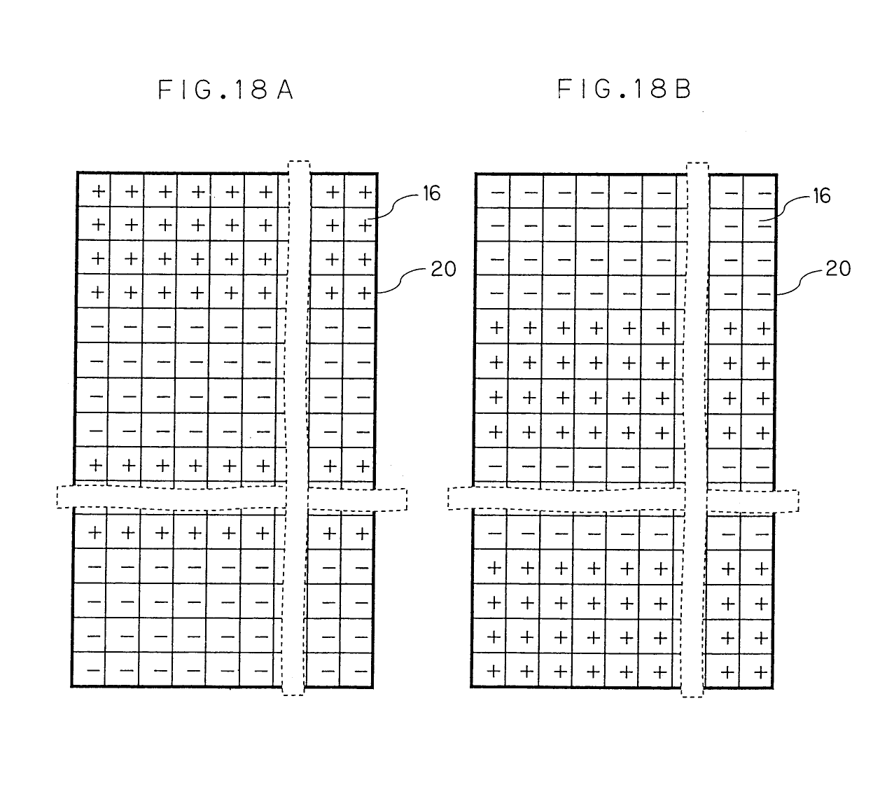

FIGS. 18A and 18B show embodiments of a four-line inversion drive. FIG. 18A shows a state of polarity of the video signals in the pixels 16 in the odd number^{th} frames. FIG. 18B shows a state of polarity of the video signals in the pixels 16 in the even number^{th} frame. The four-line inversion drive is also referred to as 4 H inversion drive. The polarity of the video signals to be applied to the pixels 16 is inverted by every four pixel rows.

As described above, the polarity of the signals to be applied to the pixels 16 is inverted by every plural pixel rows. At the same time, or synchronously, the polarity of the common signal is also changed.

In the embodiments shown above, the polarity of the video signals to be applied to the pixels 16 is inverted by the unit of pixel row. However, it is also possible to invert the polarity of the video signals to be applied to the pixels 16 by the unit of pixel column. It is not limited to invert the polarity of the video signals to be applied to the pixels 16 by the unit of one pixel column, but may be invert the polarity of the video signals to be applied to the pixels 16 by the unit of two pixel columns or three pixel columns.

The embodiment is not limited to stop the video signal writing operation in the video signal holding period c. It is also possible to perform the video signal writing operation in the period c1 and the period c2. Since the image data to be written is the same, the image quality is not lowered even in the state of illuminating the backlight 18, and the movie display performance is also maintained.

The number of times of the writing scan of the video signals does not have to be necessarily once, and may be repeated by three times, four times, . . . The writing scan of the video signals from the second time on may be performed during the period when the backlight 18 is illuminated. It is because that the image data to be written in the pixels 16 is the same even when the writing scan of the video signals is performed, and hence there arises no change in the state of image display. It is also possible to start illumination of the backlight after having ended the second scan as a mater of course. It is also possible to write the video signals in the original video holding periods (c1, c2). As regards the number of times of the writing scan of the video signals or the timing of illumination of the backlight 18, suitable conditions may be employed while taking the load applied to the source driver 14 or a required luminance into consideration.

In the embodiments, the luminance inclination may occur since the response of the coefficient of transmission between the uppermost row and the lowermost row of the display screen 20 caused by the delay of the response of the liquid crystal. Such luminance inclination may be restrained by inverting the direction of vertical scanning direction for selecting the plurality of pixel rows frame by frame, for example, by scanning from the uppermost row to the lowermost row in the odd number^{th} frames, and from the lowermost row to the uppermost row in the even number^{th} frames. It is also possible to perform the amplitude modulation of the video signals corresponding to the generated luminance inclination. Also, it is possible to modulate the amplitude value of the common signal corresponding to the generated luminance inclination.

(3) Frame Rate Conversion

In this embodiment, the video signals of a first frame rate (for example, 60 Hz) are applied from the outside the liquid crystal display device. The video signals are stored in the RAM in the interior of the liquid crystal display device, and are applied to the source signal lines S as a fourfold video signal (1F/4). There is a case in which the first frame rate and the frame rate to be applied to the source signal lines S are the same. When the frequency of the video signals applied to the source signal lines S is the fourfold speed, the frame rate as a cycle of image display is 60 Hz, and hence is the same. As described above, the drive system in this embodiment employs a system to increase the speed of the supplied video signals and apply the same to the source signal lines S. Alternatively, it employs a system to write the video signals to the display screen 20.

(3-1) Flicker Visibility

It is an effect of this embodiment to improve the movie display performance by flushing the backlight 18. By turning the backlight 18 On and Off (illuminate and extinguish) from frame to frame, the image display is intermittently displayed. The movie visibility is dramatically improved by the intermittent display. However, when the frame rate is low, the flicker is visible.

Since the frequency of NTSC signals is 60 Hz (60 frames/second) and the frequency of PAL signals is 50 Hz (50 frames/second), when the intermittent display is performed as is, the image display quality is lowered due to generation of the flicker.

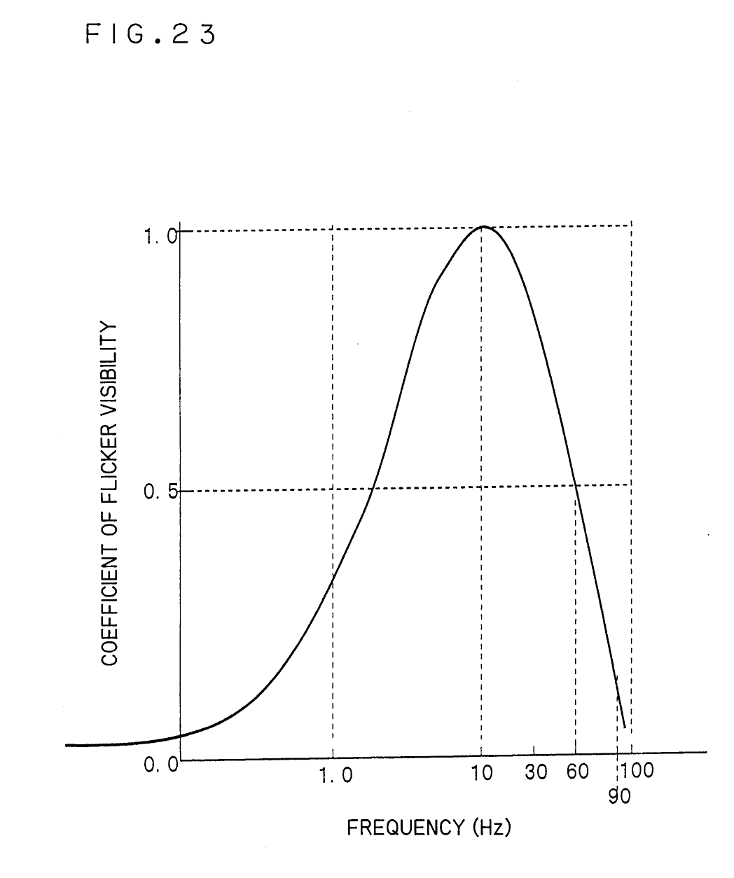

As shown in FIG. 23, there is a correlation between the frame frequency in the lateral axis and the coefficient of flicker visibility in the vertical axis. The larger the coefficient of flicker visibility is, the easier the flicker is recognized. The coefficient of flicker visibility needs to be 0.25 or lower.

From FIG. 23, it is recognized that that the flicker becomes visible when the driving method of this embodiment (intermittent display) is implemented at 50 Hz and 60 Hz. The flicker starts to be difficult to be recognized from about a little above 70 Hz in frame rate, and the coefficient of flicker visibility is 0.25 or lower at 72 Hz. The generation of the flicker is almost disappeared at 80 Hz or higher. The flicker is not recognized at 90 Hz or higher. However, when the frame rate is increased too much, the movie visibility is lowered (movie blurring occurs). The movie visibility is lowered from about a little above 100 Hz, and improvement of the movie visibility by the intermittent display by flushing the backlight is no longer effective at 150 Hz or higher.

In the driving method in this embodiment, the frame rate is set to a range from 72 Hz to 150 Hz. When the frame rate of the input signals is 72 Hz or lower, the input frame rates are converted to 1.25 times, 1.5 times or twice in frame rate before output by the driving method or the circuit in this embodiment, and are applied to the liquid crystal display panel. In this method, reduction of cost is achieved. When the frame rate of the input signal is 72 Hz or higher, the image is displayed at the same frame rate as the input frame rate. The frame rate is preferably in a range from 1.20 to 1.60 times the input frame rate when supplied to the liquid crystal display device.

Basically, in the display device in this embodiment, the conversion of the frame rate is not performed, and the input frame rate is maintained as the output frame rate. In the display device in this embodiment, the input signal is converted so as to match the format described in FIG. 5 and FIG. 9, such as the black writing period “a”. The embodiment is not limited to a mode in which the frame rate conversion is not performed and, needless to say, it is also possible to mount a required frame memory on a panel module in this embodiment, and perform the frame rate conversion.

(3-2) Frame Rate Conversion

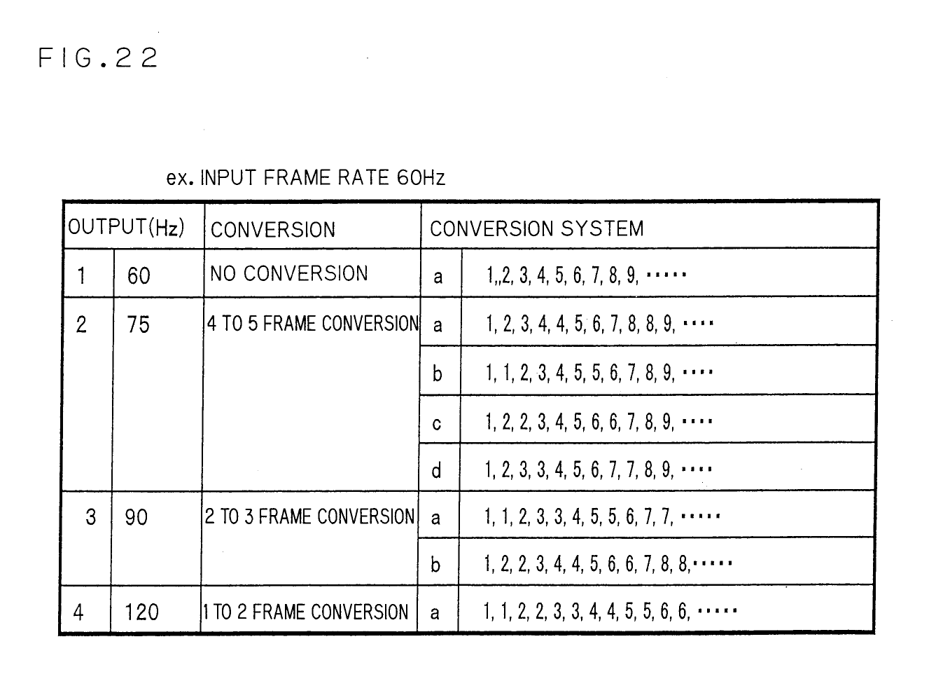

In this embodiment, the frame rate conversion is performed for solving the problem of generation of the flicker, which is shown in FIG. 22. An example in which the input (the original input frame rate) is 60 Hz is described. A column 1 shows a case in which the input frame rate is not converted before output (output 60 Hz). It is necessary to write the black voltage (video signal) into the pixels 16 at a fourfold speed during the black writing period.

A column 2 shows a case in which the input frame rate is multiplied by 1.25, so that the video signals are outputted at 75 Hz. It is necessary to read the input video signals at a speed of 1.25×4 from the internal RAM and write the black voltages (video signals) into the pixels 16.

A column 3 shows a case in which the input frame rate is multiplied by 1.5, so that the video signals are outputted at 90 Hz. It is necessary to read the input video signals at a speed of 1.5×4 from the internal RAM. A column 4 shows a case in which the input frame rate is multiplied by 2.0, so that the video signals are outputted at 120 Hz. It is necessary to read the input video signals at a speed of 2×4 and write the black voltages (video signals) into the pixels 16.

The column of “CONVERSION SYSTEM” of FIG. 22 shows input frame numbers. The input image in the first F is represented by “1”, the input image in the second F is represented by “2”, and the input image in the third F is represented by “3” and so forth. Therefore, since the conversion system at an output of 60 Hz needs not the frame rate conversion, the input image is displayed as 1, 2, 3, 4, 5, 6, . . . as is as an output image.

In the case of the output at 60 Hz of the column 1 (hereinafter referred to as “frame rate 60 Hz”), the frame conversion is not necessary (no conversion). Therefore, the input image is displayed as 1, 2, 3, 4, 5, 6, . . . as is as an output image.

In the case of the output at 75 Hz in the column 2 of FIG. 22 (hereinafter referred to as “frame rate 75 Hz”), it is necessary to convert four frames of the input image into five frames of the output image (frame rate conversion). Therefore, one of the four frames of the input image must be doubly outputted. Therefore, an example “a” shows a display of 1, 2, 3, 4, 4, 5, 6, 7, 8, 8 . . . as an output image. An example “b” shows a display of 1, 1, 2, 3, 4, 5, 5, 6, 7, 8 . . . An example “c” shows a display of 1, 2, 2, 3, 4, 5, 6, 6, 7, 8 . . . An example “d” shows a display of 1, 2, 3, 3, 4, 5, 6, 7, 7, 8 . . .

In the system 2 in which the input image is multiplied by 1.25 to obtain an output image, it is necessary to convert four frames into five frames. Since the same display appears every four frames in this conversion, the change of the output image display is unsmooth. However, in most cases, it has no problem in practical use. The circuit configuration is simple, and the RAM size to be used is small.

In the case of the output at 90 Hz in the column 3 of FIG. 22 (hereinafter referred to as “frame rate 90 Hz”), it is necessary to convert two frames of the input image into three frames of the output image (frame rate conversion). Therefore, it is necessary to output either one of the two frames of the input image doubly. Therefore, an example “a” shows a display of 1, 1, 2, 3, 3, 4, 5, 5, 6, 7, 7, 8 . . . as an output image. An example “b” shows a display of 1, 2, 2, 3, 4, 4, 5, 6, 6, 7, 8, 8 . . .

In the system 3 in which the input image is multiplied by 1.5 to obtain an output image, it is necessary to convert two frames into three frames. In this conversion, the same display appears every two frames. Since the frequency of occurrence of the same frame is high, the output image display is smooth. The circuit configuration and system for the frame rate conversion are also simple. Therefore, the system 3 in which the input image is converted by multiplying by 1.5 is preferable.

In the case of the output at 120 Hz in the column 4 of FIG. 22 (hereinafter referred to as “frame rate 120 Hz”), one frame of the input image is required to be converted into two frames (frame rate conversion). Therefore, it is necessary to output every frame of the input image doubly. Therefore, an example “a” shows a display of 1, 1, 2, 2, 3, 3, 4, 4, 5, 5, 6, 6, 7, 7, 8, 8 . . . as an output image.

In the system 4 in which the input image is multiplied by 2 to obtain an output image, it is necessary to convert one frame double into two frames. In this conversion, the same display is generated doubly. The output image display is smooth. The circuit configuration and system of the frame rate conversion are simple. However, since one input image frame is converted into two frames when displayed, the images are viewed continuously. Therefore, the movie visibility is low (the movie blurring is liable to occur).

From these reasons, it is preferable to employ the system 3 in which the input frame rate is multiplied by 1.5 to obtain the output frame rate as the frame conversion system. Alternatively, the system in which the input frame rate is multiplied by 1.25 is employed.

(3-2) Frame Conversion Circuit

In order to perform the frame rate conversion, the frame memory (RAM) for holding the image for one or two frames is needed. The frame memory may cause increase in cost. Since there are the black writing period “a”, the video writing period “b”, and the video holding period “c” (c1, c2), in this embodiment, the processing of the video signals is basically a fourfold speed. In order to increase the speed of processing the video signals, an EMI (electromagnetic interference) countermeasure is necessary, which results in increase in cost.

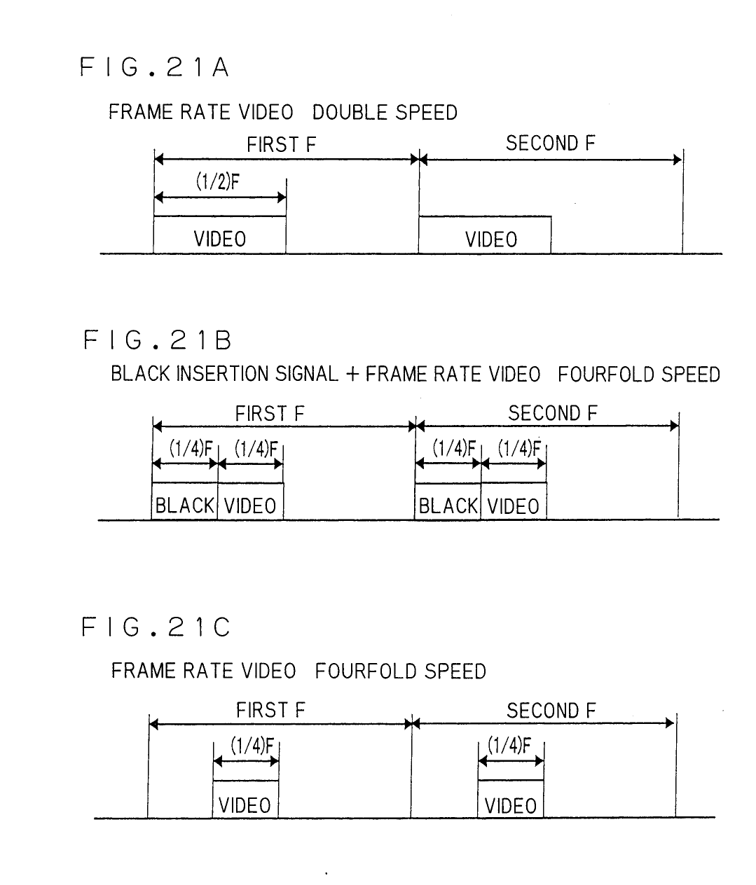

FIG. 21 is an explanatory drawing showing drive systems in this embodiment. In this embodiment, the input signals are adapted to match the drive systems of this embodiment. The drive systems in this embodiment include the format of the input signals.

The first F, the second F, . . . in FIG. 21 represent not only the frame rate of the input signals, but also the frame rate of the output signals. The input frame rate is not 60 Hz, but a high frame rate such as 75 Hz multiplied by 1.25 or 90 Hz multiplied by 1.5. In other words, the input signals are transmitted at a frame rate which makes the flicker hard to be recognized. In the display device in this embodiment, the frame rate conversion is not performed, and the input frame rate is maintained as the output frame rate. In the display device in this embodiment, the input signals are converted so as to be adapted to the format described in conjunction with FIG. 10, such as the black writing period “a”.

The term “frame rate” is a unit required for rewriting one screen. In FIG. 5, when one unit, that is, the black writing period+video writing period+video holding period is one unit, is performed by 60 times in one second, it is expressed as “frame rate 60”. In FIG. 9, when one unit, that is, the black writing period (black voltage writing period+black voltage holding period)+video writing period+video holding period+blanking time tp, is performed by 60 times in one second, it is expressed as “frame rate 60”.

(3-2-1) Frame Conversion System 1

A “high frame rate double speed system” shown in FIG. 21A will be described. The input video signals have a double speed. Therefore, the period 1F/2 in one frame corresponds to the video signals. In the remaining 1F/2, the previous video signals may be transmitted repeatedly or, alternatively, no signal may be transmitted.

The video signals transmitted in the period of 1F/2 (in FIG. 21A, it is shown as “VIDEO”) are stored in the frame memory. Reading from the frame memory is performed at a double speed. Since the input signals have a double speed and are read at a double speed, the read out signals have 2×2, that is, a fourfold speed. As described in conjunction with FIG. 5 and FIG. 9, the black writing periods “a” are implemented for the period of 1F/4 basically. The black writing signals are self-generated in the liquid crystal display panel in this embodiment irrespective of the input video signals. However, the embodiment is not limited thereto, and it is needless to say that the level of the black writing signals may be varied according to the input video signals.

The input video signals are read after the black writing periods “a” further at a double speed (a fourfold speed), then the video writing periods “b” are generated, so that the input video signals are written into the pixels 16 in the display screen 20 arranged in a matrix pattern. Subsequently, the video holding periods “c” follow thereafter.

As described thus far, in the system shown in FIG. 21A, the frame rate conversion of the input video signals is not necessary. It is also possible to store the input video signals in the memory and read the same at a double speed, so as to be adapted to the drive system in this embodiment. Therefore, the frame memory capacity can be reduced, and the circuit configuration is simple. Since the speed of the transmitted input video signals is a double speed, the EMI countermeasure can be achieved relatively with ease.

(3-2-2) Frame Conversion System 2

A “black insertion signal+high frame rate fourfold system” shown in FIG. 21B will be described. The input video signals have a fourfold speed. Therefore, the period 1F/4 in one frame corresponds to the video signals. In the period 1F/4, the black insertion signals (black writing video signals) are transmitted. In the remaining 1F/2, the previous video signals may be transmitted repeatedly or, alternatively, no signal may be transmitted.

In the system in FIG. 21B, it is not necessary to hold the video signals. Therefore, the frame memory is not necessary. As described in conjunction with FIG. 5 and FIG. 9, the black writing periods “a” are implemented basically during the period of 1F/4. The signals for the black writing period is transmitted to the first 1F/4 of one frame (in FIG. 21B, it is shown as “BLACK”). The black writing signals may be self-generated in the liquid crystal display panel in this embodiment. In the embodiment shown in FIG. 21B, the black writing signals are transmitted after having adjusted in level corresponding to the input video signals.

After having written the video signals shown as “BLACK” in the liquid crystal display panel during the black writing periods “a”, the input video signals (shown as “VIDEO” in FIG. 21B) are written into the pixels 16 in the display screen 20 arranged in a matrix pattern without changing the speed. Subsequently, the video holding periods “c” follow.

As described thus far, in the system shown in FIG. 21B, the frame rate conversion of the input video signals is not necessary. The memory for storing the input video signals is not necessary as well. Therefore, the capacity of the frame memory may be reduced, and the circuit configuration is simple.

(3-2-3) Frame Conversion System 3

A “high frame rate fourfold speed system” shown in FIG. 21C will be described. The input video signals have a fourfold speed. Therefore, the period 1F/4 in one frame corresponds to the video signals. The period 1F/4 from the timing when the one frame starts is blank. The black insertion signals (black writing video signals) are inserted during this blank period. It is also possible to transmit the previous video signal repeatedly for the remaining 1F/2. No signal is also applicable.

In the system in FIG. 21C, it is not necessary to hold the video signals. Therefore, the frame memory is not necessary. As described in conjunction with FIG. 5 and FIG. 9, the black writing periods “a” are implemented basically during the period of 1F/4. The signals for the black writing period are generated in a liquid crystal display panel module in this embodiment. Subsequently, the input video signals (shown as “VIDEO” in FIG. 21C) are written into the pixels 16 in the display screen 20 arranged in a matrix manner without changing the speed. Subsequently, the video holding periods “c” follow.

As described thus far, in the system shown in FIG. 21C, the frame rate conversion of the input video signals is not necessary. The memory for storing the input video signals is not necessary as well. Therefore, the capacity of the frame memory may be reduced, and the circuit configuration is simple.

(3-3) Generation of Black Writing Period from Input Signals

(3-3-1) Same Frame Rate Processing

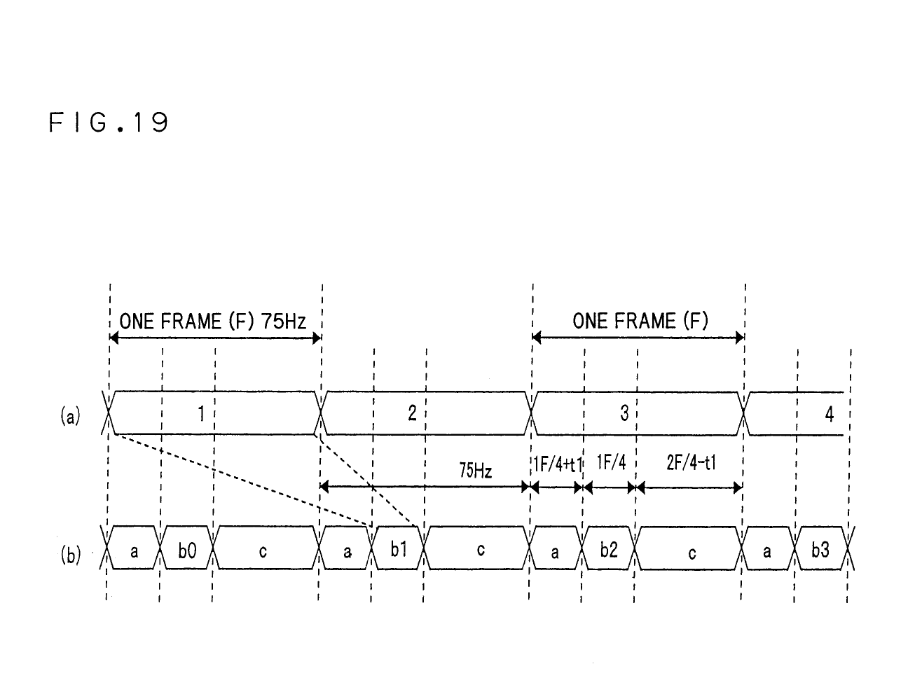

FIG. 19 is an explanatory drawing showing a method of converting the input video signals into formats shown in FIG. 5 and FIG. 9 at a fourfold speed. In FIG. 19, (a) shows video signals to be supplied to the liquid crystal display device in this embodiment, and (b) shows signals generated in the liquid crystal display device in this embodiment. In the embodiment shown in FIG. 19, the frame rate of the input video signals is set to 75 Hz. The generated frame rate is also 75 Hz. That is, the frame rate of the input video signals and the frame rate of the generated signals are the same. Basically, it employs the systems shown in FIG. 5 and FIG. 9.

As shown in (a) in FIG. 19, the input video signals are sent during the period of one frame. The sent video signals are stored in the RAM as described in conjunction with FIG. 9. Therefore, as shown in (b) in FIG. 19, the generated signals are delayed by one frame.

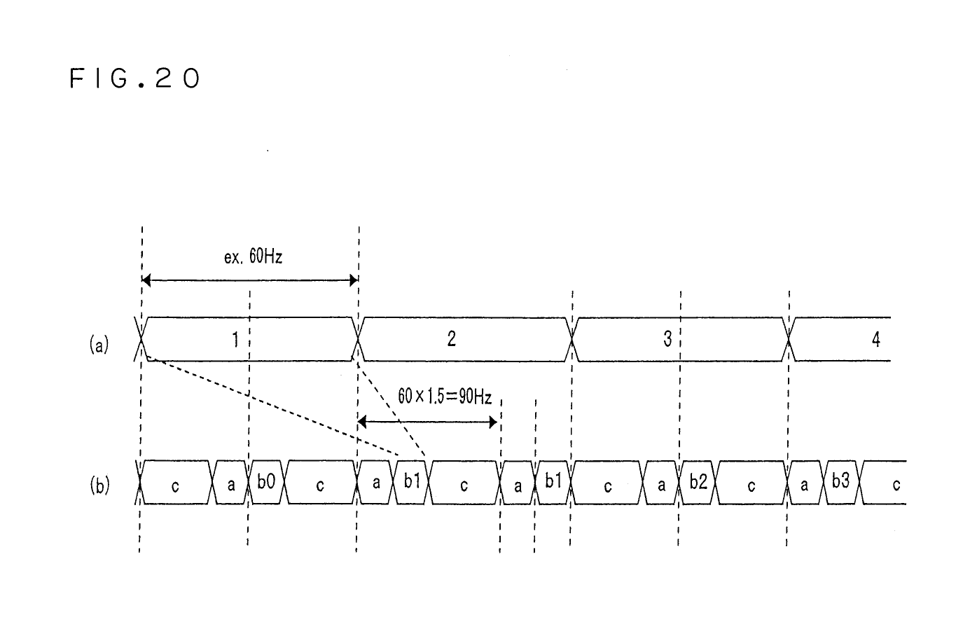

In FIG. 19 and FIG. 20, reference sign “a” designates the black writing period, and reference sign “b” designates the video writing period. Numerals added to “b” designate the frame number of the input video signals. For example, b2 represents a period or data in which the video signals of the second frame is converted into a fourfold speed.

As shown in (b) in FIG. 19, the input video signals are written in the RAM. They are read at the fourfold speed at the time of reading, and are applied to the display screen 20 at a fourfold speed during the video writing period “b”. Added before and after the video writing period are the black writing period “a” and the video holding period “c”.

The potentials of the opposed electrodes 362 are changed synchronously with the polarity of the video signals to be applied to the pixels 16. The video signals to be applied to the source signal lines S (or the video signal to be applied to the pixels 16) are a frame inversion or line inversion drive system.

(3-3-2) Different Frame Rate Processing

FIG. 20 is a system of conversion at a speed of 1.5 times which is shown in the column 2 in FIG. 22. For example, when the input frame rate is 60 Hz, the input video signals are converted into 90 Hz, which is 1.5 times. That is, two frames are converted into three frames. Therefore, the same video data comes every other frames. When the input video signals of 60 Hz are 0, 1, 2, 3, 4, . . . , they will be 0, 1, 1, 2, 3, 3, 4, . . . after conversion.

As shown in (a) in FIG. 20, the input video signals are sent during a period of one frame at 60 frames/second. The sent video signals are stored in the RAM as described in conjunction with FIG. 9. Therefore, the generated signals are delayed at least by one frame as shown in FIG. 20(b).

As shown in (b) in FIG. 20, the input video signals are written in the RAM. They are read at a speed of fourfold speed multiplied by 1.5, that is, a sixfold speed, and the read data is applied to the display screen 20 during the video writing period “b” at a sixfold speed. Added before and after the video writing period are the black writing period “a” and the video holding period “c”.

The potentials of the opposed electrodes 362 are changed synchronously with the polarity of the video signals to be applied to the pixels 16. The video signals to be applied to the source signal lines S (or the video signals to be applied to the pixels 16) are the frame inversion or line inversion drive system.

(4) Multiple Writing

A parasitic capacity is generated on the source signal lines S. The source driver circuit 14 needs to discharge the parasitic capacity. In this embodiment, it is necessary to write the black voltage and the video signals to the source signal lines S at a fourfold speed. Therefore, when the parasitic capacity is large, the target voltage cannot be achieved during one horizontal scanning period (a period for selecting one pixel row) in the internal H.

Relating this subject, it is preferable to select the pixel rows for a plurality of periods continuously and apply the voltage to the pixel 16. In particular, in the case of the liquid crystal display device, it is preferable to select the plurality of pixel rows continuously at a low temperature.

The preferable number of times for selecting the pixel rows continuously (the black writing period, the video writing period) differs depending on the liquid crystal mode. It also differs depending on the temperature. The TN liquid crystal mode is needed to be set to a relatively long time. In the case of the OCB liquid crystal mode, since the response of the liquid crystal molecule is fast, it may be a short time. The liquid crystal has a dependency on the temperature. Therefore, a configuration in which the external temperature is detected (measured) by a temperature sensor such as the thermistor, so that the number of times of the continuous writing can be varied is preferable.

(4-1) Example of Multiple Writing 1

FIG. 24 shows the number of times of continuous writing with numerals added to H. For example, in the black writing period “a”, the reference signs 5 H represents that the same pixel row is selected for five horizontal scanning periods. Normally, it is 1 H. If it is desired to select the pixel rows continuously by 5 H, the start pulse to be supplied to the gate driver circuit 12 in FIG. 1 is applied continuously for the five horizontal scanning periods. The five continuous start pulses are shifted in the gate driver circuit 12 in sequence synchronously with the internal H signal, and select the gate signal lines G. The selected gate signal lines G output ON voltage continuously for the five horizontal scanning periods (internal H).

In the black writing period “a”, the black voltage is applied five times continuously to the respective pixel rows as shown by (a) in FIG. 24. A drive inversion system employs a frame inversion drive system. Therefore, in this period, the polarity inversion with the common signals and the video signals (black voltage signals) does not occur during this period. Even when the black voltage cannot be written into the pixels in the first 1 H, the black voltage can be applied to the pixels in the subsequent H period. The voltage can be applied sufficiently to the pixels even at a temperature lower than −30° C. by applying the same black voltage to the pixels continuously for 5 H. In the video writing period “b”, the video signals of a fourfold speed are written into the pixel rows for the period of 1 H as usual.

(4-2) Example of Multiple Writing 2

The black voltage is applied to the respective pixel rows 25 times continuously in the black writing period “a” as shown by (b) in FIG. 24. In the drive inversion system, as in the embodiment shown above, the frame inversion drive system is employed. Therefore, during this period, the polarity is not inverted with the common signals and the video signals (black voltage signals). Even though the black voltage cannot be written to the pixels at the beginning, the black voltage can be written to the pixels sufficiently by applying the same black voltage for the period of 25 H. The video signals of a fourfold speed are written into the pixel rows for the period of 3 H in the video writing period “b” (b1). In the video writing period “b” (b1), the black voltage is applied three times continuously to the respective pixel rows. Even though the video signals to the pixels at the beginning cannot be written, the video signals can be written sufficiently to the pixels by applying the same video signals for the period of 3 H.

In a case in which writing is not sufficient even though the continuous writing is performed during the video writing period “b” (b1), the video holding period c1 can be used as the video writing period. In order to show this example, in the embodiment shown by (b) in FIG. 24, the video writing period “b” is marked as b1, which means the video writing (first time). The video holding period c1 is originally considered as the video writing (second time) and is marked as b2. The video writing periods b1, b2 may be selected once (1 H), respectively. In the embodiment shown by (b) in FIG. 24, the backlight 18 is illuminated during the video holding period c1 (video writing period b2) and the video holding period c2. (In the video writing period b2), only the image writing state may be visually recognized. However, in the video writing (first time) and the video writing (second time), the image writing state is little recognized visually since the same image is written. Other configurations and systems are the same as the drive system described above, and hence description will not be given again.

Furthermore, when the writing is not sufficient even though the video signals are written in the video holding period c1 in the part (b) in FIG. 24, the video holding period c2 may be used as the video writing period. The writing of the video signals in the video holding periods c1, c2 may be performed by selecting the respective pixel rows by a number of times as in the case of the video writing periods “b”. Other configurations and systems are the same as the drive system described above, description will not be given again.

(4-3) Reading of RAM

FIG. 25 corresponds to the configuration shown in FIG. 9, in which the multiple writing system described in FIG. 24 is employed. In the lower graph in FIG. 25, the hatched ranges indicate that the multiple writing is performed (for example, 5 H in the black writing period). Since other configurations are the same as in FIG. 9, description will not be given again.

FIG. 26 corresponds to the configuration shown in FIG. 6, in which the multiple writing system described in FIG. 24 is employed. FIG. 26 shows an embodiment in which the video signals are written for 2 H during the video writing period. An X-ODD of the gate signal lines G is applied with an ON voltage for 2 H (the unit of internal H), and the position to be applied is shifted by one gate signal line G. Other configurations are the same as FIG. 6, and hence description will not be given again.

As described above, the embodiment is not limited to a mode in which the video signal writing operation is stopped during the video signal holding period “c”. It is also possible to perform the video signal writing operation during the period of c1 and the period of c2. Since the image data to be written does not change, the video quality is not deteriorated even in the state in which the backlight 18 is illuminated, and the movie display performance is maintained.

The number of times of the video signal writing scans does not have to be once, and may be repeated three times, four times . . . The video signal writing scans from the second time on may be performed during the period in which the backlight 18 is illuminated. It is because that even though the video signal writing scan is performed, the image data to be written in the pixels 16 is the same, and hence the image display state does not change. It is also possible to start illumination of the backlight after having completed the scanning from the second time on as a matter of course.

It is also possible to perform the video signal writing during the original video holding periods (c1, c2). As regards the number of times of the video signal writing scan and the timing of illuminating the backlight 18, suitable conditions may be employed considering the load applied to the source driver circuit 14 and the required luminance.

In this embodiment, there may arise luminance inclination since the response of coefficient of transmission is different between the uppermost row and the lowermost row in the display screen 20 due to delay of the liquid crystal response. Such luminance inclination may be restrained by inverting the vertical scanning direction for selecting the plurality of pixel rows, that is, by inverting the scanning direction every frame such as scanning the pixel rows from the uppermost row to the lowermost row in the ODD frames and from the lowermost row to the uppermost row in the EVEN frames. Alternatively, it is also possible to perform the amplitude modulation of the video signals corresponding to the generated luminance inclination. Alternatively, the value of amplitude of the common voltage signals VCOM may be modulated.

(5) OCB (Optically Compensated Bend) Liquid Crystal

The OCB liquid crystal will be described. The OCB liquid crystal is high response and hence is mounted to liquid crystal TVs and the liquid crystal monitors.

As shown in FIG. 36A, the OCB liquid crystal is sandwiched between the pixel electrodes 23 disposed on the array substrate 15 and the opposed electrodes 362 disposed on the opposed substrate 361 arranged so as to oppose to the array substrate 15. In a state in which the voltage is not applied to the liquid crystal layer 364, liquid crystal molecules 365 of the liquid crystal layer 364 assume a spray alignment. Therefore, the liquid crystal molecules 365 may be transferred to a bend alignment by applying a high voltage on the order of several volts between the pixel electrodes 23 and the opposed electrodes 362 when the power source is supplied.

When applying the high voltage for ensuring this phase transfer, the voltages having the opposite polarities are written to the adjacent horizontal pixel lines alternately to give a twisted potential difference in the lateral direction between the adjacent pixel electrode 23 and the pixel electrode 23 for phase transfer, so that nucleation is achieved, whereby the phase transfer is achieved about this nucleus. The spray alignment is converted to the bend alignment by performing such an operation for about one second, and undesired history is deleted by brining the potential difference between the pixel electrodes 23 and the opposed electrodes 362 into the same potential.

After having brought the liquid crystal molecules 365 into the bend alignment, the voltage equal to or higher than a low OFF voltage which can maintain the bend alignment is applied from a drive power source 366 to the liquid crystal molecules 365 as shown in FIG. 36B during operation. The OFF voltage and an ON voltage which is higher than the OFF voltage are applied from the drive power source 366 between the pixel electrodes 23 as shown in FIG. 36C. By changing the drive voltage between the ON and OFF voltages, the bend alignment of the liquid crystal molecules 365 is changed from a state shown in FIG. 36B to a state shown in FIG. 36C to change the retardation value of the liquid crystal layer, so that the coefficient of transmission is controlled.

When performing the image display using the OCB liquid crystal display device as described above, it is considered to control birefringence, drive, for example, the liquid crystal display panel by the drive circuit by the combination with the polarizing plate, block light in the state of applying high voltage (black display), and transmits the light in the state of applying low voltage (white display).

In the liquid crystal display panel as OCB mode, the black voltage drive is used intending to prevent the reverse transfer to the spray alignment. In this case, the liquid crystal display panel performs the video signal display for about 80% of one frame period, and the black display (non video signal display), which brings the drive voltage into the maximum voltage, during remaining 20% of one frame period.

(6) Application of Maximum Voltage

(6-1) Applied Voltage and Coefficient of Transmission of Liquid Crystal Layer

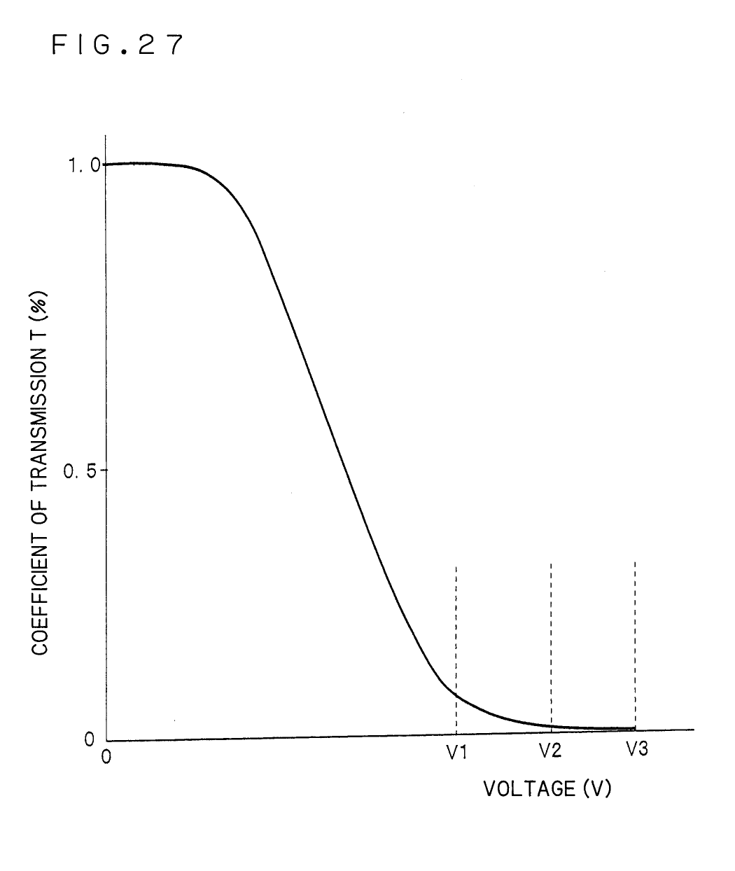

FIG. 27 is a drawing showing the relation between the voltage applied to the liquid crystal layer and the coefficient of transmission of the liquid crystal layer. The lateral axis in FIG. 27 represents an absolute value (effective value) of the voltage to be applied to the liquid crystal layer. The vertical axis shows the coefficient of transmission of the liquid crystal layer. The relation between the liquid crystal layer and the polarization axis of the polarizing plate is a normally white (NW) display. In the NW display, the voltage closer to zero corresponds to the high gradation of the video signals and the higher voltage corresponds to the low gradation of the video signals.

The higher the absolute value of the voltage applied to the liquid crystal layers 364 of the pixels 16 is, the lower the coefficient of transmission of the liquid crystal layer becomes. Therefore, the contrast ratio may be increased. Therefore, in the black writing period “a”, it is preferable to apply a high black voltage. In particular, in the OCB liquid crystal, the reverse transfer from the bend alignment to the spray alignment is effectively restrained by applying a high black voltage during the black writing period “a”.

(6-2) Application of Voltage during Black Writing Period a

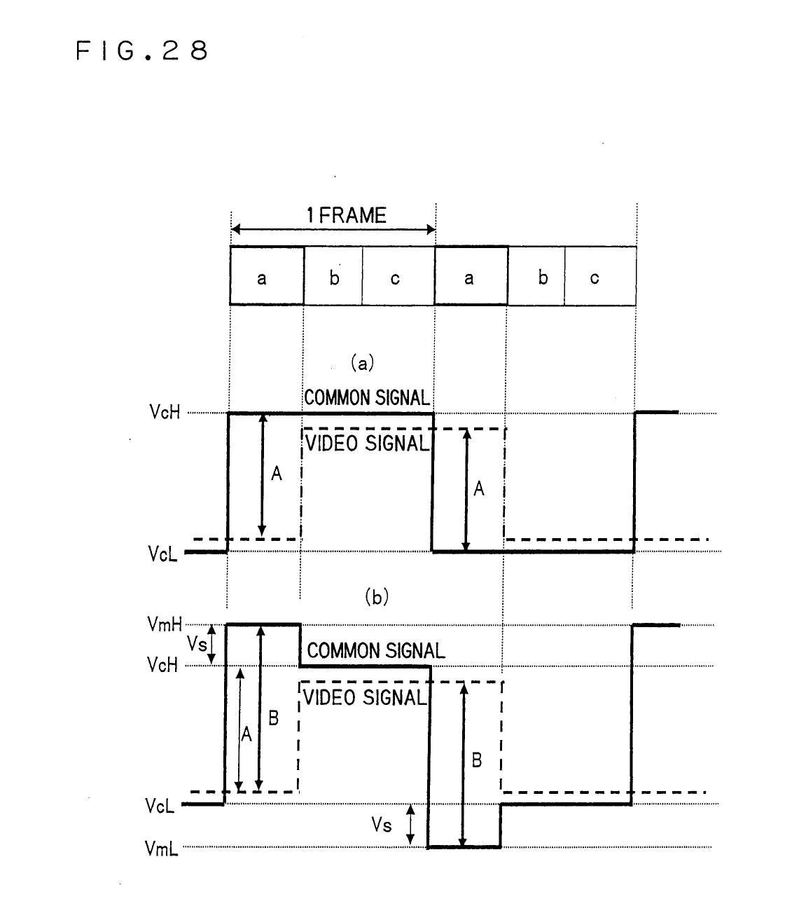

In FIG. 28, the common voltages are indicated by solid lines, and video signals outputted from the source signal lines S are indicated by dot lines. The state of application of the video signals is a high gradation (white display). The part (a) in FIG. 28 shows the relation between the common voltages and the source signal lines S which has been described thus far. In the part (a) in FIG. 28, the common voltage is VcH and the video signal (source signals) is at the minimum voltage during the black writing period “a”. The potential difference between the value of VcH and the video signals is indicated by A. The voltage A is applied to the liquid crystal layer and the liquid crystal layer is turned into the black display. During the video writing period “b”, the potential difference between the video signals and the common voltage is reduced to achieve the white display, and the potential difference during the video writing period is maintained during the video holding period “c”.

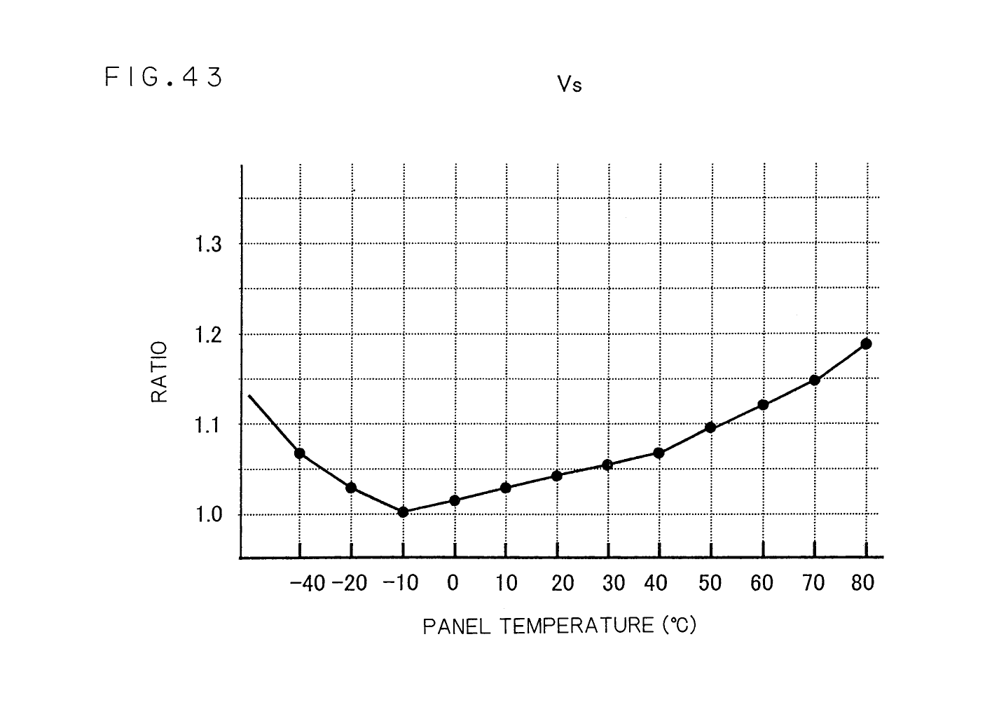

In an embodiment shown in the part (b) in FIG. 28, the common voltage also become the values of VmH, VmL in addition to VcH, VcL. The values of VcH, VcL, VmH, VmL are outputted to the opposed electrodes by being switched by a switching circuit. The values of VmH, VmL can also be changed by the panel temperature in the same manner as the values of VcH, VcL. The potential difference Vs=VmH−VcH and the potential difference Vs=VcL−VmL preferably set to a value in the range from 0 V to 2.0 V. The value Vs is varied with the panel temperature (see FIG. 43).

In the part (b) in FIG. 28, the common voltage is VmH during the black writing period “a”, and the video signals (source signals) are set to a minimum voltage during the black writing period “a”. The potential difference between the value of VmH and the video signals is indicated by B. The voltage B is applied to the liquid crystal layer, and the liquid crystal layer is turned into the black display. During the video writing period “b”, the potential difference between the video signals and the common voltage is reduced in order to set the common voltage VcH and achieve the white display. In the video holding period “c”, the potential difference during the video writing period is maintained. In the subsequent frame, the common voltage is set to VmL and the video signals (source signals) are set to a maximum voltage during the black writing period “a”. The potential difference between the VmL and the video signals is indicated by B. The voltage B is applied to the liquid crystal layer, and the liquid crystal layer is turned into the black display. During the video writing period “b”, the potential difference between the video signals and the common voltage is reduced in order to set the common voltage signals to VcL, and achieve the white display. In the video holding period “c”, the potential difference during the video writing period is maintained.

As described above, in the driving method in this embodiment described in the part (b) in FIG. 28, a high voltage is applied to the liquid crystal layer 364 in the black writing period “a” (A>B). Therefore, in the liquid crystal characteristic (voltage—characteristic of coefficient of transmission) shown in FIG. 27, a desirable black display is achieved. In the OCB liquid crystal, the reverse transfer can be prevented.

In this embodiment, the both drive systems in the part (a) and the part (b) in FIG. 28 can be realized. The common voltage (common signal) are set to have the relations VcH=VmH, VmL=VcL.

The VmH, VmL are applied to the opposed electrode 362 during the black writing period “a”. However, the embodiment is not limited to the application of the VmH or VmL to the opposed electrodes 362 during the entire period of the black writing period “a”. What is at least necessary is to apply the VmH or VmL to the opposed electrodes 362 during a certain period of the black writing period a. Therefore, to “apply the VmH or VmL to the opposed electrodes 362” means to apply the entire or a part of the black writing period “a”.

(6-3) Liquid Crystal Mode in which Coefficient of Transmission Increases

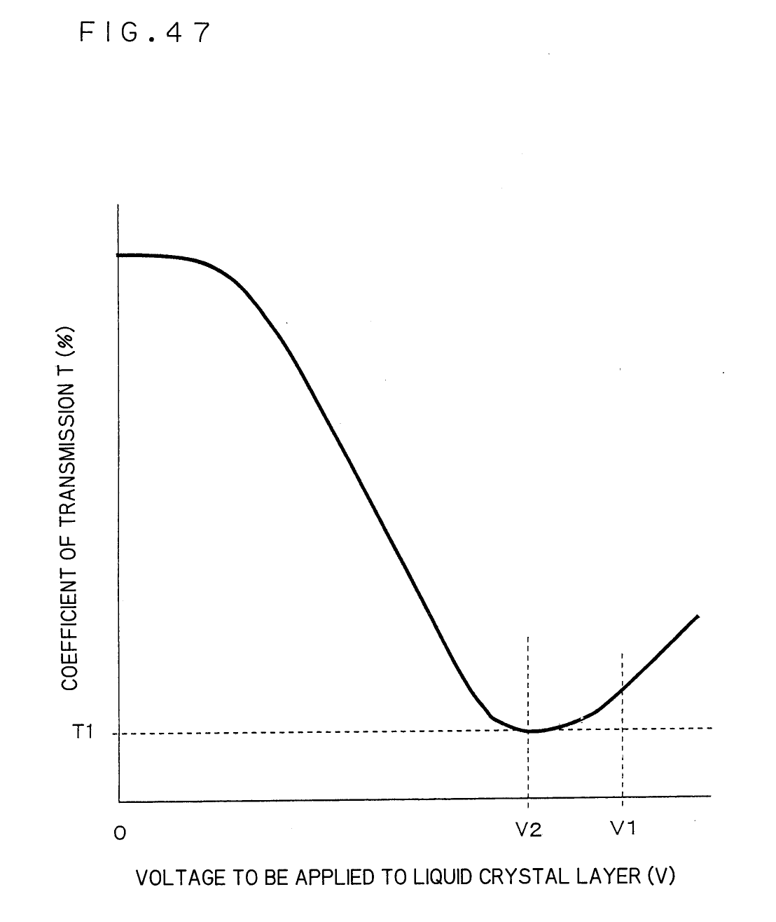

As shown in FIG. 27, the higher the voltage to be applied to the liquid crystal layer increases, the lower the coefficient of transmission becomes in most cases. However, as shown in FIG. 47, when the voltage to be applied to the liquid crystal layer is increased to a value higher than a certain level, the coefficient of transmission may be increased in contrast. In FIG. 47, the coefficient of transmission is minimum at a voltage V2, and the coefficient of transmission becomes T1, which is higher at a voltage V1. For example, when the film thickness of the liquid crystal layer is out of the optimal conditions, the characteristic shown in FIG. 47 is observed in many cases.

In this embodiment, the backlight 18 is extinguished during the black writing period “a”. Therefore, even though the coefficient of the transmission is increased during the black writing period “a”, it can hardly be recognized visually.

(6-4) Obtuseness of Waveform of Common Voltage

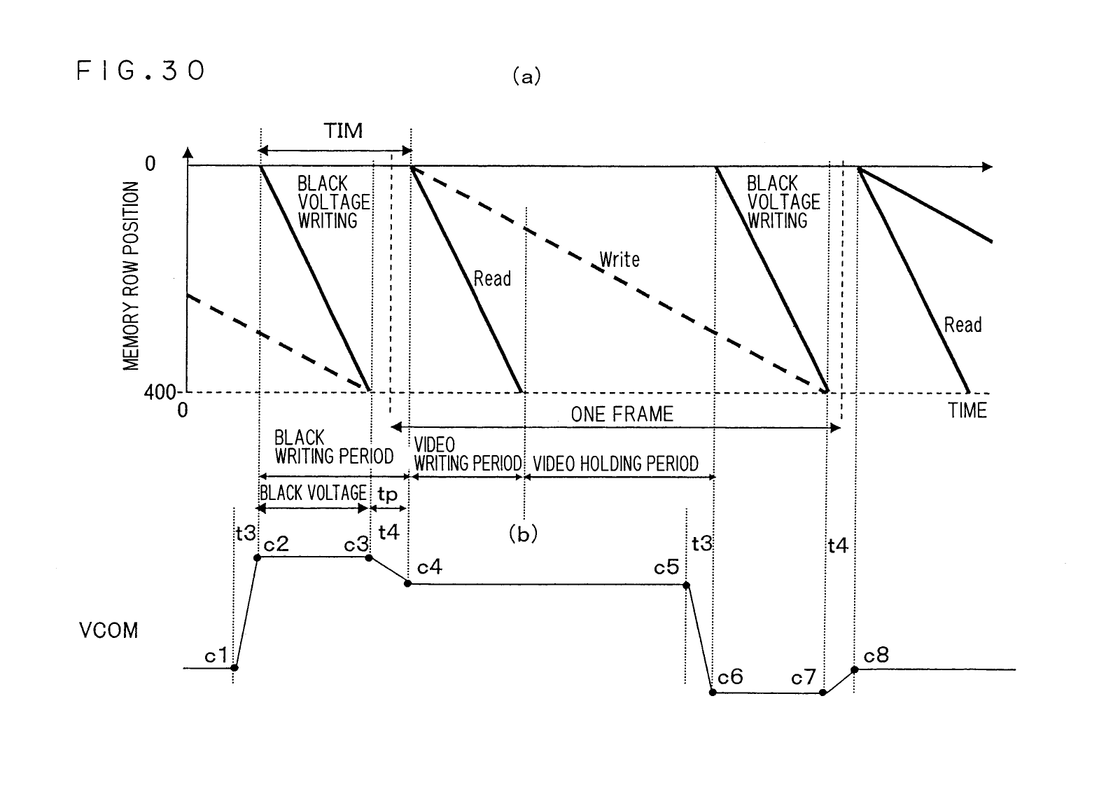

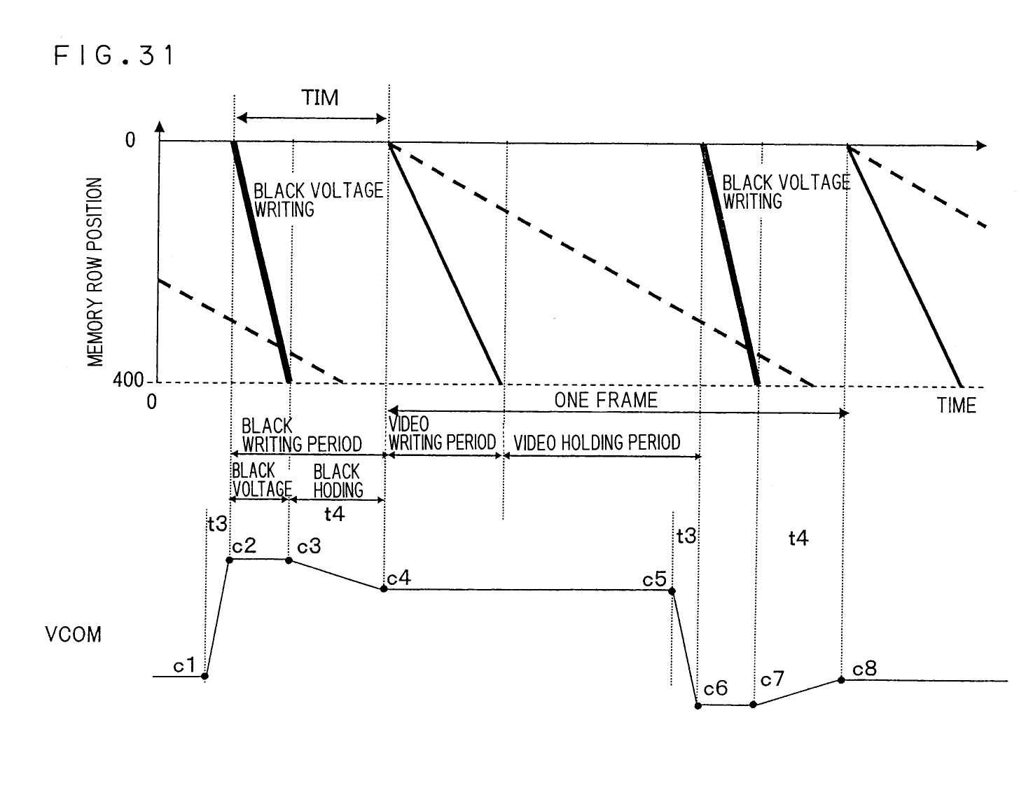

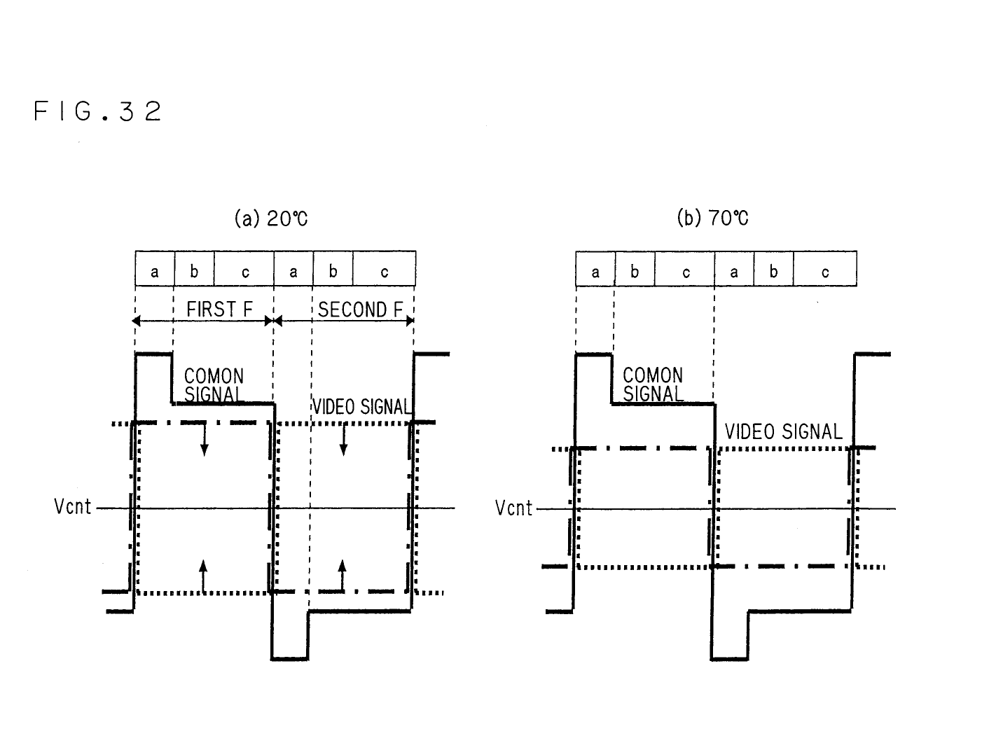

In the part (b) in FIG. 28, an ideal common voltage waveform is shown. However, since there is a capacity in the opposed electrodes 362, there arises an obtuseness in the common voltage (VCOM) which is applied to the opposed electrodes 362 shown in FIG. 30. In order to solve this problem, the change points of the common voltage are set synchronously with the black writing period and the video writing period (or the timing of RAM reading) as shown in FIG. 31 and FIGS. 32A and 32B.

In FIG. 30 and FIG. 31, description is given assuming that the voltage at a point c1 is VcL, the voltage at a point c2 is VmL, the voltage at a point c4 is VcH, and the voltage at a point c6 is VmL.

FIG. 30 shows a change of the common voltage in the drive system shown in FIG. 9 and the RAM reading system. In FIG. 30, the point c2 is matched with the beginning point of the black writing period for applying a sufficient common voltage to the opposed electrodes 362 and to the liquid crystal layer 364. The change to the point c2 is started from the point c1, which is a point before the black writing period. It is in the range from 10 μsec to 100 μsec during a term t3 from the point c1 and the point c2.

The time point when the black writing period “a” is completed is designated as c3, and the time point when the video writing period “b” starts (when the RAM reading starts) is designated as c4. A time difference t4 between the point c3 and the point c4 is from 50 μsec to 1 msec. When the point c4 and the term t4 are determined, the position of the point c3 is obtained by counting backward. The term t4 is sufficiently secure corresponding to the blank period tp of the video signals. The changes from VmH to VcH, and from VmL to VcL contribute to discharge the electric charge of the opposed electrodes 362, and hence it takes time to change relatively. The term t4 corresponds to the black voltage holding period. When the change of the coefficient of transmission of the liquid crystal layer 364 due to the voltage is slow, the term t4 may be elongated. Therefore, in this embodiment, the term t4 is adapted to be set to different values by the liquid crystal mode. More specifically, a counter circuit which can set the term t4 by command is provided in the gate source driver IC31. As regards the term t3, there is provided a counter circuit which changes the term t3. The counter circuits are synchronized with the black writing period and the video writing period.

The term t4 is changed by the panel temperature. When the panel temperature is low, the term t4 is set to a long term, and when the panel temperature is high, the term t4 is set to a short term. This operation is performed depending on the results of the output from a temperature detection circuit which is shown in FIG. 39, for example.

In the same manner, the point c6 is matched with the beginning point of the black writing period for applying the sufficient common voltage to the opposed electrodes 362 and the stable voltage to the liquid crystal layer 364. The change to the point c6 is started from a point c5, which is a point before the black writing period. A time point when the black writing period “a” is completed is designated as c7 and the time point when the video writing period “b” is started (the RAM reading is started) is designated as c8.

According to the embodiment, the phase relation between the VCOM signals and the video signals can be adjusted by shifting the phases thereof. By shifting the phase relation between the VCOM signals and the video signals, the luminance inclination of the screen can be adjusted easily.

(6-5) Multiple Speed Drive of Black Writing Period

In the embodiments shown above, a system in which the positions of the pixel rows to be selected are shifted by one pixel row during the black writing period. More specifically, the state of writing of the black voltage to the pixels 16 during the black writing period is a system in which the source output is replaced by the black voltage in the timing waveform in FIG. 6. The gate signal lines G are selected in sequence from X_ODD 1 to X_EVEN 200 and the black voltage applied to the source signal lines S is written to the pixels 16 by the unit of pixel row. It is the same when selecting the plurality of pixel rows. FIG. 26 shows a method of selecting two pixel rows. The gate signal lines G are selected from X_ODD 1 to X_EVEN 200 in sequence for the period of 2 H, the black voltage applied to the source signal lines S is written to the pixels 16 by the unit of the pixel row. The positions of the pixel rows to be selected are shifted by one pixel row synchronously with the internal H.

In FIG. 6 and FIG. 26, the period required for writing the black voltage to the display screen 20 is 1F/4. The liquid crystal requires a predetermined time from being applied with the voltage until achieving a predetermined coefficient of transmission. Therefore, even when the black voltage is applied to the pixels 16, the target coefficient of transmission cannot be achieved immediately.

In FIG. 26, there is a blank period tp from writing of the black voltage to the 400^{th} pixel row (X_EVEN 200). Therefore, even at the 400^{th} pixel row (X_EVEN 200), the target coefficient of transmission is achieved during the blank period tp. However, there are video signals which have very short blank period tp. There is also a case in which the video writing period “b” has to be started immediately after termination of the black writing period “a”. In this case, the liquid crystal does not follow the voltage which is written into the pixels 16.

Relating to this problem, in this embodiment shown in FIG. 31, the black voltage is written to the entire pixel rows in the display screen 20 during the former half of the 1F/4 period of the black writing period “a”, and selection of the gate signal lines G is stopped in the later half of the 1F/4 period thereof. In the latter half of the 1F/4, the liquid crystal layer of the pixels responds by the voltage written in the pixels 16.

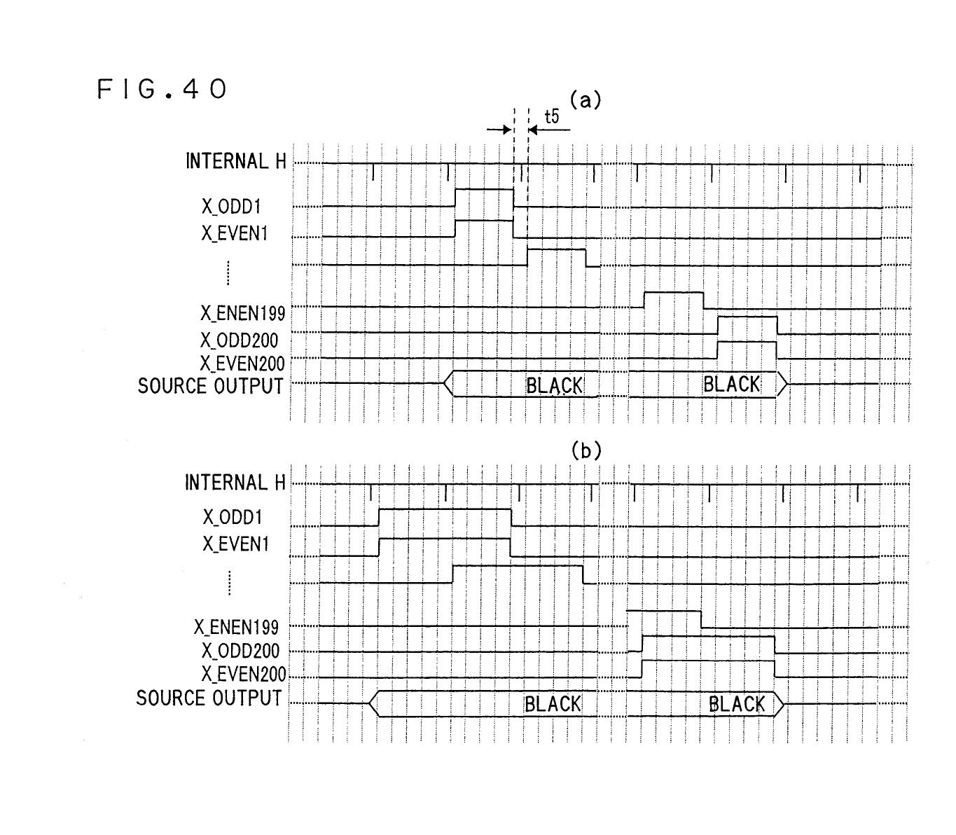

In the embodiment shown in FIG. 31, the plurality of pixel rows are selected simultaneously, and the black voltage applied to the source signal lines S is written to selected pixel rows during the black writing period. FIG. 40 is a timing chart of the black voltage writing system shown in FIG. 31.

In FIG. 40A, X_ODD 1 and X_EVEN 1 are simultaneously selected in the first internal 1 H. In the subsequent internal 1 H, X_ODD 2 and X_EVEN 2 are simultaneously selected. Then, in the subsequent internal 1 H, X_ODD 3 and X_EVEN 3 are simultaneously selected. After having repeated the selection in this manner, X_ODD 200 and X_EVEN 200 are selected simultaneously in the last internal 1 H. That is, the two (a plurality of the) gate signal lines G are selected in 1 H, different two (a plurality of the) gate signal lines G are selected in the subsequent 1 H period. In other words, the plurality of pixel rows are selected simultaneously, and then subsequent pixel rows other than these selected plurality of pixel rows are selected. The source output (black voltage) applied to the source signal lines S is written in the selected pixel rows.

By selecting the pixel rows as shown in FIG. 40A, the black voltage can be applied to the display screen 20 during a period of ½. Therefore, in the latter half period of ½, the liquid crystal layer can sufficiently respond to the applied voltage. The polarities of the common voltage and the video signals are the same as the embodiments shown in FIG. 6 and FIG. 26.

In FIG. 40B, in the 1 H (the first internal 1 H), X_ODD 1 and X_EVEN 1 are simultaneously selected. In the 2 H (the subsequent internal 1 H), X_ODD 1, X_EVEN 1, X_ODD 2, X_EVEN 2 are simultaneously selected. In the 3 H, X_ODD 2, X_EVEN 2, X_ODD 3, X_EVEN 3 are simultaneously selected. After having repeated the selection in this manner, X_ODD 200 and X_EVEN 200 are simultaneously selected at the last internal 1 H. That is, two (a plurality of the) gate signal lines G are selected in the period of 1 H. The pixel rows to be selected are kept selected for the period of 2 H. In other words, the plurality of pixel rows are selected simultaneously, and the selected pixel rows are kept selected for a plurality of H periods.

In FIG. 40B, the plurality of gate signal lines G are selected simultaneously, the black writing period is shortened, and the black holding period is elongated. Accordingly, the response time of the liquid crystal layer by the application of the black voltage can be secured sufficiently. Configurations other than those described above are the same as in FIG. 6, FIG. 26 and FIG. 40A, and hence description will not be given again.

When the selection of the same pixel rows is a 1 H period as shown in FIG. 40A, the period for selecting the respective gate signal lines G are 1 H or shorter. Therefore, the period to apply an ON voltage is 1 H or shorter. Therefore, there exists a blank (OFF period) which is represented by t5 in each selected period. In this manner, by providing the blank period, the mixture of signals among the pixel rows is avoided. In particular, the matter described above is effective during the video writing period “b” (see FIG. 6). As shown in FIG. 40B, in the case in which the same pixel rows are selected for a plurality of H periods, the blank (OFF period) like in FIG. 40A is not provided, and the ON voltage is continuously applied. Such way of writing is effective when the writing voltage is continued for a plurality of H periods as in FIG. 40B and FIG. 26.

(7) Adjustment of Voltage to be Applied to Gamma Circuit and Liquid Crystal

Voltage-coefficient of transmission of the liquid crystal is different depending on RGB. The voltage-coefficient of transmission is different also depending on the film thickness of the liquid crystal layer 364. Therefore, it is necessary to adjust optimal gamma curve and white balance by adjusting the voltage to be applied to the liquid crystal. Since the liquid crystal has a dependency on the temperature, it is necessary to adjust the voltage (common voltage and video signals) to be applied to the liquid crystal layer according to the temperature.

(7-1) Adjustment of Video Signal and Common Voltage

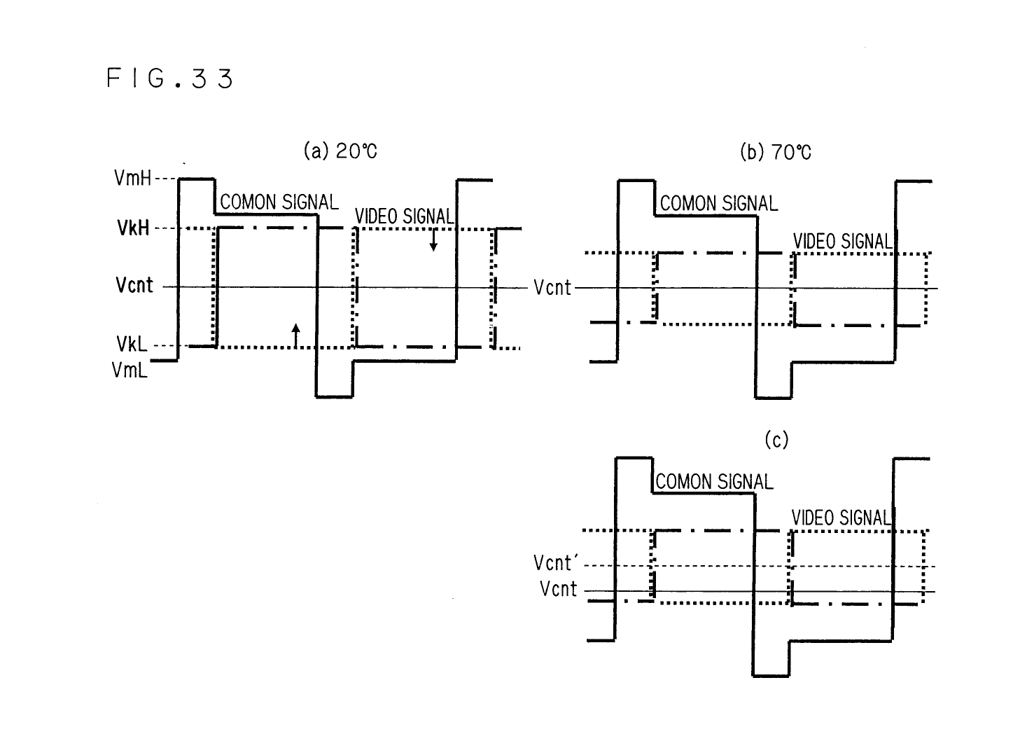

FIG. 32 shows the relation between the video signals and the common signals (common voltages). In FIGS. 32A and 32B and FIGS. 33A, 33B, and 33C, the common signals of the positive polarity are represented each by a solid line in the first frame in order to avoid complexity of the drawings. In the same manner, the video signals of the positive polarity are represented by a long and short dashed line and of the negative polarity by a dotted line in the first frame. The polarities of the common signals and the video signals are switched every frame between the positive polarity and the negative polarity with the Vcnt as the center potential. Actually, the Vcnt of the common signals and the Vcnt of the video signals are different, because a let-through voltage may be generated in the pixels. In this specification, in order to facilitate description, it is assumed that the Vcnt (center voltage) of the video signals and the common signals have the same potential.

How to adjust the amplitude of the video signals and the common signals will be described now. In the description, an example in which adjustment of the amplitude is performed depending on the panel temperature is given. In the case of the OCB liquid crystal mode, the value of amplitude is required to change with the temperature. In the example, a case in which the common signals have states of VmH and VmL is shown. However, the method of adjustment in the embodiment is not limited thereto. As shown in the part (a) in FIG. 28, the common signals which do not have the states of VmH and VmL are also applicable, as a matter of course.

(7-1-1) First Example of Adjustment

FIG. 32A shows a case in which the panel temperature is 20° C. FIG. 32B shows a case in which the panel temperature is 70° C. In FIGS. 32A and 32B, the polarities of the video signals and the common signals are switched at the positions where the black writing periods “a” start as shown in FIG. 28. The value of amplitude of the common signals is not changed with the change of the panel temperature. The value of amplitude of the video signals is reduced with increase in panel temperature. The center voltages Vcnt of the video signals and the common signals are the same, and the Vcnt is not changed with the change of the panel temperature. In an amplitude adjustment system in FIGS. 32A and 32B, the polarities of the video signals and the common signals are switched simultaneously, and hence drive control is easy.

(7-1-2) Second Example of Adjustment

FIG. 33A shows a case in which the panel temperature is 20° C. FIG. 33B shows a case in which the panel temperature is 70° C. In FIGS. 33A to 33C, the polarities of the video signals and the common signals are switched at the positions where the video writing periods “b” start (including the positions where the black writing periods “a” start, and the black voltage holding period) as shown in FIG. 28. The value of amplitude of the common signals is not changed with the change of the panel temperature. The value of amplitude of the video signals is reduced with increase in panel temperature. The center voltages Vcnt of the video signals and the common signals are the same, and the Vcnt is not changed with the change of the panel temperature.

In the drive system shown in FIG. 33B, the change of the polarity of the video signals is delayed by (1F/4) period with respect to the common signals in the first frame. The blank period tp is set to zero. By delaying the polarity of the video signals, a voltage of VmH-VcL is applied during the black writing period “a”. In other words, a high voltage (black voltage) is easily applied to the liquid crystal layer 364. The reference sign VkH in the drawing represents the amplitude voltage on the side of the positive polarity of the video signals. The reference sign VkL represents the amplitude voltage on the side of the negative polarity of the video signals.

As a matter of course, in the second frame as well, the change of the polarity of the video signals is delayed by (1F/4) period with respect to the common signal as in the case of the first frame. By delaying inversion of the polarity of the video signals by (1F/4), the voltage of the VkH-VmL is applied during the black writing period “a”. In other words, a high voltage (black voltage) is easily applied to the liquid crystal layer 364. In the case of the OCB liquid crystal, the higher the voltage applied during the black writing period “a”, the more the reverse transfer is restrained. Therefore, in the system shown in FIGS. 33A to 33C, the high black voltage can be applied easily to the black writing periods “a”, and hence the reverse transfer can effectively restrained.

As shown in FIG. 33C, the center voltage may be changed from Vcnt to Vcnt′ with the change in temperature. It is also possible to change the value of the amplitude of the value of the common amplitude (common voltage) with the change of the temperature.

(7-2) Switching of Polarity of Common Signal and Video Signal

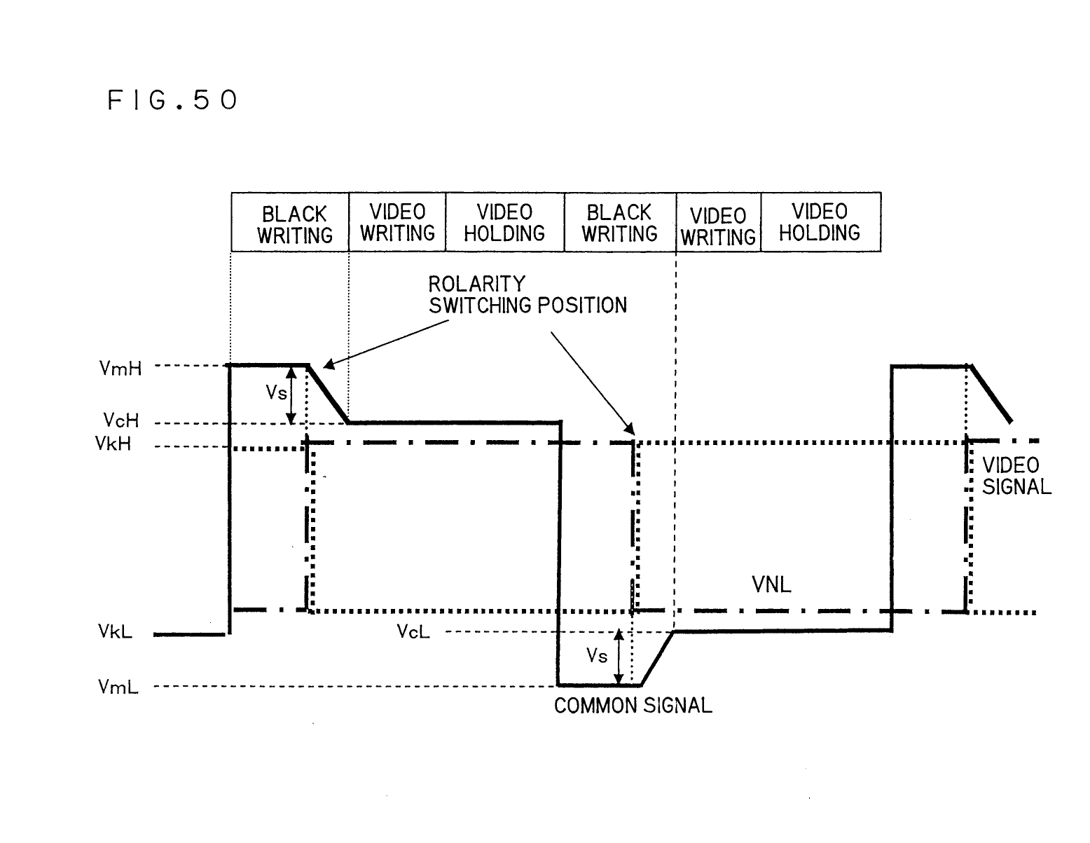

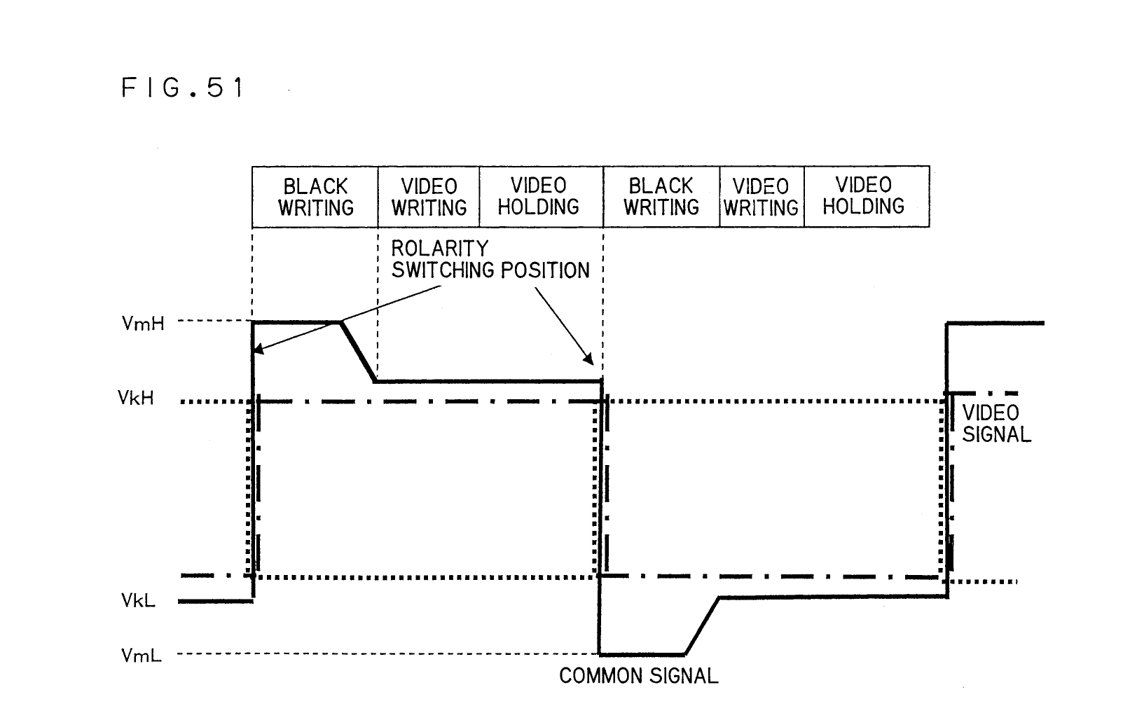

FIGS. 32A and 32B and FIGS. 33A, 33B and 33C show the relation between the video signals and the common signals (common voltage). FIG. 30 and FIG. 31 show obtuseness of the waveform of the common signals. FIG. 50 and FIG. 51 show the common signal and the point to switch the polarity.

In FIG. 50 and FIG. 51 as well, the common signals of the positive polarity are represented each by a solid line in the first frame in order to avoid complexity of the drawings. In the same manner, the video signals of the positive polarity are represented by a long and short dashed line and of the negative polarity by a dotted line in the first frame. The driving method in the embodiment is not limited thereto. As shown in the part (a) in FIG. 28, the common signals can be applied even though they do not have the states of VmH and VmL.

FIG. 50 shows a driving method which is effective in a driving method for the transmissive liquid crystal display panel. It is because that a high voltage can be applied during the black writing period, and hence a desirable black display is achieved. It is particularly desirable as the driving method for the OCB liquid crystal.

In the liquid crystal display device using the OCB liquid crystal, even when the bend alignment is achieved once, if a state in which the voltage at a predetermined level of higher is not applied for a certain period or more to the liquid crystal layer continues, a phenomena such that the bend alignment cannot be maintained and the alignment is returned to the spray alignment (hereinafter, this phenomenon is referred to as reverse transfer) occurs. In order to prevent this reverse transfer, the black voltage is applied to the OCB liquid crystal.

In the drive system shown in FIG. 50, even though the video signals to be written into the pixels during the video writing periods are white display (low in voltage to be applied to the liquid crystal layer as shown in FIG. 50), a high voltage is applied to the liquid crystal layer in the black writing periods. The voltage to be applied to the liquid crystal layer 362 changes from frame to frame. In order to reduce the change in amplitude of the video signals by the application of the high voltage during the black writing periods, the switching of the polarity as shown in FIG. 50 is performed. When changing from the negative voltage to the positive voltage, and from the positive voltage to the negative voltage, the polarity switching is performed before the video writing period (including the same time as the beginning of the video writing period), and the gate signal lines G are selected in sequence, and the polarity of the frame is maintained during the period in which the black voltage is written in the pixels 16 during the black writing period.

A voltage to be applied in order to maintain the bend alignment, or in order to prevent or restrain the reverse transfer is applied during the black voltage period. In FIG. 50, the sufficient black voltage can be applied during the black writing period. A voltage which causes the alignment to be transferred from the spray alignment to the bend alignment may also be referred to as the black insertion voltage. The voltage may be referred to as “transfer voltage”.

FIG. 51 is a driving method effective in a driving method for the transflective or reflective liquid crystal display panel. Since the image is displayed by reflecting the outside light, the contrast may be deteriorated by the application of the high voltage in the case of the voltage-coefficient of transmission characteristic as shown in FIG. 47.

In the drive system shown in FIG. 51, the position where the polarity of the video signals is switched is substantially matched with the position where the polarity of the common signals is switched. As described above, since the switching of the polarity is not performed during the black writing period, the movement of the liquid crystal molecules in the liquid crystal layer is stabilized and the desirable image display is realized. Since the operation of the amplitude of the video signal is easy in the transflective and reflective liquid crystal display panel, the high contrast display is achieved.

(7-3) Asymmetry Setting of Common Voltage

The common voltages in FIG. 7, FIG. 28, FIGS. 32A and 32B, and FIGS. 33A to 33C are symmetry between the side of the positive polarity VmH and VcH and the side of the negative polarity VmL and VcL, with respect to the Vcnt as a center, respectively. However, the embodiment is not limited thereto. In particular, the waveforms of VmH and VmL are liable to be deflected. Therefore, it is configured so that the voltage can be set independently on the side of the positive polarity and the side of the negative polarity, respectively. That is, the asymmetry voltage setting is possible between the side of the positive polarity and the side of the negative polarity. More specifically, four DA (digital-analogue) conversion circuits for generating VmH, VmL, VcH and VcL are formed in the gate source drivers IC31.

(7-4) Reading of Black Voltage and Voltage During Blank Period

FIG. 9, FIG. 25, FIG. 30, FIG. 31, FIGS. 32A and 32B, and FIGS. 33A to 33C show as if the black voltage during the black writing period “a” is generated using data read from the RAM in order to facilitate description. However, the embodiment is not limited thereto. It is also possible to apply the black voltage of a predetermined value, or black voltage corresponding to positive polarity/black voltage corresponding to negative polarity to the pixels 16 without reading out from the RAM. In this case as well, the black voltage performs temperature compensation. The voltage applied to the source signal lines S during the blank periods may be a voltage of a predetermined value, or a voltage corresponding to the positive polarity/voltage corresponding to the negative polarity applied to the source signal lines S without reading out from the RAM. In this case as well, the temperature compensation of the voltage is performed in this embodiment.

(7-5) Gamma Conversion

FIG. 34 and FIG. 35 are drawings showing configurations of a gamma curve generating circuit (gamma conversion circuit) of the video signals of this embodiment. The gamma curve generating circuit is formed in the gate source driver IC31 in this embodiment as described in conjunction with FIG. 3. The minimum value of the potential generated in the gamma curve generating circuit is 0V (GND potential), and the maximum value of the potential is 5V (the power voltage AVDD of the gate source driver IC31).

The output of the gamma conversion circuit is 6 bits (64 gradations). The output terminal V0 to V63 of the gamma conversion circuit corresponds to the gradation 1 to 64. The output stages of the respective source signals of the gate source driver IC31 select any one of the output terminals V0 to V63 on the basis of the input video signal data, and apply to the source signal lines S.

(7-5-1) Gamma Conversion Circuit 1

FIG. 34 is a gamma conversion circuit in the first embodiment in this embodiment. The low potential of the gamma curve is regulated by a gradation amplifier 351b. The high potential of the gamma curve is regulated by a gradation amplifier 351a. The voltage outputted from the gradation amplifier 351a is VOPH. The voltage outputted from the gradation amplifier 351b is VOPL.

There are two ladder resistances which generate the gamma curve for video signals of the positive polarity and for video signal of the negative polarity. The ladder resistance for the positive polarity can change the value of resistance from S1P to S9P by a command. The ladder resistance for the negative polarity can change the value of resistance from S1N to S9N by a command. An arbitrary gamma curve can be generated by changing the value of resistance from S1P to S9P and from S1N to S9N. The gamma curve can be differentiated between the positive polarity and the negative polarity.

By forming the gamma curve of the positive polarity and the gamma curve of the negative polarity symmetrically to equalize the amounts of displacement of the gradation amplifier 351a and the gradation amplifier 351b, the value of amplitude of the video signals can be changed with respect to center voltage Vcnt as the center (from FIG. 32A to FIG. 32B, from FIG. 33A to FIG. 33B).

The output voltages of the gradation amplifiers 351a and 351b are controlled by an amplitude adjusting resister 352. The output bit of the amplitude adjusting resister 352 is 6 bits. Therefore, the outputs of the gradation amplifiers 351a and 351b can be changed in 64 levels. By setting the value of the gradation amplifier 351a to a high value (high potential), the value of amplitude of the gamma curve is increased. By setting the value of the gradation amplifier 351a to a low value (low potential), the value of amplitude of the gamma curve is reduced.

In the same manner, by setting the value of the gradation amplifier 351b to a high value (high potential), the value of amplitude of the gamma curve is reduced. The value of the gradation amplifier 351b to a low value (low potential), the value of amplitude of the gamma curve is increased. The value of amplitude of the video signals can be changed by the output value of the gradation amplifiers 351a, 351b. Therefore, the adjustment of the amplitude described in conjunction with FIGS. 32A and 32B, and FIGS. 33A to 33C can easily be realized.

The gamma curve can also be changed freely by a command setting of the ladder resisters. In the configuration shown in FIG. 35, the gradation amplifier 351a and the gradation amplifier 351b can be operated independently. The set of the gradation amplifier 351a and the gradation amplifier 351b can be provided independently for red (R), green (G) and blue (B).

Preferably, the amounts of displacement of the gradation amplifier 351a and the gradation amplifier 351b are the same. Accordingly, the gradation amplifiers 351a and 351b can be controlled easily from the amplitude adjusting resister 352, because the control can be achieved by employing the same resister values for the gradation amplifier 351a and the gradation amplifier 351b and differentiating the direction of change (from AVDD to GND for the gradation amplifier 351a and from GND to AVDD for the gradation amplifier 351b). The potential of the gradation amplifier 351a is set from the AVDD voltage toward the lower voltage. The potential of the gradation amplifier 351b is set from the GND voltage toward the higher voltage.

Terminals are connected among the resistances (VR1P, VR2P, VR3P, VR4P . . . , VR1N, VR2N, VR3N, VR4N . . . ). The number of broken lines of the gamma curve is determined by the number of connections of the terminals and the number of divisions of the ladder resistances.

The values of resistance of the ladder resistances (VR1P, VR2P, VR3P, VR4P . . . , VR1N, VR2N, VR3N, VR4N . . . ) are configured to be the same on top and bottom. For example, VR1P and VPNP are the same resistance, and the VR1N and VPNN are the same resistance.

The values of resistance of the ladder resistances (VR1P, VR2P, VR3P, VR4P . . . VR1N, VR2N, VR3N, VR4N . . . ) can be changed by the command setting. The value of resistance is changed by the command.

The ladder resistances each include a plurality of resistances, and a switching circuit is added between the respective resistances. The change of the values of resistance of the ladder resistances is achieved by turning ON and OFF the switching circuits added to a resistance R. When all the switching circuits are turned ON (closed), the values of resistance of the ladder resistances become 0Ω. Therefore, the value of resistance of the VR1P is reduced as a whole. The value of resistance of the VR1P can be changed step by step by the number of short circuits of switches SW.

By performing the above-described operation for the resistances of the ladder resistances (VR1P, VR2P, VR3P, VR4P . . . , VR1N, VR2N, VR3N, VR4N . . . ), the voltage values of the respective terminals (V1 to VN) can be changed by the command setting.

The gradation voltages (V1 to VN) for the gradation levels can be changed by changing the values of the ladder resistances (VR1P, VR2P, VR3P, VR4P . . . , VR1N, VR2N, VR3N, VR4N . . . ), and various gamma curves can be generated corresponding to the characteristics of the liquid crystal layer 364.

The value of amplitude of the gamma curve can be changed as shown in the drawing by changing the values of the gradation amplifier 351a and the gradation amplifier 351b. When the output voltage VOPH of the gradation amplifier 351a and the output voltage VOPL of the gradation amplifier 351b are changed, the V2 to VN−1, which is the intermediate potential thereof, varies in proportion to the magnitude of the VOPH-VOPL. Therefore, although the value of amplitude of the gamma curve is changed, since the positions of the broken lines of the gamma curve change in proportion thereto, the shape of the gamma curve also is changed in proportion. This characteristic is an important advantage because the dependency on the temperature of the OCB liquid crystal can be compensated easily.

Selection circuits 353 are circuits (2 to 1) for selecting one contact point from the two contact points. For example, in FIG. 35, a selection circuit 353a selects one of a terminal a1 of the ladder resistance of the positive polarity and a terminal b1 of the ladder resistance of the negative polarity, and outputs to a terminal V2. The selection circuits 353 select any one of the contact points a (a1, a2, a3, . . . ) and the contact points b (b1, b2, b3, b4, . . . ). The voltage that the selection circuits 353 selects and is outputted to the terminals V (V2 to VN−1) is either one of the output of the ladder resistance of the positive polarity or the output of the ladder resistance of the negative polarity.

When the selection circuit 353 selects the contact point a, the polarity of the video signals that the source driver circuit 14 outputs to the source signal lines S is positive. When the selection circuit 353 selects the contact point b, the polarity of the video signals that the source driver circuit 14 outputs to the source signal lines S is negative.

For the OCB liquid crystal, it is necessary to reduce the amplitude of the video and reduce the augment by the common voltage when the panel temperature is high. In contrast, it is necessary to relatively increase the amplitude of the video and relatively increase the augment by the common voltage when the panel temperature is low.

For example, the temperature of the panel is low, an amplitude voltage Vcp of the common signals is increased. The image data to be applied to the liquid crystal layer 24 is increased by increasing the potential of the output voltage VOPH of the gradation amplifier 351a and decreasing the potential of the output voltage VOPL of the gradation amplifier 351b in FIG. 35. When the temperature of the panel is high, the image data to be applied to the liquid crystal layer 24 is reduced by reducing the amplitude voltage Vcp of the common signal, lowering the potential of the output voltage VOPH of the gradation amplifier 351a and increasing potential the output voltage VOPL of the gradation amplifier 351b in FIG. 35. As described above, setting and adjustment can be achieved freely corresponding to the dependency on the temperature of the liquid crystal layer 364.

(7-5-2) Gamma Conversion Circuit 2

FIG. 35 shows the gamma conversion circuit according to a second embodiment in this embodiment. In the following embodiment, points which are different from the first embodiment will mainly be described. The lower potential of the gamma curve is regulated by the gradation amplifier 351b. The high potential of the gamma curve (VOPH in the case of the video signal of the positive polarity and VONH in the case of the video signal of the negative polarity) is set by the gradation amplifier 351a. The low potential of the gamma curve (VOPL in the case of the video signal of the positive polarity and VONL in the case of the video signal of the negative polarity) is set by the gradation amplifier 351b.

In the configuration shown in FIG. 35, the ladder resistance which generates the gamma curve can be commonly used for the positive polarity and the negative polarity. Although the gamma resistance (the ladder resistance) is simplified in the drawing, it has the same configuration as the ladder resistance for the positive polarity or the negative polarity in FIG. 35. The respective resistances are represented by S1, S2, . . . , S9. The values of resistance from S1 to S9 can be changed by a command. By changing the values of resistances S1 to S9, desired gamma curves can be generated.

A number of taps are drawn from between the resistances of the ladder resistance. Taps V0, GAMP1, GAMP2, . . . GAMP62, V63 are drawn for the video signals of the positive polarity. The taps V0, GAMN1, GAMN2, . . . GAMN62, V63 are drawn as the video signals of the negative polarity. The taps V0 and V63 are common for the video signals of the positive polarity and the negative polarity.

In the case in which the video signals of the positive polarity are applied to the liquid crystal layer 364, the output of V0, GAMP1, GAMP2, . . . , GAMP62, V63 are selected by the selection circuit 353. When applying the video signals of the negative polarity to the liquid crystal layer 364, the output of V0, GAMN1, GAMN2, . . . , GAMN62, V63 are selected by the selection circuit 353.

In the embodiment shown in FIG. 34, there is only one ladder resistance. However, the same function and operation as the embodiment shown in FIG. 35 are achieved by selecting the taps GAMP1, GAMP2, . . . , GAMP62 in the case of the video signals of the positive polarity and selecting the taps GAMN1, GAMN2, . . . , GAMN62 in the case of the video signals of the negative polarity. By equalizing the amounts of displacement of the gradation amplifier 351a and the gradation amplifier 351b, the value of amplitude of the video signals can be changed easily with respect to the center voltage Vcnt as the center.

By setting the value of the gradation amplifier 351a to a high value (high potential), the value of amplitude of the gamma curve is increased. By setting the value of the gradation amplifier 351a to a low value (low potential), the value of amplitude of the gamma curve is reduced.

In the same manner, by setting the value of the gradation amplifier 351b to a high value (high potential), the value of amplitude of the gamma curve is reduced. By setting the value of the gradation amplifier 351b to a low value (low potential), the value of amplitude of the gamma curve is increased. The value of amplitude of the video signals can be changed by the output value of the gradation amplifier 351. Therefore, the adjustment of the amplitude described in conjunction with FIG. 32 and FIG. 33 can easily be achieved.

The gamma curve can also be changed freely by a command setting of the ladder resisters. In the configuration shown in FIG. 35, the gradation amplifier 351a and the gradation amplifier 351b can be operated independently. The set of the gradation amplifier 351a and the gradation amplifier 351b can be provided independently for red (R), green (G) and blue (B).

Since other configurations are the same as the embodiment shown in FIG. 35 (for example, the operation of the gradation amplifiers 351a and 351b and the direction of change, the temperature compensation, and so on), description will not be given again.

(7-6) Voltage Generating Circuit

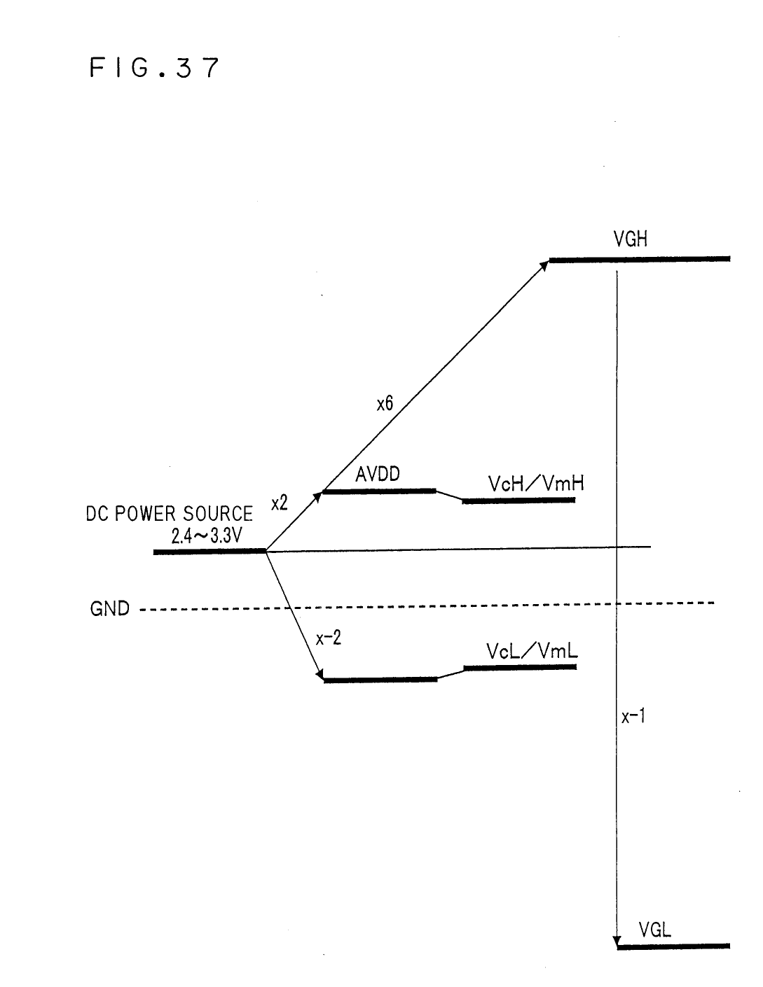

Referring now to FIG. 37, a voltage generating circuit will be described. The voltage of the DC power source (battery power source) is a power voltage of a range from 2.4 V to 3.3 V. This power voltage is increased. The voltage of the DC power source is regulated to a predetermined voltage by a regulator, and the regulated voltage is doubled to generate the AVDD voltage (the power source of the source driver unit of the gate source driver IC31). The VcH and VmH voltages are generated from the AVDD voltage. The voltage of the DC power source is regulated to a predetermined voltage by the regulator, and the regulated voltage is halved to generate the VcL and VmL voltage from the halved voltage.

The voltage AVDD is assumed to be 5.5V. The voltage of the DC power source is regulated to a predetermined voltage by the regulator, and the regulated voltage is multiplied by six to generate VGH voltage (the voltage on the high-voltage side of the gate driver unit of the gate source driver IC31). This voltage is assumed to be 15V. The VGL voltage (the voltage on the low-voltage side of the gate driver unit of the gate source driver IC31) is generated by inverting the VGH voltage. This voltage is assumed to be −15V. The voltage VGH is an ON voltage of the pixel switching devices Q of the pixels 16 and the voltage VGL is an OFF voltage of the pixel switching devices Q of the pixels 16. The ON voltage and the OFF voltage are applied to the gate signal lines G. In the common signal waveform, the voltage VGL corresponds to VmL=−15V, and the voltage VGH corresponds to VmH=15V. In the video signal, 5.5V=VOPH/VONH and GND=VOPL/VONL are established.

Hereinafter, in order to facilitate description, it is assumed that 0V is a ground (GND) voltage, 5.5V is a voltage of the source driver unit, 15V is a voltage on the high-voltage side of the gate driver unit, and −15V is a voltage on the low-voltage side of the gate driver unit. The voltages other than the GND voltage are generated in the gate source driver IC31.

(8) Transfer Operation of OCB Liquid Crystal

Referring now to FIG. 38, the transfer operation of the OCB liquid crystal display panel will be described. As described in conjunction with FIGS. 36A, 36B and 36C, in the OCB liquid crystal display device, in a state in which no voltage is applied between the pixel electrodes 23 disposed on the array substrate 15 and the opposed electrodes 362 disposed on the opposed substrate 361 arranged so as to oppose the array substrate 15, the liquid crystal molecules 365 of the liquid crystal layer assumes the spray alignment (FIG. 36A). Therefore, the liquid crystal molecules 365 are transferred to the bend alignment by applying a high voltage on the order of several tens of volts between the pixel electrodes 23 and the opposed electrodes 362 when the power source is turned on.

After having brought the liquid crystal molecules 365 into the bend alignment, the voltage equal to or higher than a low OFF voltage which can maintain the bend alignment is applied from the drive power source 366 to the liquid crystal molecules 365 as shown in FIG. 36B. The OFF voltage and an ON voltage which is higher than the OFF voltage are applied from the drive power source 366 between the pixel electrodes 23 as shown in FIG. 36C. By changing the drive voltage between the ON and OFF voltages, the bend alignment of the liquid crystal molecules 365 is changed from a state shown in FIG. 36B to a state shown in FIG. 36C to change the retardation value of the liquid crystal layer, so that the coefficient of transmission is controlled.

As described in conjunction with FIG. 37, AVDD voltage=5.5V, the VGH voltage=15V, and the VGL voltage=−15V are generated by the gate source driver IC31. These voltages are used for transferring the OCB liquid crystal display panel. Therefore, a specific voltage is not used as a voltage to be used for the transfer operation of the OCB liquid crystal display panel.

FIG. 38 shows a startup sequence of the OCB liquid crystal display panel in this embodiment. The gate voltage that the gate driver unit of the gate source driver IC31 is an ON voltage (VGH=15V) and an OFF voltage (VGL=15V) of the pixel switching devices Q of the pixels 16. The transfer voltage to be applied to the opposed electrodes 362 at the time of transfer is VGH on the high-voltage side and VGL on the low-voltage side. It is for reducing the number of voltages to be generated and reducing the cost by using the transfer voltage with the output voltage of the gate driver unit of the gate source driver IC31. Also, it is for easily performing the temperature compensation of the voltage to be used for transfer and temperature compensation for the transfer period.

In FIG. 38, the voltage signals to be applied to the opposed electrodes 362 within the range marked as the transfer movement period are the transfer signals. During the transfer operation period, the source driver unit of the gate source driver IC31 outputs the signals. The output waveform is shown in the column of “Source”. The voltage to be applied to the opposed electrode is shown in the column of “VCOM”. The voltages to be applied to the common electrodes C1 to Cm in FIG. 1 are shown in the column of VCS.

The voltage 5.5V is a maximum voltage which is generated in the source driver unit of the gate source driver IC31 and can be applied to the source signal lines S. Actually, it is the maximum voltages (VOPH, VONH) that an operational amplifier which uses the AVDD voltage as a power source can output. In this specification, although the maximum voltage is expressed as 5.5V as if it is fixed, actually it can be changed by the command setting by every 0.1V. By changing the voltage by this command setting, an optimum voltage can be applied to the source signal lines S at the time of transfer movement. The GND potential is the grounding potential of the circuit, this grounding potential can be used as the GND potential without generating the potential in the source driver unit. The voltage 5.5 is changed depending on the panel temperature. Also, it is set to an optimum value by the liquid crystal film thickness, an alignment film, or the liquid crystal material.

The voltage of 5.5V, the GND potential, 15V, and −15V are generated using a charge pump circuit (not shown) shown in FIG. 37. The generated voltage is selected using the analogue switch (not shown), and is applied to the source signal lines S, the VCS electrodes (VCS signal lines), and the opposed electrodes 362.

(8-1) Transfer Voltage

The voltage 15V is a maximum voltage which is generated at the gate driver unit of the gate source driver IC31, and can be applied to the gate signal lines G. Actually, it is the maximum voltage that the operational amplifier using the VGH voltage shown in FIG. 37 as a power source can output. During the normal display operation (image display operation), this voltage is used as an ON voltage for the gate signal lines G. During the transfer operation, this voltage 15V is applied to the opposed electrodes 362 and is used as the transfer voltage. In this specification, although the maximum voltage is expressed as 15V as if it is fixed, actually, it can be changed by the command setting by every 0.5V. By changing the voltage by this command setting, an optimum voltage can be applied to the source signal lines S at the time of transfer movement. Actually, the voltage 15V is changed with the panel temperature, and is set to an optimum value by the liquid crystal film thickness.

The voltage −15V is a minimum voltage that is generated at the gate driver unit of the gate source driver IC31, and can be applied to the gate signal lines G. Actually, it is the minimum voltage that the operational amplifier using the VGL voltage shown in FIG. 37 as a power source can output. During the normal display operation (image display operation), this voltage is used as an OFF voltage (when the transistors Q of the pixels 16 are N-channels) for the gate signal lines G. During the transfer operation, this voltage −15V is applied to the opposed electrodes 362 and is used as the transfer voltage. In this specification, although the maximum voltage is expressed as −15V as if it is fixed, actually, it can be changed by the command setting by every 0.5V. By changing the voltage by the command setting, an optimum voltage can be applied to the source signal lines S at the transfer operation. Actually, the voltage −15V is changed with the panel temperature, and is set to an optimum value by the liquid crystal film thickness.

(8-2) Transfer Sequence

The transfer operation (transfer sequence) includes operations in three divisions of A, B, and C (they are shown as A (A1, A2), B, C in the lowermost part in FIG. 38). The operations of A, B, and C are repeated a plurality of times as needed.

The operation performed during the period of A is an operation to increase the gate signal lines G to be selected in sequence. During the period of A (A1), one gate signal line G1 is selected. A voltage GND (minimum voltage) that the source driver unit of the gate source driver IC31 outputs is written to the pixel row connected to the selected gate signal line G1. In the subsequent period, the two gate signal lines G1, G2 are selected. The voltage GND (minimum voltage) that the source driver unit of the gate source driver IC31 outputs is written to the pixel rows connected to the selected gate signal lines G1 and G2. In the subsequent one horizontal scanning period, the three gate signal lines G1, G2 and G3 are selected. The voltage GND (minimum voltage) that the source driver unit of the gate source driver IC31 outputs is written to the pixel rows connected to the gate signal lines G1, G2 and G3.

As described above, when the number of selected gate signal lines is increased and the horizontal scanning period which corresponds to the number of pixel rows (internal H) has elapsed, all the gate signal lines are selected, and the voltage that the source signal lines output is written to all the pixels 16. As described above, the period in which all the pixel rows are selected after having increased the number of the pixel rows one by one is one frame period. However, since this one frame period is not a period for displaying the image, it is not necessary to be matched with the frame rate for displaying the image.

In the transfer operation, there are a transfer reset sequence, a transfer negative period, a transfer positive period, a transfer period from the transfer positive period to the transfer negative period as shown in the range indicated by an arrow in FIG. 38, and the transfer positive period and the transfer negative period are repeated. The number of times of repetition is changed by the panel temperature.

In this embodiment, the period A is not limited to one frame period. However, in order to facilitate description, the period A is defined as the one frame period, and the period B is defined as the one frame period. The period C is defined as one frame period×n (n is one or larger integer). The number n changes according to the transfer operation period. The transfer operation period changes also with the panel temperature. In particular, when the panel temperature is a low temperature, the transfer operation period is elongated. When it is a high temperature, the transfer operation period may be shortened.

The period A1 is a period in which the gate signal lines G are selected incrementally in sequence. The period A2 is a period in which the gate signal lines G are unselected decrementally in sequence. The period B is a period in which an OFF voltage is applied to all the gate signal lines G. The period C is a period in which one or a plurality of gate signal lines G are selected so as to display the image and the voltage applied to the source signal lines S is written to the pixels.

In the description of this embodiments, the number of the gate signal lines to be selected or unselected is one during the period A. However, the embodiment is not limited thereto, and may be a plurality of numbers of the gate signal lines. For example, in the period A, the gate signal lines G1, G2 are selected during the first horizontal scanning period, and the gate signal lines G1, G2, G3, G4 are selected during the subsequent horizontal scanning period. Then, during the subsequent horizontal scanning period, the gate signal lines G1, G2, G3, G4, G5, G6 are selected.

In the period A2, the gate signal lines G are unselected in sequence. In the first horizontal scanning period, the gate signal line G1 is unselected, and in the subsequent horizontal scanning period, the gate signal lines G1 and G2 are unselected. In the subsequent horizontal scanning period, the gate signal lines G1, G2 and G3 are unselected.

During the periods of A1 and A2, the operation may be performed as in the black writing period shown as drive “a” and the black writing period shown as drive “b”, or as in FIG. 25.

The matters shown above are applied also in the period C. In the subsequent horizontal scanning period, the gate signal lines G1 and G2 are selected. Then, in the subsequent horizontal scanning period, the gate signal lines G2 and G3 are selected. In the subsequent horizontal scanning period, the gate signal lines G3 and G4 are selected. During the subsequent one horizontal scanning period, G1 and G2 are selected. During the subsequent one horizontal scanning period, G3 and G4 are selected. During the further subsequent one horizontal scanning period, G5 and G6 are selected.

In the first period A (A1), the GND potential as a potential that the source signal lines S output is applied to the opposed electrodes 362. The voltage GND is also applied to the VCS. During the period B1, which is a subsequent period of the period A1, a state in which all the gate signal lines G are selected is maintained. The duration for maintaining this state is one frame. A voltage which is applied to the opposed electrodes 362 at any timing T during the period B1 is changed to the voltage VGL. The timing T represents the time from the beginning of the gate scanning. In other words, it is determined by counting from the positions of beginning of the respective A modes. The period to the timing T is a transfer reset sequence. With the provision of this period, generation of the liquid crystal molecules 365 which is not transferred is avoided. In the period B, all the gate signal lines G are selected (applied with an ON voltage).

Before the period A2, the voltage VCOM to be applied to the opposed electrodes 362 is changed to the voltage VGL (changed at the timing T).

In the subsequent period A2, all the selected gate signal lines G are unselected in sequence. In this period, the voltage GND is applied to the source signal lines S and VCS, and the voltage VGL is applied to the opposed electrodes 362. Therefore, a state in which the GND potential (a minimum output potential which the source driver unit can output to the source signal lines S), which is the output voltage from the source driver unit of the gate source driver IC31, is applied to all the pixels 16 of the display screen 20.

In the subsequent period C, one of the gate signal lines G is selected from the top to the bottom of the display screen 20 in sequence as in the state of the normal image display. The voltage 5.5V (a maximum output voltage) is outputted from the source driver unit of the gate source driver IC31, and is applied to the respective pixels 16. The operation described thus far is repeated during the period C by n times. Therefore, the period C=1F×n is established. The number of times of repetition is determined by the transfer time. The transfer time is changed with the panel temperature. When the panel temperature is low, the transfer time is elongated, and hence the value of n is increased. In the period C, the voltage VGL is applied to the opposed electrodes 362 and the voltage GND is applied to the VCS.

In the period C described above, the minimum voltage of −15 is applied to the opposed electrodes 362, and the voltage 5.5V (the maximum voltage that the source driver unit is outputted to the source signal lines S) is applied to the source signal lines S, so that a very high voltage is applied to the liquid crystal layer 362. The voltage −15V is a minimum voltage which is generated at the gate source driver IC, and can be applied to the opposed electrodes 362. Therefore, the OCB liquid crystal molecules 365 are desirably transferred. Since the voltage 5.5 V is applied to the source signal lines S and the voltage GND (the minimum voltage that the source driver unit can output) is applied to the VCS, a potential is generated between the VCS electrode (the signal line C in FIG. 1) and the source signal line S, so that the desirable transfer of the OCB liquid crystal molecules 365 is assisted.

In the subsequent period A1, the voltage GND (the minimum voltage of the source driver unit) is applied to the source signal lines S, and application of the voltage VGL and the GND voltage (the minimum voltage that the source driver unit is outputted to the source signal lines S) to the opposed electrodes 362 and the VCS respectively is continued. During the period A1, the selection voltage (ON voltage) is applied to all the gate signal lines G.

Although the voltage to be applied to the VCS is the GND voltage in the description, the voltage VGL=−15V may be applied if possible. That is, the phrase “to apply the GND voltage to the VCS” may be replaced with the phrase “to apply −15V to the VCS”.

In the subsequent period B, the voltage of 15V (the maximum voltage that the source driver unit is outputted to the source signal lines S) is applied to the VCS. The voltage to be applied to the opposed electrodes 362 is changed toward 15V. The voltage 15V is a maximum voltage which is generated at the gate source driver IC and can be applied to the opposed electrodes 362. The voltage GND is applied to the source signal lines S.

In this period B, the voltage to be applied to the opposed electrodes 362 may be abruptly changed from −15V to +15V. However, the voltage to be applied to the opposed electrodes 362 is abruptly changed, a stress is applied to the switching devices Q and hence luminescent spots and unlit spots may appear in the pixels 16.

In order to cope with this problem, in this embodiment, the voltage is changed from −15V, the GND voltage (the minimum voltage which the source driver unit can output to the source signal lines S), the voltage 5.5V (the maximum voltage that the source driver unit is outputted to the source signal lines S) to the voltage 15V step-by-step in the period B. The voltage used for the change is a voltage which is generated or used in the gate source driver IC31.

As described thus far, the voltage to be applied to the opposed electrodes 362 is changed stepwise via at least one or more voltages. In an embodiment in FIG. 38, the voltage applied to the opposed electrodes 362 via the GND voltage and the voltage 5.5V is changed from the minimum value to the maximum value.

Voltage holding periods t7, t8, which are passed through when the potential of the opposed electrodes 362 is changed, are adapted to be changeable. Taking a stress to be applied to the switching device Q, the holding periods of t7 and t8 are set to be the shortest possible period which can accept the stress. The holding periods of t7 and t8 are adapted to be manually or automatically changeable with the panel temperature. The periods t7 and t8 may also be set to 0.

In the subsequent period A2, all the gate signal lines G selected in the period B are unselected in sequence. The direction of unselecting operation is performed from the top to the bottom of the display screen 20. The gate signal lines G may be unselected by the combination of X_ODD and X_EVEN. That is, the pixel rows are unselected by two pixel rows each time during the period of 1 H. In this period, the voltage 15V is applied to the source signal lines S and the VCS, and the VGH voltage held on the opposed electrodes 362. The output voltage from the source driver unit is maintained at the GND potential (the minimum output potential that the source driver unit can output to the source signal lines S).

During the subsequent period C, one gate signal line G is selected downward one-by-one in sequence from the top of the display screen 20 as in the normal image display state. As shown as “DRIVE b” in FIG. 24, and in FIG. 25, and FIG. 26, the plurality of pixel rows may be selected simultaneously. The period C may be adapted to be set according to the panel temperature by the unit of frame. The GND potential is outputted from the source driver unit of the gate source driver IC31 and applied to the respective pixels 16.

In the period C described above, the maximum voltage of 15V is applied to the opposed electrodes 362, and the GND voltage (the minimum voltage which the source driver unit can output to the source signal lines S) is applied to the source signal lines S, so that a very high voltage is applied to the liquid crystal layer 362. Since the GND voltage is applied to the source signal lines S and the voltage 15V (the maximum voltage that the gate driver unit is outputted) to the VCS, a potential is generated between the VCS electrode (the signal line C in FIG. 1) and the source signal lines S, so that the desirable transfer of the OCB liquid crystal molecules 365 is assisted.

In the subsequent period A1, the voltage GND (the minimum voltage of the source driver unit) is continuously applied to the source signal lines S and the voltage VGH is continuously held at the opposed electrodes 362. The voltage 15V is also continuously applied to the VCS. During the period A1, the selection voltage (ON voltage) is applied to all the gate signal lines G.

In the subsequent B period, the voltage applied to the VCS is changed from 15V (the maximum voltage that the gate driver unit can output to the source signal lines S) to the GND potential. The voltage applied to the opposed electrodes 362 is changed toward −15V. In the B period, the voltage applied to the opposed electrodes 362 may be abruptly changed from 15V to −15V. However, when the voltage to be applied to the opposed electrodes 362 is abruptly changed, a stress is applied to the switching devices Q and hence luminescent spots and unlit spots may appear in the pixels 16.

In order to cope with this problem, in this embodiment, the voltage is changed from the voltage 15V to the GND (the minimum voltage that the gate driver unit can output to the source signal lines S), and then to the voltage −15 step-by-step during the period B. The voltage may further be changed from the voltage 15V, the voltage 5.5V, the GND voltage, to the voltage −15V. All the voltages used for change is voltages generated or used in the gate source driver IC31. As describe above, the voltage to be applied to the opposed electrodes 362 is changed stepwise via at least one or more voltages.

A holding period t9 for holding the voltages (the GND potential or 5.5V and the GND potential) passed through in the course of the change of the potential of the opposed electrodes 362 is adapted to be changeable as in the case of t7 and t8 described above. Considering the stress applied to the switching devices Q, the holding period t9 is set to a shortest possible time for allowing the stress. The holding period t9 is adapted to be changeable manually or automatically with the panel temperature. The holding period t9 can be set to zero as well.

The period from ts to te described above is a repeating period. The number of repetition of the repeating period (number of times of transfers Tn) is adapted to be changeable manually or automatically with the panel temperature. The voltage to be applied to the opposed electrodes 362 changes from the positive voltage (15V) to the negative voltage (−15V). That is, the voltage transfers from the positive period to the negative period. In the repeating period, positive and negative voltages are applied to the opposed electrodes 362 alternately. The number of times of the positive periods is the same as that of the negative periods. In the embodiment shown in FIG. 38, although the voltage to be applied to the opposed electrodes 362 is started from the negative voltage (−15V), it may also be started from the positive voltage (+15V).

After having performed the predetermined number of transfers, the procedure goes to the period A2. In the period A2, all the selected gate signal lines G are unselected in sequence. In this period, the voltage GND is applied to the source signal lines S and the VCS, and the voltage GND is applied to the opposed electrodes 362.

Subsequently, the display is transferred to the normal display state. In the normal display state, as described in conjunction with FIGS. 32A, 32B and FIGS. 33A, 33B and 33C, the VCS electrode is set to the GND potential, and the voltages corresponding to the video signals are applied to the source signal lines S. The same potential as the opposed electrodes 362 may be applied to the VCS electrode depending on the structure of the liquid crystal display panel. The voltages corresponding to the video signals are applied to the source signal lines S. The polarity of the common signals is inverted frame by frame and applied to the opposed electrodes 362.

(8-3) Transfer Holding Mode

In the OCB liquid crystal, it is necessary to perform a transfer sequence before displaying the image. In order to complete the transfer sequence described in conjunction with FIG. 38, duration as long as one second may be needed. When the power source is turned off after having displayed the OCB liquid crystal display device, it may need duration as long as one second may be needed to display the image next.

For example, when the OCB liquid crystal display device in this embodiment is used for a foldable mobile phone, once it is folded (the lid is closed), it is necessary to perform the transfer sequence also when the lid is opened next, and hence it is necessary to wait about one second until the image is displayed. In order to cope with this problem, a transfer holding mode is provided in this embodiment. The transfer holding mode will be described below.

FIG. 53 is a timing chart in the transfer holding mode. When the lid of the mobile phone is closed, the display state is switched from the display ON state to the black display. The black display means that the black image is displayed. Switching of the timing is performed synchronously with the internal V (internal vertical synchronous signals). With the black display, the reverse transfer can hardly occur. Subsequently, the transfer holding state is achieved.

The gate driver unit selects the gate signal lines G in the normal scanning state (the operation in the normal image display state). The pixel row is selected in sequence from the top to the bottom of the display screen one by one or by the unit of the plurality of pixel rows. It corresponds to the period C in FIG. 38. That is, the state of selection of the gate signal lines G in the transfer holing state is the same as the image display state.

In the transfer holding period, the maximum voltages (VOPH, VONH) and the minimum voltages (VOPL, VONL) are applied alternately to the source signal lines S frame by frame.

In the transfer holding period, the maximum voltage (VmH) and the minimum voltage (VmL) are applied alternately frame by frame to the opposed electrodes 362 and the VCS electrodes (VCS signal lines).

In the frame in which the maximum voltages (VOPH, VONH) are applied to the source signal lines S, the minimum voltage (VmL) is applied to the opposed electrodes 362 and the VCS electrodes (VCS signal lines). In the frame in which the minimum voltages (VOPL, VONL) are applied to the source signal lines S, the maximum voltage (VmH) is applied to the opposed electrodes 362 and the VCS electrodes (VCS signal lines). By applying the voltage in this manner, a higher voltage than the normal display is applied to the liquid crystal layer 362.

The black voltage drive prevents the reverse transfer to the spray alignment. In this embodiment, since the black voltage is applied to the entire surface of the display screen 20 during the black writing period “a”, a uniform voltage which is high irrespective of the image display can be applied. Therefore, the bend alignment can easily be maintained, and the reverse transfer does not occur. The configuration of the source driver unit of the gate source driver IC31 is also simplified, so that the power consumption can be reduced. With the configuration in such a manner that the black voltage is changed with the panel temperature, the bend alignment can be maintained desirably even in the low temperature area without occurrence of the gradation inversion, and hence a desirable image quality is achieved. Therefore, the reverse transfer to the spray alignment is avoided. Alternatively, the bend alignment can easily be maintained and the reverse transfer does not occur. The power consumption is also reduced.

The frequency of the internal V during the transfer holding period may be lowered in comparison with the normal display mode. It is because that the transfer state can be maintained even when the frequency is lowered. The frequency of the internal V can be set to a frequency close to the frequency at the time of normal display mode when the panel temperature is low, and can be lowered when the panel temperature is high. With a configuration in which the voltage to be applied to the liquid crystal layer and the internal V (frame frequency) are changed with the panel temperature, the bend alignment can be maintained desirably even in the low temperature area without occurrence of the gradation inversion, and hence a desirable image quality is achieved. The backlight is extinguished at the beginning of the black display or the beginning of the transfer holding.

The period of the transfer holding mode is set to a range from one second to 15 seconds. The transfer holding mode is maintained during this range even when the lid of the mobile phone is closed. Therefore, the transfer state is maintained at low power consumption. Within this period, the image display can be achieved without performing the transfer sequence shown in FIG. 38 by opening the lid.

(8-4) Restoration from Transfer Holding Mode

A restoration sequence from the transfer holding mode will be mainly shown in FIGS. 52A to 52C.

FIG. 52A is an explanatory drawing showing transfer from activation of the power source to the transfer holding sequence. A logic voltage of 1.8V is generated from the standby mode in the charge pump circuit. Subsequently, the OSC (the basic frequency) is generated to activate a DCDC converter. Then, the transfer sequence shown in FIG. 38 and, when the image display is not performed, the procedure goes to the transfer holding mode shown in FIG. 53.

FIG. 52B is an explanatory drawing showing a transfer from the transfer holding sequence to a display ON sequence. The mode is transferred from the transfer holding mode to the image display state. At this time, the black image is displayed. After having brought the screen into the black display (black raster display), the backlight is turned ON (BL_ON). Then, the image is displayed according to the input video signals.

FIG. 52C is an explanatory drawing showing a transfer from the activation of the power source to the display ON sequence. The logic voltage of 1.8V is generated from the standby mode in the charge pump circuit. Subsequently, the OSC (the basic frequency) is generated to activate the DCDC converter. Then, the transfer sequence shown in FIG. 38 is performed. Subsequently, after having brought the screen to the black display, the backlight is turned ON (BL_ON). Then, the image is displayed according to the input video signals.

(9) Temperature Compensation

The liquid crystal display panel has a dependency on the temperature. When the panel temperature is changed, the flicker is generated in association with the temperature change. It also causes lowering of the contrast. Particularly in the liquid crystal display panel employing the OCB liquid crystal, since the image is displayed by controlling birefringence, the dependency on the temperature appears significantly with the combination with the polarizing plate.

(9-1) Configuration of Temperature Control Circuit

FIG. 39 is a drawing showing a configuration of a temperature control circuit 393 which detects and compensates the panel temperature. A temperature detecting resister Rs (temperature sensor) 392 such as a thermistor is arranged in an area which is ineffective for the image display of the liquid crystal display panel. The temperature detecting resister Rs392 is connected in series with a resister R391 which has no dependency on the temperature. The voltage at an “a” terminal of the temperature detecting resister Rs392 is supplied to an A/D converter circuit 395 of 6-bit.

The A/D converter circuit 395 converts the voltage at the “a” terminal from analogue to digital to obtain digital data. The data converted to the digital data is converted by a temperature converting table 396 and is supplied to a logic circuit 397. The output of the A/D converter circuit 395 has an accuracy which changes one data every 2° C. The temperature converting table 396 interpolates 6-bit data corresponding to the characteristic of the liquid crystal display panel. The output of the temperature converting table 396 is 8-bit.

Temperature correction values are written in the EEPROM 394 at certain intervals (for example, every 16° C.). The logic circuit 397 performs processing to the data in the EEPROM 394 and the temperature data converted into the digital data by the A/D converter (output data from the temperature converting table 396), and interpolates the data read from the EEPROM 394 to obtain the interpolating values at corresponding temperatures.

The temperature control circuit 393 controls a black writing period control circuit 398 and the selection circuits 353 using the interpolated data. The temperature control circuit 393 controls a transfer time control circuit 399, a VCOM control circuit 400 for controlling the potential of the opposed electrodes 362, and a VREF control circuit 390 for controlling the amplitude of the video signals that the source driver unit outputs to the source signal lines S. The VREF control circuit 390 controls the gradation adjusting resister 352 and the gradation amplifier 351, and operates the values of VOPH/VONH and VOPL/VONL. The VREF control circuit 390 changes the gamma curve.

(9-2) Method of Temperature Compensation

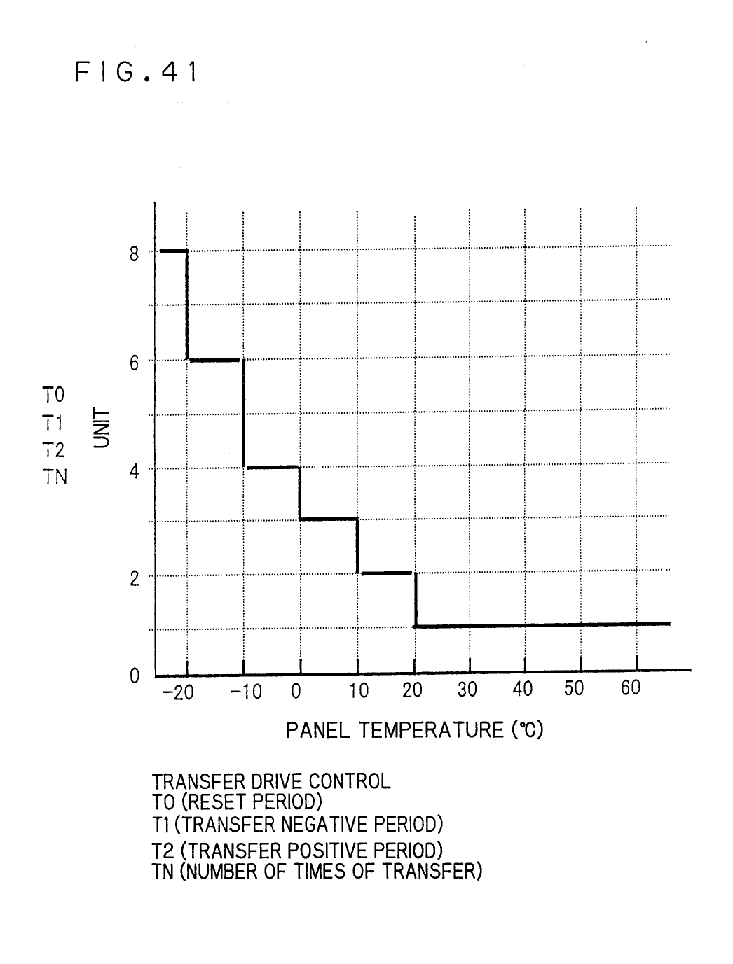

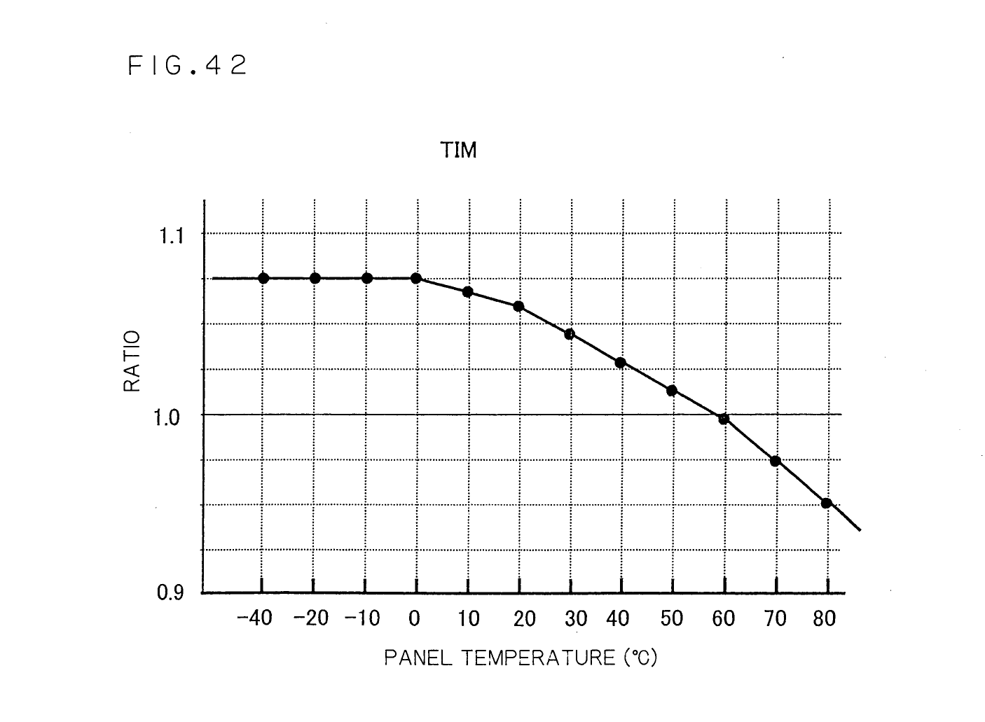

FIGS. 41, 42, 43 and 44 are explanatory drawings for explaining an example of temperature compensation. Referring now to the drawings, a method of temperature compensation according to this embodiment will be described. A method of temperature compensation shown in FIG. 41 relates to the transfer, and is a method of temperature compensation specific mainly to the OCB liquid crystal. Methods of temperature compensation shown in FIGS. 41 to 44 may be applied to a general liquid crystal display panel. In particular, desirable image display without generation of the flicker, change of contrast and change of luminance caused by the change of the panel temperature is achieved by combining these methods with a drive system in this embodiment described in conjunction with FIG. 4 and FIG. 5.

(9-2-1) Temperature Compensation of Transfer Operation

FIG. 41 is a method of temperature compensation of the transfer sequence described in conjunction with FIG. 38. The lateral axis in FIG. 41 represents the panel temperature (° C.). The vertical axis is a unit (ratio). For example, “2” on the vertical axis represents time or number of times which is “1” multiplied by “2”.

Reference sign T0 designates time (period) of the transfer reset sequence in FIG. 38. For example, at a temperature of 30° C., the unit is “1”. It is “8” at a temperature of −20° C. Therefore, at a temperature of −20° C., the time (period) of the transfer reset sequence is 8 times the period of the case at a temperature of 30° C.

Reference sign T1 designates a transfer negative period (time) in FIG. 38. For example, at a temperature of 30° C., the unit is “1”. At a temperature of −20° C., the unit is “8”. Therefore, at a temperature of −20° C., the transfer negative period (time) is 8 times the period of the case at a temperature of 30° C.

Reference sign T2 designates a transfer positive period (time) in FIG. 38. For example, at a temperature of 30° C., the unit is “1”. At a temperature of −20° C., the unit is “8”. Therefore, at a temperature of −20° C., the transfer positive period (time) is 8 times the period of the case at a temperature of 30° C.

Reference sign TN designates the number of times of the repeating period in FIG. 38. For example, at a temperature of 30° C., it is performed once. At a temperature of −20° C., the repeating range is repeated 8 times.

In description in conjunction with FIG. 41, the unit of the T0, T1, T2 and TN is common in order to facilitate description. The respective units of T0, T1, T2 and TN may be independent values. For example, at a temperature of 30° C., when the unit of T0 is “1”, the unit of T1 and T2 may be “2”. In this embodiment, although the unit of T0, T1 and T2 are common, the TN is adapted to have a significant dependency on the temperature. For example, at a temperature of 30° C., the unit of T0, T1 and T2 is “1”, and at a temperature of −20° C., the unit of T0, T1 and T2 is “2”. The unit of TN is “1” at a temperature of 30° C., and “8” at a temperature of −20° C.

As described above, by performing the temperature compensation in the transfer sequence, desirable transfer is achieved even when the panel temperature is low. The temperature compensation is also applied to the transfer holding mode in FIGS. 52A to 52C. It is applied to the transfer sequences in FIGS. 52A to 52C, and to a frame frequency in FIG. 53.

(9-2-2) Temperature Compensation of Black Writing Period “a”

TIM of the black writing period control circuit 398 adjusts the length of the black writing period. The response of the liquid crystal has a dependency on the temperature. A desirable black display is achieved by performing the temperature compensation. As shown in FIG. 30 and FIG. 31, the TIM is a period including a period in which writing of the black voltage into the pixels 16 is performed and a state of holding the writing of the black voltage (until the video writing period starts) combined to each other. The vertical axis represents a ratio.

For example, assuming that the ratio is 1.0 (standard) at a temperature of 60° C., the black writing period “a” at a temperature of 0° C. or lower is set to 1.075 times. The black writing period is reduced to 0.95× at a temperature of 80° C. The black writing period “a” is realized by setting the set value of the corresponding counter circuit by a command.

(9-2-3) Temperature Compensation of Voltages VmH and VmL

The potential difference Vs of the VCOM control circuit 400 is the potential difference of VmH−VcH and the potential difference of VcL−VmL. As shown in FIG. 28 and FIG. 50, the potential difference is Vs=VmH−VcH or Vs=VcL−VmL. However, the potential difference of VmH−VcH and the potential difference VcL−VmL may be differentiated. There may be a case that the flicker is reduced by differentiating these potential differences because the let-through voltage of the switching devices Q or the like generated in the pixels 16 is compensated.

The potential difference Vs is preferably in a range from 0V to 2.0V. The relation between the potential difference Vs and the temperature is shown in FIG. 43. The vertical axis represents the ratio.

The potential difference Vs is set to a minimum value at a temperature of −10° C. and is increased both at a higher temperature and at a lower temperature. That is, the value of Vs is increased with reference to a predetermined temperature when the temperature is higher than or lower than the reference temperature. For example, assuming that the potential difference Vs at a temperature of −10° C. is ratio 1.0 (reference), a Vs voltage of 1.07 times the reference is applied at a temperature of −40° C. At a temperature of 70° C., a Vs voltage of 1.15 times the reference is applied. In this manner, according to the embodiments of the invention, even when the characteristic is not linear with respect to the panel temperature, flexible temperature compensation is achieved by providing the table data shown in FIG. 41 to FIG. 44 in the EEPROM 394.

(9-2-4) Temperature Compensation of Video Signal Amplitude

The VREF control circuit 390 controls the gradation adjusting resister 352 and the gradation amplifier 351, and controls the values of VOPH/VONH and VOPL/VONL. With this operation, the value of amplitude of the video signals is changed and hence the voltage to be applied to the liquid crystal layer 362 is also changed. The amount of change is Vrd as shown in FIG. 44. The value Vrd for the positive video signals and the value Vrd for the negative video signals to be changed are the same amount of voltage.

A voltage to be applied to the liquid crystal layer is increased with decrease in temperature as an example. The voltage is reduced with increase of the panel temperature. The value Vrd is increased so as to be proportional to the temperature when the temperature is higher than a temperature of −10° C. At a temperature of 60° C., the value Vrd is reduced by about 10%. These operations are applied to the voltage to be applied to the liquid crystal layer during the black writing period and the video writing period.

(10) Black Voltage During Black Writing Period and Video Signals During Blank Period

The black voltage (black display signals) is written in the pixels 16 during the black writing period “a”. A predetermined voltage (holding voltage) is applied to the source signal lines S during the blank period. The blank signals which generates the black display signals and the holding voltages are applied to the liquid crystal display device in this embodiment as the video signals from the outside of the liquid crystal display device.

However, when the black display signals and the blank signals are applied from the outside as the video signals, it is necessary to access the internal RAM every time. The black display signals and the blank signals may be fixed values in most cases.

In this embodiment, as shown in FIG. 45, when starting up the liquid crystal display device, the data of the black display signals (black display data) and the data of the blank signals (blank data) are read from the EEPROM 394 are held in the internal RAM. The EEPROM 394 includes 6 bytes addresses of black display data corresponding to the red (R) pixels 16, black display data corresponding to the green (G) pixels 16, black display data corresponding to the blue (B) pixels 16, blank data corresponding to the red (R) pixels, blank data corresponding to the green (G) pixels and blank data corresponding to blue (B) pixels. The pixel arrangement is a stripe pixel arrangement.

The holding voltage is generated from the blank data. The holding voltage is a voltage to be applied to the source signal lines S in the video holding period. The holding voltage may be applied to the source signal lines S during the black voltage holding period of the black writing period “a” The blank data is converted by digital-analog conversion and also is converted in polarity into the voltage signals which are applied to the source signal lines S. The value of the blank data can be set freely by the command setting. The source signal lines S can be specified as a high impedance state.

FIG. 45 shows a data map of the internal RAM. The RAM area from the first pixel row to the 400^{th} pixel row, which is the maximum pixel row, is an area for holding the video signals applied from the outside. Reference sign 1-1R designates video data of a first (first row) red (R) pixel in the first pixel row. In the same manner, reference sign 1-1G designates video data of a first green (G) pixel in the first pixel row. Reference sign 2-1B designates video data of a first blue (B) pixel in the second pixel row. Reference sign 400-240G designates video data of 240^{th} green (G) pixel in the 400^{th} pixel row. Reference sign 400-120B designates video data of 120^{th} blue (B) pixel in the 400^{th} pixel row.

The display area of the liquid crystal display panel in this embodiment is assumed to have 400 pixel rows. Therefore, the RAM area for 400 pixel rows is sufficient when only the frame rate conversion of a fourfold speed is performed. In this case, the RAM capacity is 400 pixel rows×240 pixel columns×3 (RGB) bytes.

The internal RAM of the liquid crystal display device in this embodiment has a capacity for 402 pixel rows. It may be not suitable to express as the pixel rows. Since the 401^{st} pixel row stores the black display data, and the 402^{nd} pixel row stores the blank data, it is not a general idea of the pixel row. However, in order to facilitate description, it is expressed as a RAM in the 401^{st} pixel row and a RAM in the 402^{nd} pixel row. The respective pixel rows have 240 (RGB) bytes.

An area from 1 to 400 is an area for storing the image data for video display. The black display data is stored in the 401^{st} pixel row as shown in FIG. 45. The black display data is common for the respective pixel column. The blank data is stored in the 402^{nd} pixel row. The RAM area in the 401^{st} and 402^{nd} pixel rows is not an area for storing data showing the video signals.

Data preset to the EEPROM 394 in advance is read to the 401^{st} and 402^{nd} pixel rows when activating the liquid crystal display device, is held in the latch circuit of the gate source driver IC31, and then is stored in the RAM area in FIG. 45.

The black display data in the 401^{st} pixel row is read from the RAM during the black writing period “a”, and the voltage converted from the data is written into the pixels 16. The blank data in the 402^{nd} pixel row is read from the RAM during the blank period tp and the video holding period “c”, and the voltage converted from the blank data is applied to the respective source signal lines S.

In the 401^{st} pixel row, the different black display data for R, G and B are stored. However, a common value of the black display data may be employed for R, G and B. With such communization, the address area in the EEPROM 394 may be reduced. The logic area of the gate source driver IC31 may also be reduced.

The RGB data is 6 bits. When the black voltage is different among R, G and B nevertheless the communization of the RGB black display data is desired, the system in FIG. 46 may be employed. In FIG. 46, the larger the values of RK, GK, BK are, the larger the voltage to be applied to the liquid crystal layer becomes. In other words, when the value is 0, it is the minimum value and corresponds to the white display, and when the value is 63, it is the maximum value and corresponds to the black display. In FIG. 46, the black display data K of the 8 bits which is common for R, G and B is deployed to the black display data RK, GK and BK as shown in the drawing. The seven^{th} bit of K is coordinated with the 5^{th} to 1^{st} bits of the red black display data RK, the 5^{th} to 2^{nd} bits of the green black display data GK, and the 5^{th} and 4^{th} bits of the blue black display data BK. The 6^{th} bit of K is coordinated with the 0^{th} bit of the red black display data RK. The 5^{th} and 4^{th} bits of K are coordinated with the 1^{st} and 0^{th} bits of the green black display data GK, and the 3^{rd} to 0^{th} bits of K are coordinated with the 3^{rd} to 0^{th} bits of the blue black display data BK. As described above, by coordinating the common K data for R, G and B stored in the EEPROM 394 with the RK, GK and BK, the desirable black display independent for R, G and B is realized. By the employment of the similar processing or the method for the blank data, the blank data independent for R, G and B (RB, GB, BB) can be generated from one byte data.

As described above, in the embodiment shown in FIG. 46, a bit common for a plurality of colors (for example, two or three colors of R, G and B) is provided in data having the number of bits of a predetermined length. There are also provided bits independent for each color (for example, R or G or B).

Needless to say, the matters described above can be applied to the blank data described in conjunction with FIG. 45. There are provided a common bit for a plurality of colors (for example, two or three colors from among R, G, and B) in the number of bits of a predetermined length. There are also provided bits independent for each color (for example, R or G or B).

The black display data (RK, GK, BK) and the blank data (RB, GB, BB) are changed corresponding to the panel temperature as described in conjunction with FIG. 39 and FIG. 41 to FIG. 44. The change can be accommodated easily by adding or subtracting the black display data and the blank data.

(11) Driving Method of Reflective and Transflective Display Panel

In the part (b) in FIG. 28 and FIGS. 33A, 33B and 33C, the common signals VmH, VcH, VmL and VcL are changed to apply to the opposed electrodes 362, and the polarity of the video signal is switched before starting the video writing period “b”, so that a high voltage is applied during the black writing period “a”. By the application of the high voltage, a desirable black display is achieved, and the reverse transfer can be prevented in the OCB liquid crystal.

In the case of the voltage-coefficient of transmission characteristic as shown in FIG. 27, the coefficient of transmission is lowered with increase of the voltage applied to the liquid crystal layer. However in the case of the voltage-coefficient of transmission characteristic as shown in FIG. 47, the coefficient of transmission demonstrate the minimum value at the voltage V2. When a high voltage V1 which is higher than the voltage V2 is applied to the liquid crystal layer, the coefficient of transmission of the pixels 16 is increased and the contrast is lowered. In the drive system shown in FIG. 4, in a case in which the liquid crystal display panel is a transmissive type, lowering of the contrast is avoided even though the V1 voltage is applied according to the characteristic shown in FIG. 47 by extinguishing the backlight 18 during the black writing period “a”, because the backlight 18 is extinguished and hence the image display is not visually recognized.

In the reflective and transflective liquid crystal display panel, even though the backlight 18 is extinguished, the image can be recognized by the outside light. Therefore, as long as the V1 voltage is applied according to the characteristic in FIG. 47, the display contrast in the black writing period “a” is lowered. In addition, the image written into the pixels 16 during the video writing period “b” is recognized.

In the description given below, the display panel is explained as the transflective type. However, the drive system in this embodiment is also applied to the reflective type.

In the case of the liquid crystal characteristic as shown in FIG. 47, when a voltage V1 which is higher than an optimum value is applied during the black writing period “a”, the coefficient of transmission T1 is increased, and the display contrast is lowered. In the case of the transflective liquid crystal display panel, the backlight 18 is not illuminated during the black writing period “a”. However, even when the backlight 18 is not illuminated, when the voltage V1 is applied, the state of the coefficient of transmission of the pixels is visually recognized by the outside light. Therefore, in the case of the transflective liquid crystal display panel, there is a limit in voltage to be applied to the liquid crystal layer 364 during the black writing period.

In the case in which the same voltage V1 is applied, the coefficients of transmission depend on colors of R, G, and B. Therefore, the voltages to be applied to the liquid crystal layer 364 are preferably differentiated depending on colors R, G and B. For example, the black voltage during the black writing period “a” is set to be the highest in R and the lowest in B. This demonstrates an effect specifically when the OCB liquid crystal display panel is used in the transflective mode. The black voltage is changed or adjusted by the panel temperature. Such adjustment or change is performed using the temperature control circuit 393 in FIG. 39.

Needless to say, the drive system and configuration described thus far may be applied to the transflective and reflective liquid crystal display panels as well. The transflective and reflective liquid crystal display panels will be described, mainly about specific matters below. As regards other matters which will not be described below, the embodiments shown above will be applied. Needless to say, the following embodiment and the embodiments described above may be combined to each other. In contrast, the matters described in conjunction with the transflective and reflective liquid crystal display panel may be applied to the embodiments described above as a matter of course. Matters described in this specification may be combined to each other and part of them in one embodiment may be diverted to another embodiment even though the combined embodiment is not shown here. The combined embodiment is also included in the technical scope of the invention.

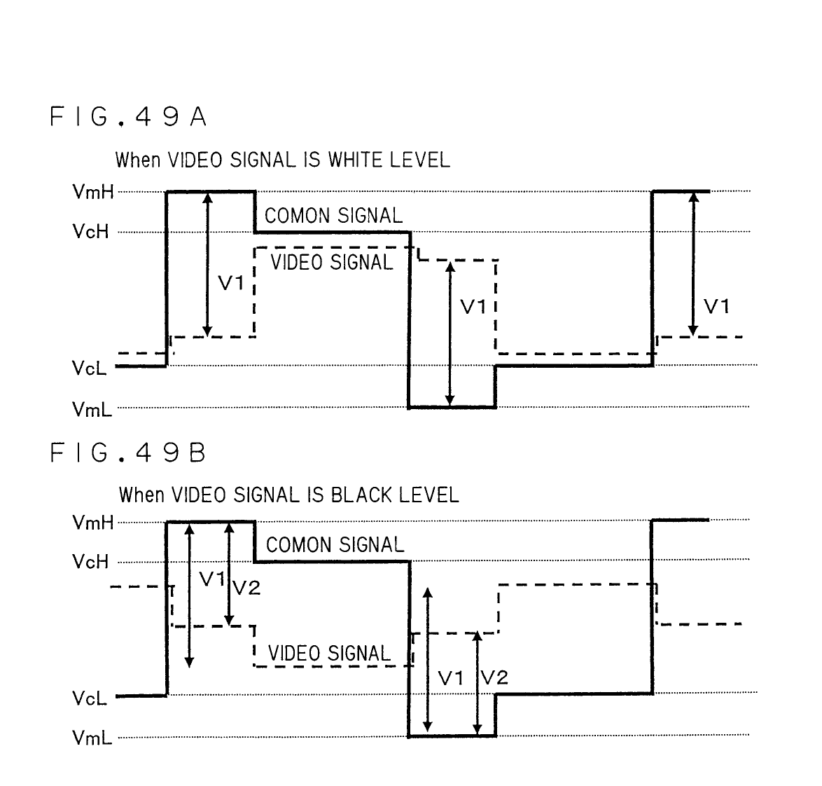

FIGS. 49A and 49B are explanatory drawings showing a driving method of the transflective liquid crystal display panel in this embodiment. FIG. 49A shows a state in which the video signals are in the white level (the video signals to be written during the video writing period “b” are white signals). FIG. 49B shows a state in which the video signals are in the black level (the video signals to be written during the video writing period “b” are black signals). In order to facilitate understanding, the characteristic shown in FIG. 47 is employed as the voltage-coefficient of transmission characteristic of the liquid crystal display panel, in which the coefficient of transmission demonstrates the minimum value at V2 and the coefficient of transmission is deteriorated at V1.

(11-1) When Image Display of Pixels is White Display

FIG. 49A shows a case in which the display of the pixels 16 is white display. Basically, in the transflective liquid crystal display panel, the voltages to be applied during the black writing period “a” are differentiated from pixel 16 to pixel 16. However, it is also possible to obtain an average level in one screen, and equalize the voltages to be applied during the black writing period “a” in the display screen 20.

In FIG. 49A, the voltage V1 is applied during the black writing period “a”. Therefore, in the black writing period “a”, the contrast is lowered. However, since the white image (voltage) is written into the corresponding pixels 16 during the video writing period “b” write after, the lowering of the contrast does not work against the display. In the case of the OCB liquid crystal, the higher the voltage to be applied during the black writing period “a”, the lower the possibility of occurrence of reverse transfer and hence the desirable image display is achieved. Therefore, even when the voltage to be applied to the liquid crystal layer during the video writing period “b” is low, the reverse transfer does not occur.

(11-2) When Image Display of Pixels is Black Display

FIG. 49B shows a case in which the display of the pixels 16 is black display. In FIG. 49B, the voltage V2 is applied during the black writing period “a”. Therefore, the coefficient of transmission of the pixels 16 demonstrates the lowest value during the black writing period “a”. Consequently, the desirable contrast is achieved. Since the black image (voltage) is written into the corresponding pixels 16 during the video writing period “b” write after, if the contrast is lowered during the black writing period “a”, the quality of image display is lowered. In the case of the OCB liquid crystal, the voltage to be applied during the black writing period “a” is lowered in comparison with FIG. 49A, and the reverse transfer may occur. However, since the black voltage as the video is written during the video writing period “b”, even though the voltage during the black writing period is rather low, a sufficient voltage which can avoid occurrence the reverse transfer to the pixels 16 is applied in the one frame period.

As described above, in this embodiment, the voltage to be applied to the pixels 16 during the black writing period “a” is determined corresponding to the video signal (source signals) to be written into the pixels 16 during the video writing period (video holding period). In this operation, the transflective (reflective) liquid crystal display panel which can achieve a desirable contrast is provided. In particular, in the case of the OCB liquid crystal display panel, a desirable image display is achieved without occurrence of the reverse transfer.

(11-3) Video Signals and Black Voltage of Transflective Liquid Crystal Display Panel

In the case of the OCB liquid crystal, it is necessary to apply the voltage of a predetermined effective value to the liquid crystal layer in the one frame period in order to prevent the reverse transfer. However, when an excessively high voltage is applied during the black writing period “a”, the lowering of the display contrast of the transflective (reflective) liquid crystal display panel may be resulted. In order to cope with this problem, as described in FIG. 49A, when the effective value of the voltage to be applied to the liquid crystal layer during the video writing period “b”, a high voltage is applied during the black writing period “a”. Although lowering of the contrast may occur in the black writing period, it is insignificant since the image display is white display. In terms of the entire part of one frame, the effective voltage is applied sufficiently to the liquid crystal layers of the pixels 16, so that there is no possibility of occurrence of the reverse transfer.

In a case in which the video signals to be written into the pixels 16 is the black voltage, when a high voltage is applied during the black writing period “a”, lowering of the contrast is obvious. Therefore, as described in conjunction with FIG. 49B, the voltage to be applied to the pixels 16 during the black writing period “a” is a voltage of an optimum effective value at which the minimum coefficient of transmission is achieved. The effective value of the voltage to be applied to the liquid crystal layer during the video writing period “b” is sufficient as a level which does not cause the reverse transfer since the video signals are the black voltage. In terms of the entire part of one frame, since a sufficient effective voltage is applied to the liquid crystal layers of the pixels 16, the reverse transfer does not occur. The lowering of contrast does not occur.

Accordingly, application of the sufficient effective voltage during one frame period is essential in the transflective liquid crystal display panel.

(11-3-1) Detailed Examples of Driving Method

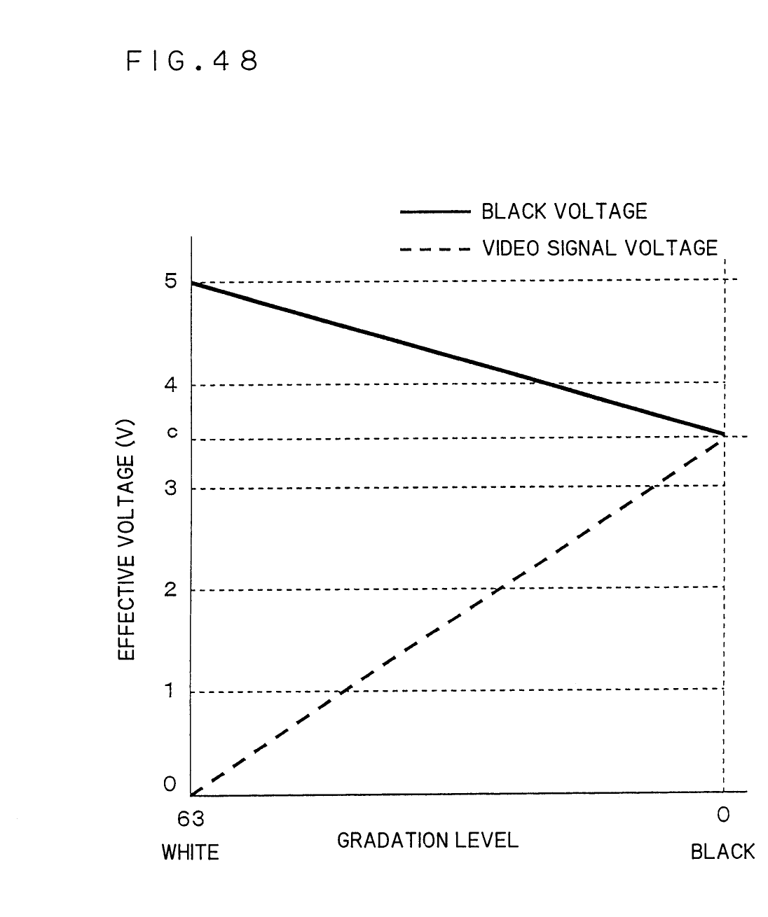

FIG. 48 is an explanatory drawing of the driving method in this embodiment. In FIG. 48, the lateral axis represents the gradation level. The gradation 63 is the white display, and corresponds to the maximum gradation. The gradation 0 is the black display, and corresponds to the minimum gradation. The liquid crystal mode is a normal white (NW) mode. The lower the voltage to be applied to the liquid crystal layer 362 is, the higher the coefficient of transmission of the liquid crystal layers (pixels) becomes, and the higher the voltage to be applied to the liquid crystal layer is, the lower the coefficient of transmission of the liquid crystal layers (pixels) becomes. The vertical axis represents the effective voltage to be applied to the liquid crystal layer 364. In the case in which the display mode of the liquid crystal display panel is the normally black (NB), the gradation 0 and the gradation 63 on the lateral axis are inverted. The drive system in this embodiment may be applied to both liquid crystal display mode, NW and NB.

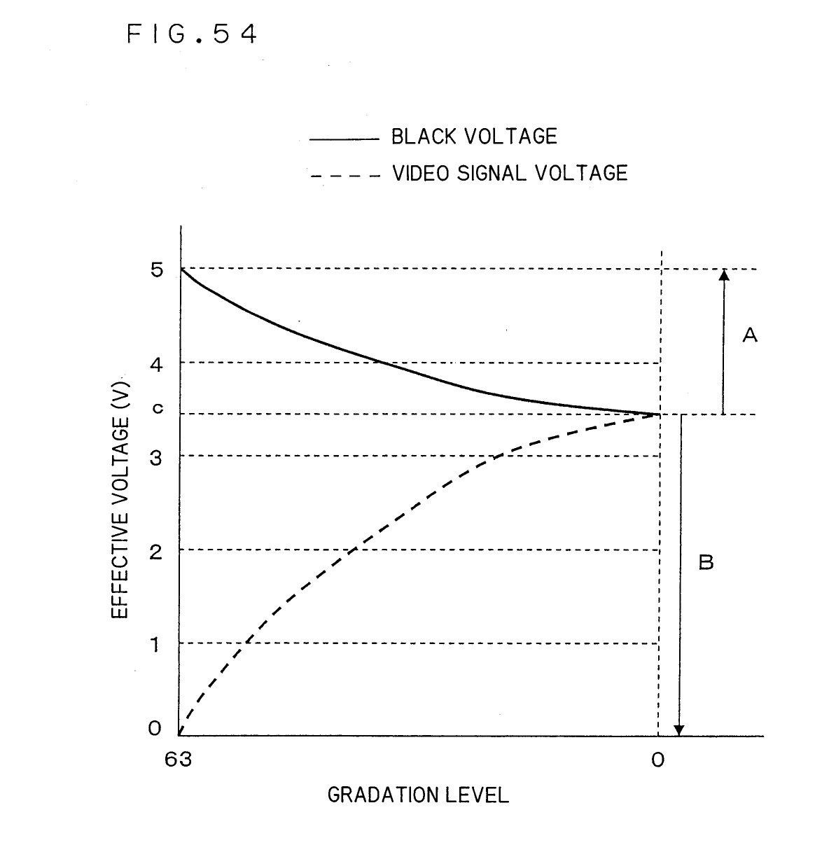

In FIG. 48, FIG. 54 to FIG. 60 described below, the gamma conversion and the startup voltage are not applied in order to facilitate description. That is, they are explanatory drawings for understanding the embodiment of the invention. For example, the coefficient of transmission is little changed by applying the voltage lower than 1.0V to the liquid crystal layer 364. However, FIG. 48 shows as if the coefficient of transmission changed from 0V. Originally, it is necessary to consider the gamma conversion when drawing the graph. However, when the general idea of the gamma conversion is reflected in the graph, it would be difficult to understand. Since the gamma conversion is easy for those skilled in the art, description or drawing is omitted.

In FIG. 48, the gradation 63 is a gradation of a maximum luminance (white), and the gradation 0 is a gradation of the minimum luminance (black). Since the liquid crystal display panel is normally white mode, the smaller the gradation number is, the higher the voltage to be applied to the liquid crystal layer 364 becomes. The gradation 0 is a voltage which realizes the minimum luminance, and the gradation 63 is a voltage which realizes the maximum luminance (at the time of NW mode). At the gradation 63, the effective value to be applied to the liquid crystal layer 364 is small.

In FIG. 48, a solid line represents a voltage to be written into the pixels 16 during the black writing period “a”. In the gradation 0, the same voltage as the voltage to be written into the pixel 16 during the video writing period “b” is employed. At the gradation 63, the maximum 5V is applied. In this manner, the reason why a higher voltage is applied during the black writing period “a” as the gradation is increased toward the gradation 63 is because the video signal voltage to be applied during the video writing period “b” is low. In the OCB liquid crystal, when a state in which the voltage to be written into the pixels 16 is low is continued, the bend alignment cannot be maintained. Therefore, application of the high voltage during the black writing period “a” is effective for maintaining the bend alignment.

When the coefficient of transmission of the pixel 16 is low as the gradation 0, the coefficient of transmission is increased by applying a high voltage Va during the black writing period “a” and the display contrast is lowered. When a voltage to be applied to the liquid crystal layer 364 like the gradation 0, the bend alignment can be maintained, and hence it is not necessary to apply a high voltage during the black writing period “a”.

In FIG. 48, at gradation 63, the voltage is 0V and at the gradation 0, the voltage is cV during the video writing period “b”. During the black writing period “a”, at the gradation 63, the voltage is 5v and at the gradation 0, the voltage is cV.

It is assumed that c=3.5V as an example. The value of “c” is set to a suitable value by the liquid crystal mode or the film thickness of the liquid crystal layer 364. Alternatively, it is changed by the panel temperature.

During the black writing period “a”, the larger the number of gradation is, the higher the effective voltage to be applied to the pixels is set. The smaller the gradation number is, the lower the effective voltage to be applied to the pixels. In the embodiment shown in FIG. 48, the effective voltage is 3.5V at the gradation number 0 and 5.0V at the gradation number 63. In this manner, the effective value to be applied to the liquid crystal layer 364 is lowered during the black writing period “a” corresponding to the gradation number.

During the video writing period “b”, voltages corresponding to the video signals are applied to the respective pixels. At the gradation 0, the effective voltage to be applied to the liquid crystal layer 364 is high, and at the gradation 63, the effective voltage to be applied to the liquid crystal layer 364 is low. The effective voltage is 3.5V at the gradation number 0 and 0.0V at the gradation number 63.

At the gradation number 0, a voltage of 5V is applied during the black writing period “a”. A voltage of 0V is applied to the pixels during the video writing period “b”. At the gradation number 63, a voltage of 3.5V is applied to the pixels during the black writing period “a”. A voltage to be applied to the pixels is 3.5V during the video writing period “b”. That is, in a certain pixel, the black voltage (video signals) to be applied to the pixels during the black writing period “a” is changed corresponding to the voltage (video signals) to be applied to the pixels during the video writing period “b”. The voltage (video signals) to be applied during the black writing period “a” is determined by the voltage (video signals) to be written into the video writing period “b”.

As described above, it is a characteristic of this embodiment to apply the black voltage during the black writing period “a” and the video signal voltage during the video writing period “b” having a correlation with respect to each other. The black voltage is a voltage equal to or higher than the video signals. When the video signal voltage is low, the black voltage is increased. When the video signal voltage is high, the black voltage may be relatively low.

In the black writing period “a”, in the case of the liquid crystal characteristics shown in FIG. 47, the coefficient of transmission increases when a voltage higher than a certain level (V1) is applied. Therefore, in the case of the reflective or transflective liquid crystal display panel, the display contrast is lowered by the influence of the outside light. In particular, when the video signal to be applied during the video writing period “b” is the black voltage, lowering of the display contrast is obvious in many cases. At the gradation number 0, it is preferable to set V2=3.5V, so that the minimum coefficient of transmission is achieved. When the V2 is 3.5V during the black writing period “a” and 3.5V during the video writing period “b”, this pixel realizes a desirable black display.

At the gradation number 63, when a voltage of V1=5.0V is applied during the black writing period “a”, the coefficient of transmission is lowered to T1. During the video writing period “b”, a voltage of 0V of the white display is applied to the corresponding pixel. In this pixel, the contrast is lowered during the black writing period “a”. However, during the video writing period “b”, since it is the white display, the lowering of the contrast is insignificant.

In this manner, the magnitude of the black voltage to be applied to an arbitrary pixel during the black writing period “a” is determined by the magnitude of the video signals (the gradation number of the video signals) to be applied to the pixel during the video writing period “b”.

In particular, the example shown in FIG. 48 is effective for the reflective or transflective OCB liquid crystal display device. In the OCB liquid crystal, when the effective value of the voltage to be applied to the liquid crystal layer is lower, the reverse transfer occurs. For example, when the voltage to be applied to the liquid crystal layer 364 at the gradation number 63 is 0V, the reverse transfer occurs. In this case, the reverse transfer is restrained by applying a high voltage (black voltage) during the black writing period “a”. In the embodiment shown in FIG. 48, at the gradation number 63, since the voltage of 5.0V is applied during the black writing period “a”, the reverse transfer is prevented.

When the effective value of the voltage to be applied to the liquid crystal layer is high, the reverse transfer does not occur. For example, when the voltage to be applied to the liquid crystal layer 364 at the gradation number 0 is 3.5V, the reverse transfer does not occur. In this case, the effective value of the voltage to be applied during the black writing period “a” may be small. In contrast, when an excessively high voltage (V1) is applied, the coefficient of transmission becomes T1 and the contrast is lowered. In the embodiment shown in FIG. 48, a voltage of V2=3.5V which is the highest in contrast is applied during the black writing period “a”. In this manner, a certain relation is provided between the video signal voltage and the black voltage. For example, a configuration which satisfies the magnitude of the video signal voltage (the effective voltage to be applied to the liquid crystal layers in the respective pixels during the video writing period “b”)+the magnitude of the black voltage (effective voltage to be applied to the liquid crystal layers of the respective pixels during the black writing period “a”)=predetermined effective voltage Vt may be employed. Relating to generation of the black voltage, it is also applicable to multiply the effective voltage to be applied to the liquid crystal layers of the respective pixels during the video writing period “b” by a certain ratio. Alternatively, it is also applicable to add or subtract from the video signals or the video signal data. By computing with a computing expression of a certain relation, the black voltage or the black voltage data (the effective voltage to be applied to the liquid crystal layers of the respective pixels during the black writing period “a”) may be obtained.

Preferably, the liquid crystal display device is configured so that the predetermined effective voltage Vt can be changed or adjusted by the panel temperature. The predetermined effective voltage Vt is increased when the panel temperature is low, and is lowered when the panel temperature is high. It is also preferable to change a c voltage to be applied to the pixels 16, for example, in FIG. 48 according to the panel temperature. The voltage c is lowered when the panel temperature is high, and is increased when the panel temperature is low. The solid line and the dotted line are also moved (changed) with the change of the c voltage. The voltages c depend on the colors R, G, and B. Therefore, it is preferable to set the different c voltages for R, G, and B, so that the voltage c of the R, G and B can be changed or adjusted commonly or independently with the panel temperature.

In the embodiment shown above, the black voltage to be applied to the pixels during the black writing period “a” is determined for the respective pixels. However, the black voltage is not limited to be determined in the respective pixels. It is also possible to obtain one black voltage from an average value of the video signals of the display area of the display screen 20 or from the pedestal level of the video signals, and apply the same to all the pixels. Alternatively, it is possible to obtain one black voltage corresponding to one pixel row from the average value of the video signals to be applied to one pixel row or from the pedestal level of the video signals, and apply the same to the one pixel row. Alternatively, it is possible to divide the display screen 20 into a plurality of divisions during the video writing period “b”, obtain one black voltage corresponding to the pixels in the division from the average value of the video signals to be applied to the pixels in the divided division or from the pedestal level of the video signals, and apply the same to the pixels in the division. In this manner, the black voltage corresponding to the respective pixels or a plurality of pixels is obtained from the video signals applied to the liquid crystal display device and the obtained black voltage is applied during the black writing period “a”.

The black voltage may be obtained with a delay of one frame or more. For example, it is possible to obtain the black voltage to be applied to the pixels in the first frame (the black voltage corresponding to the respective pixels or the plurality of pixels) from the video signals or the like, and apply the obtained black voltage to the respective pixels during the black writing period “a” in the second frame, which is the subsequent frame of the first frame.

The black voltage may be obtained not only from the video signals (the video signals before or after the gamma processing), but also from the average coefficient of transmission in the display area. The black voltage is determined by adding the brightness of the outside light (the environmental lighting intensity of the panel). It is also possible to determine the black voltage from a certain data bit such as higher one bit of the video signals.

The matters and content described in the example shown above may be applied to other examples in the embodiment, which will be described in conjunction with FIG. 54 to FIG. 60. Other examples and the content described in conjunction with FIG. 48 may be combined to each other.

(11-3-2) Modification 1

FIG. 54 shows an embodiment in which the voltage to be written into the pixels 16 during the video writing period “b” (dotted line) and the voltage to be applied to the pixels 16 during the black writing period “a” (solid line) demonstrate curves with respect to the gradation. As described above, the black voltage or the video signal voltage with respect to the gradation can be changed or adjusted easily. The values of a voltage A and a voltage B are changed or modified to optimum values. The ratio between the voltage A and the voltage B is adjusted by a certain relation to obtain optimum values. The value of “c” is set to a suitable value by the liquid crystal mode or the film thickness of the liquid crystal layer 364. Alternatively, it is changed by the panel temperature.

(11-3-3) Modification 2

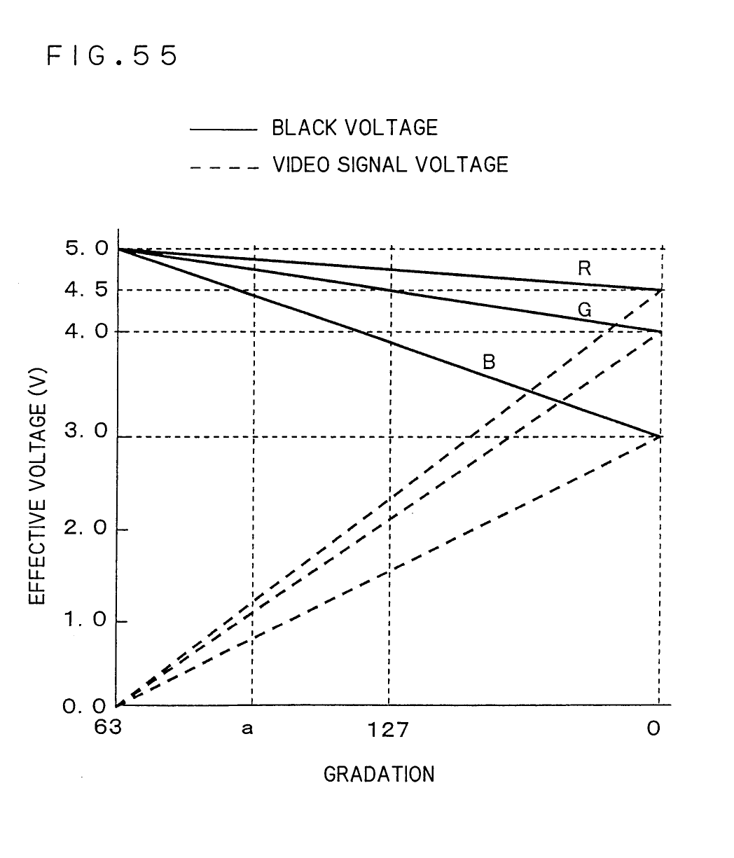

FIG. 55 shows an embodiment in which the black voltage or the video signal voltage with respect to the gradation number are changed corresponding to the colors R, G, and B. It is set to a suitable value by coordinating the black voltage to be applied to the liquid crystal layer during the black writing period “a” and the video signal voltage to be applied to the liquid crystal layer during the video writing period “b” with the gradation number. Display at a desirable contrast is realized by changing at least one of the black voltage or the video signal voltage by the colors R, G and B.

(11-3-4) Modification 3

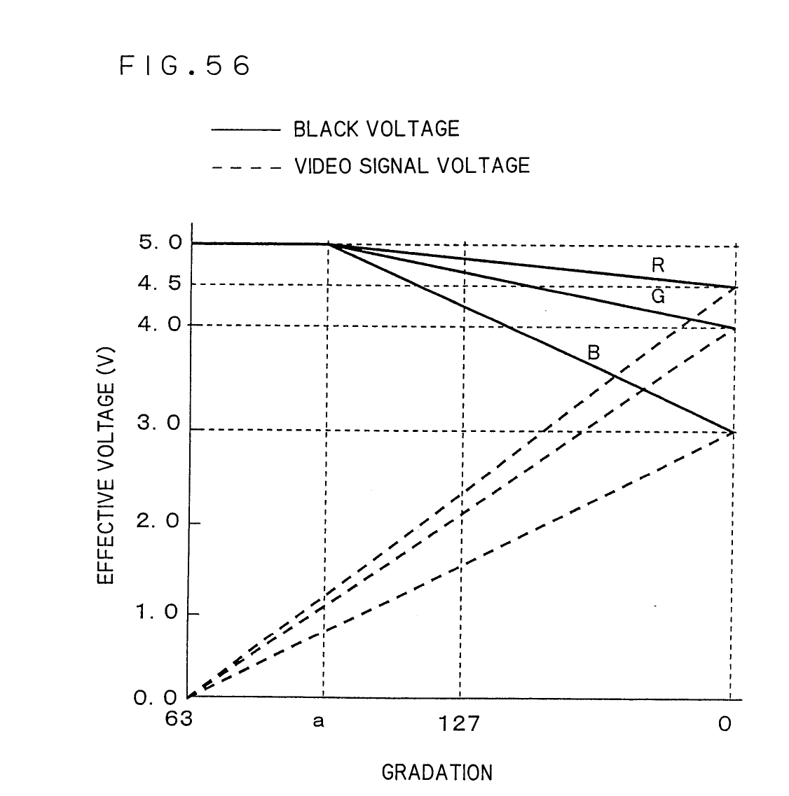

FIG. 56 shows an embodiment in which the black voltage to be applied to the liquid crystal layer 364 of R, G, and B is equalized with a gradation number larger than the gradation number “a”. The value of “a” can be changed or adjusted by the panel temperature. In the range larger than the gradation “a”, the magnitude of the black voltage to be applied to the liquid crystal layer during the black writing period “a” is defined as a predetermined value (fixed value). It may be constant for R, G and B. In the configuration shown in FIG. 56, the configuration of the circuit and the control method are simplified. The predetermined value (fixed value) may be set adequately by the liquid crystal mode or the film thickness of the liquid crystal layer 364. Alternatively, it is changed by the panel temperature.

(11-3-5) Modification 4

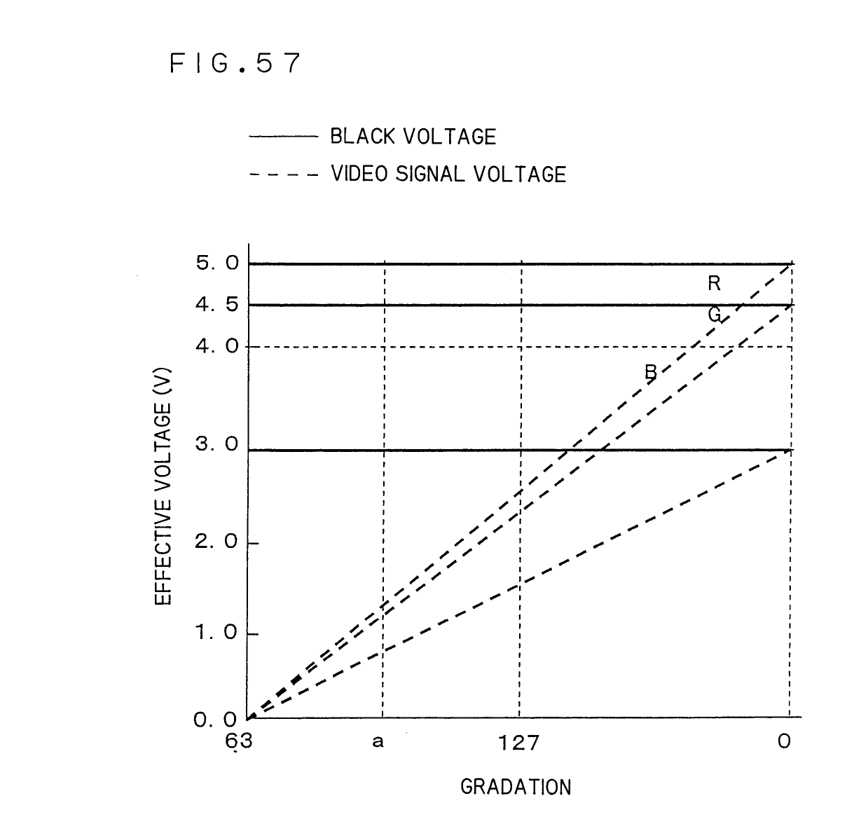

FIG. 57 shows an embodiment in which the black voltage is fixed as a constant value with respect to the gradation number. However, the black voltages to be applied to the liquid crystal layer during the black writing period “a” depend on the colors R, G, and B, because the colors R, G, B each have an optimum black voltage. The black voltages of the colors R, G, and B are set adequately by the liquid crystal mode or the film thickness of the liquid crystal layer 364. Alternatively, it is changed by the panel temperature.

(11-3-6) Modification 5

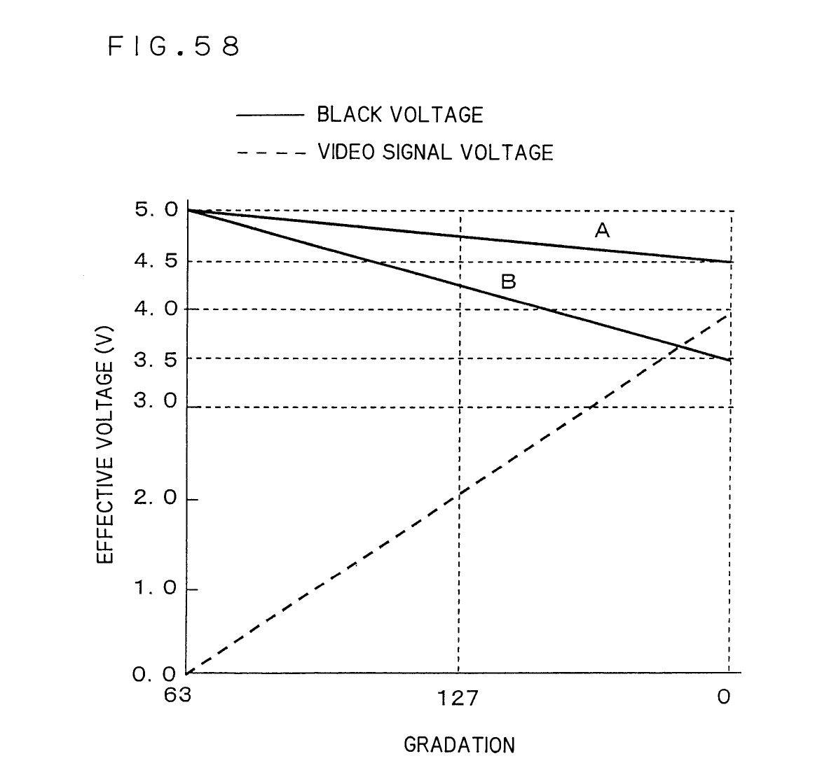

In the embodiments shown above, the black voltage at the gradation 0 is matched with the video signal voltage at the gradation 0. However, the embodiment is not limited thereto. As shown by a solid line in FIG. 58, the black voltage at the gradation 0 and the video signal voltage at the gradation 0 may be different from each other, as a matter of course. A solid line B shows an embodiment in which the black voltage at the gradation 0 is set to be lower than the video signal voltage at the gradation 0. A solid line A shows an embodiment in which the black voltage at the gradation 0 is equal to or higher than the video signal voltage at the gradation 0.

In the arbitrary pixels, the effective voltage obtained from the voltage applied to the liquid crystal layers 364 of the pixels during the black writing period “a” and the voltage applied to the liquid crystal layers 364 of the pixels during the video writing period “b” is preferably set to a predetermined value. Assuming that the effective voltage as the predetermined value is 4V and the voltage to be applied to the liquid crystal layers 364 of the pixels during the video writing period “b” is 2V, the voltage to be applied to the pixels during the black writing period “a” is set to 2V. Assuming that the effective voltage as the predetermined value is 4V and the voltage to be applied to the liquid crystal layers 364 of the pixels during the video writing period “b” is 1V, the voltage to be applied to the pixels during the black writing period “a” is set to 3.88V.

The predetermined effective value obtained from the voltage to be applied to the liquid crystal layers 364 of the pixels during the black writing period “a” and the voltage to be applied to the liquid crystal layers 364 of the pixels during the video writing period “b” are set to be within a certain range. It is set to fall within a range from 80% to 120% of an ideal predetermined effective value (a value determined by the liquid crystal mode or the film thickness of the liquid crystal layer 364).

(11-3-7) Modification 6

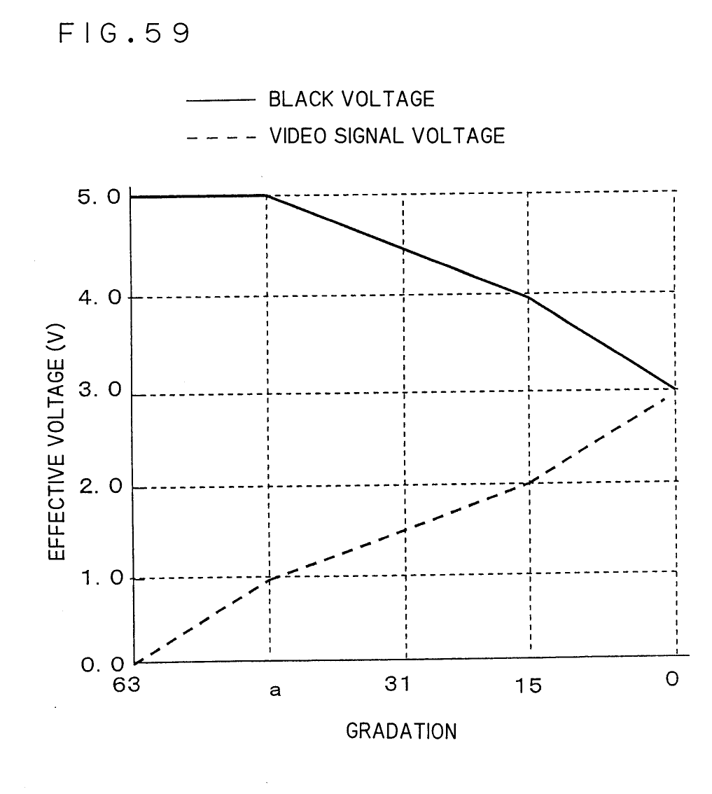

In the embodiment shown above, the black voltage and the video signal voltage are expressed to assume straight lines, the embodiment is not limited thereto. For example, they may assume a number of broken lines or curved lines as shown in FIG. 59.

(11-3-8) Modification 7

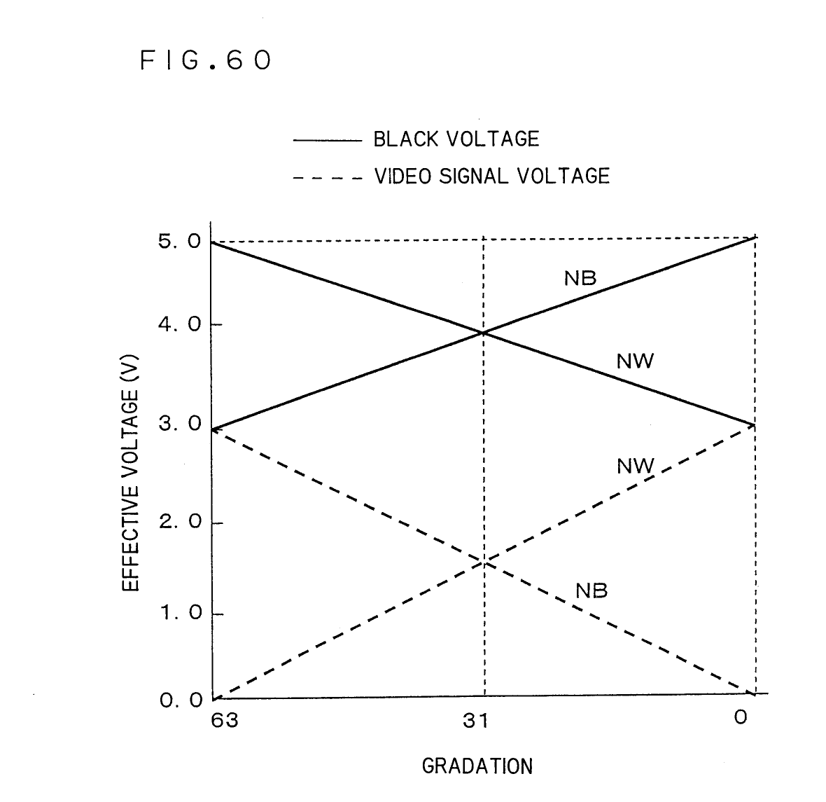

In the embodiment shown above, the display mode of the liquid crystal display panel is the normally white mode (NW). However, the embodiment is not limited thereto, and the normally black mode (NB) is also applicable. In the normally white mode, the black voltage or the like is applied to the liquid crystal layer as marked as NW in FIG. 60. In the normally black mode, the black voltage or the like is applied to the liquid crystal layer as marked as NB in FIG. 60.

(12) Application to Display Equipment

Subsequently, a display equipment in which the liquid crystal display device in this embodiments is used as a display will be described.

(12-1) Mobile Phone

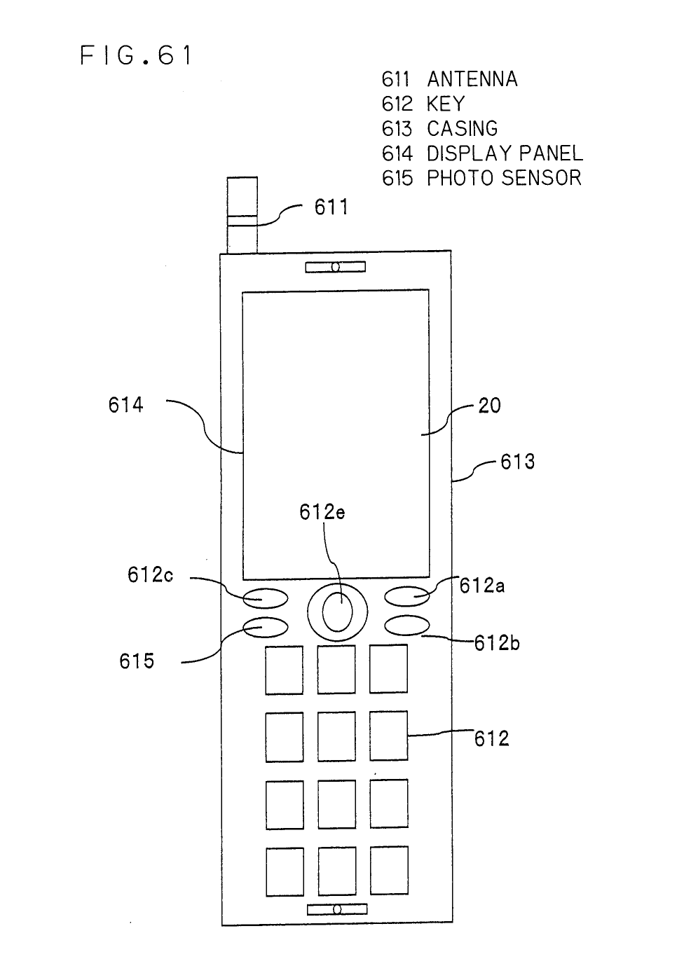

FIG. 61 is a plan view of a mobile phone as an example of an information terminal device.

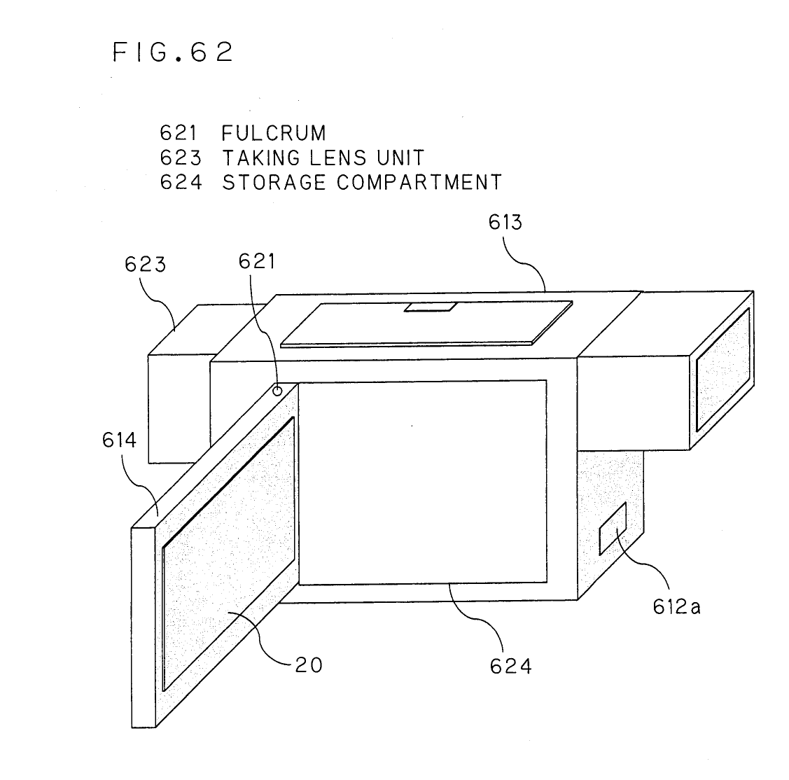

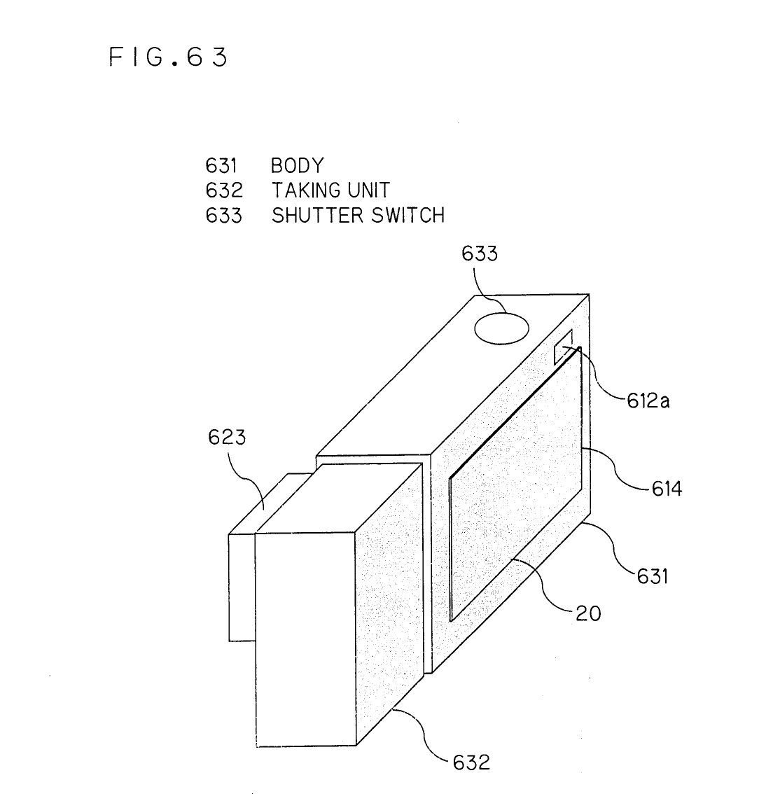

An antenna 611 is mounted to a casing 613. Reference numeral 612a designates a switching key for changing the length of the black writing period “a”. By changing the length of the black writing period “a”, the brightness of the displayed image is switched. Reference numeral 612b designates a retransfer switch. When the reverse transfer occurs and the quality of the image display is deteriorated, a transfer sequence is performed by pressing the switch 612b and the bend alignment is achieved. Reference numeral 612c designates a standby key. By pressing the standby key 612c, the transfer maintenance sequence starts, and when the standby key 612c is pressed again, a restoration sequence is performed and the image display state is achieved. It is preferably to provide a key 612 for switching the mode of the liquid crystal display panel (transmissive, transflective). These keys 612 are provided also on the display equipment shown in FIGS. 62 and 63.

Reference numeral 615 designates a photosensor. The photosensor 615 adjusts the luminance of the display screen 20 automatically by changing the luminance of illumination of the backlight during the black writing period “a” according to the intensity of the outside light.

(12-2) Video Camera

FIG. 62 is a perspective view of a video camera.

The video camera includes a taking lens unit 623 and a video camera body 613. The liquid crystal display device in this embodiment is used also as a display monitor 614. The angle of the display screen 20 can be adjusted freely about a fulcrum 621. When the display screen 20 is not used, it is stored in a storage compartment 624.

In the display equipment in the embodiments shown in FIG. 61 and FIG. 62, the display luminance can be switched by the operation of the keys 612. The keys 612 are adapted to be operated by the user for switching operation. Whether or not the display luminance is automatically changed is set by the setting mode. When it is set to automatic, the brightness of the outside light is detected and the display luminance is switched to 50%, 60%, and 80% automatically.

The liquid crystal display devices in the embodiments may be applied not only to the video camera, but also to an electronic camera as shown in FIG. 63. The liquid crystal display devices in the embodiments are used as a monitor 22 attached to a camera body 631. The camera body 631 is provided with a shutter 633 and switches 612.

A technical idea of the liquid crystal display device described in the embodiments shown above may be applied to video cameras, projectors, three-dimensional (3D) TVs, projection TVs, view finders, main monitors, sub monitors, or clock display of mobile phones, PHSs, and mobile information terminals.

(13) Modifications

The invention is not limited to the embodiments shown above, and various modifications or alterations may be made without departing the scope of the invention in the stage of implementation thereof.

The embodiments may be combined as long as possible, and in this case, characteristic effects are achieved owing to such combinations.

What is claimed is:

1. A liquid crystal display device including a liquid crystal display panel having an array substrate formed with a display area with a plurality of pixels arranged in a matrix pattern by a plurality of source signal lines and a plurality of gate signal lines arranged orthogonally to each other and pixel switching devices arranged in the vicinities of intersections of the source signal lines and the gate signal lines, and an opposed substrate having opposed electrodes and being arranged on the array substrate with a liquid crystal layer sandwiched therebetween, comprising:
a video display control unit configured to write black voltages into the respective pixels during a first period in one frame and write video signals into the respective pixels during a second period subsequent to the first period in the one frame; and
a common voltage application unit configured to apply a common voltage VmH to the opposed electrodes during the first period, apply a common voltage VcH (VmH>VcH) during the subsequent second period, and apply a common voltage VmL to the opposed electrodes in the first period in a subsequent frame of the one frame and apply a common voltage VcL (VmL<VcL<VcH) during a subsequent second period.

2. A liquid crystal display device including a liquid crystal display panel having an array substrate formed with a display area with a plurality of pixels arranged in a matrix pattern by a plurality of source signal lines and a plurality of gate signal lines arranged orthogonally to each other and pixel switching devices arranged in the vicinities of intersections of the source signal lines and the gate signal lines, and an opposed substrate having opposed electrodes and being arranged on the array substrate with a liquid crystal layer sandwiched therebetween, comprising:
a video display control unit configured to write black voltages to the respective pixels during a first period in one frame, write video signals to the respective pixels during a second period subsequent to the first period during the one frame, and determine the magnitudes of the black voltage to be applied to the pixels during the first period by the magnitudes of the video signals to be applied to the pixels during the second period.

3. The liquid crystal display device according to claim 1, comprising:
a backlight configured to illuminate the liquid crystal display panel; and
a backlight control unit configured to extinguish the backlight during the first period and the second period in the first frame and illuminate the backlight during periods other than the first period and the second period in the first frame.

4. The liquid crystal display device according to claim 2, comprising:
the backlight configured to illuminate the liquid crystal display panel; and
a backlight control unit configured to extinguish the backlight during the first period and the second period in the first frame and illuminate the backlight during periods other than the first period and the second period in the first frame.

5. The liquid crystal display device according to claim 1, wherein video signals having opposite polarities are applied to the source signal lines of the liquid crystal display device alternately from frame to frame, and
the polarity of the video signals is switched after the first period starts and before the second period starts, or simultaneously with the start of the second period.

6. The liquid crystal display device according to claim 2, wherein video signals having opposite polarities are applied to the source signal lines of the liquid crystal display device alternately from frame to frame, and
the polarity of the video signals is switched after the first period starts and before the second period starts, or simultaneously with the start of the second period.

7. The liquid crystal display device according to claim 1, further comprising a temperature detecting unit configured to detect the panel temperature of the liquid crystal display panel,
wherein the temperature detecting unit changes the first period with the panel temperature.

8. The liquid crystal display device according to claim 2, further comprising a temperature detecting unit configured to detect the panel temperature of the liquid crystal display panel,
wherein the temperature detecting unit changes the first period depending on the panel temperature.

9. The liquid crystal display device according to claim 1, further comprising a temperature detecting unit configured to detect the panel temperature of the liquid crystal display panel,
wherein the temperature detecting unit changes the magnitude of at least one of the voltage to be applied to the liquid crystal layer during the first period and the voltage to be applied to the liquid crystal layer during the second period on the basis of the panel temperature.

10. The liquid crystal display device according to claim 2, further comprising a temperature detecting unit configured to detect the panel temperature of the liquid crystal display panel,
wherein the temperature detecting unit changes the magnitude of at least one of the voltage to be applied to the liquid crystal layer during the first period and the voltage to be applied to the liquid crystal layer during the second period on the basis of the panel temperature.

11. The liquid crystal display device according to claim 1, wherein a frame rate of signals to be supplied into the liquid crystal display device is converted into a frame rate at a speed of 1.25 times or 1.5 times to display an image in the display area.

12. The liquid crystal display device according to claim 2, wherein a frame rate of signals to be supplied into the liquid crystal display device is converted into a frame rate at a speed of 1.25 times or 1.5 times to display an image in the display area.

13. The liquid crystal display device according to claim 1, wherein the black voltages are written into the plurality of pixel rows simultaneously during the first period.

14. The liquid crystal display device according to claim 2, wherein the black voltages are written into the plurality of pixel rows simultaneously during the first period.

15. The liquid crystal display device according to claim 1, wherein the liquid crystal display device is of transmissive, transflective or reflective type.

16. The liquid crystal display device according to claim 2, wherein the liquid crystal display device is of transmissive, transflective or reflective type.

17. The liquid crystal display device according to claim 1, wherein the video display control unit includes:
a source driver unit configured to apply voltages corresponding to video signals to the respective pixels;
a gate driver unit configured to select the pixel row to which the voltage is applied; and
a RAM circuit configured to hold the video signals supplied from the outside.

18. The liquid crystal display device according to claim 2, wherein the video display control unit includes:
a source driver unit configured to apply voltages corresponding to video signals to the respective pixels;
a gate driver unit configured to select the pixel row to which the voltage is applied; and
a RAM circuit configured to hold the video signals supplied from the outside.

19. The liquid crystal display device according to claim 1, further comprising a memory configured to hold data to generate the black voltages.

20. The liquid crystal display device according to claim 2, further comprising a memory configured to hold data to generate the black voltages.
